(19) United States
(12) Patent Application Publication
(10) Pub. No.: US 2017/0061743 A1
(43) Pub. Date: Mar. 2, 2017

(54) GAMING MACHINE

(71) Applicants: Universal Entertainment Corporation, Tokyo (JP); Aruze Gaming (Hong Kong) Limited, Kowloon (HK)

(72) Inventors: Takehisa ITAGAKI, Tokyo (JP); Fumihiro WATABE, Tokyo (JP); Takaki NARITA, Tokyo (JP)

(21) Appl. No.: 15/234,077

(22) Filed: Aug. 11, 2016

(30) Foreign Application Priority Data
Aug. 31, 2015 (JP) 2015-171101

(51) Int. Cl. G07F 17/34; G07F 17/32

(52) U.S. Cl. CPC G07F 17/34; G07F 17/3213

(57) ABSTRACT

A display area is provided in which regions for displaying symbols stopped are arranged in a plurality of rows and a plurality of columns. The processing of (1-1) stopping symbols in each of the columns and (1-2) determining whether or not a plurality of predetermined symbols are successively stopped among the symbols stopped in the processing of (1-1) are executed. Upon determining in the processing of (1-2) that the plurality of predetermined symbols are successively stopped, a coupled-region animation is produced for the predetermined symbols, the coupled-region animation being produced in a region obtained by coupling regions where the plurality of predetermined symbols are successively stopped.

### CROSS-REFERENCE TO RELATED APPLICATION

This application claims the benefit of Japanese Patent Applications No. 2015-171101, filed Aug. 31, 2015, which application is incorporated herein by reference in its entirety.

### FIELD OF THE INVENTION

The present invention relates to a gaming machine.

### BACKGROUND OF THE INVENTION

A gaming machine is conventionally known in which, upon a player operating a spin button, a plurality of symbols are displayed so as to scroll in symbol display areas, the symbols are automatically stopped, and a benefit such as a payout or a free game is awarded based on how the symbols are stopped.

It is very important for the player to perceive whether or not he/she can obtain the benefit when playing a game. The player, therefore, has a great interest in stopping of the symbols.

Recently, a gaming machine has been disclosed in which a symbol display effect presented when mechanical reels are stopped can be produced with respect to the direction of viewing outer peripheral surfaces of the reels, which is an effect component completely different from conventional ones (see U. S. Patent Application Publication No. 2015/080107).

In video reels as well as mechanical reels, a player has a great interest in stopping of symbols. This is why a novel effect produced for symbols when the symbols are stopped is demanded in video reels, too.

The present invention has been made in view of the problems described above, and an object of the present invention is to provide a gaming machine that is able to produce a novel effect for symbols.

Objects of the present invention, problems to be solved by the present invention, and effects (benefits) of the present invention should be understood from the claims, and should not be wrongly interpreted from the following description.

### BRIEF SUMMARY OF THE INVENTION

In a first aspect of the present invention, a gaming machine of the present invention includes:

a display unit with a display area in which regions for displaying symbols stopped are arranged in a plurality of rows and a plurality of columns; and

a control unit that executes the processing of
(1-1) stopping symbols in each of the columns, and
(1-2) determining whether or not a plurality of predetermined symbols are successively stopped among the symbols stopped in the processing of (1-1);

upon determining in the processing of (1-2) that the plurality of predetermined symbols are successively stopped, the control unit producing a coupled-region animation for the predetermined symbols, the coupled-region animation being produced in a region obtained by coupling regions where the plurality of predetermined symbols are successively stopped.

In the configuration described above, the coupled-region animation for the predetermined symbols is produced in the region obtained by coupling the regions where the plurality of predetermined symbols are successively stopped.

In a case where the predetermined symbols are successively stopped, the regions are coupled so that the animation is produced in a region corresponding to the plurality of regions, which is wider than a single region. This can attract the player's attention. Since the animation is associated with the predetermined symbols, it can be easily perceived that the predetermined symbols are stopped. The coupled-region animation can be produced in each column. When, for example, the coupled-region animations are successively produced in a plurality of columns, a player has a high expectation for a benefit.

The above-described configuration is able to achieve new effects, that is, attracting the player's attention each time symbols are stopped in each column, allowing the player to easily perceive how the symbols are stopped in each column, and increasing the player's expectation for a benefit.

In this gaming machine, further, the control unit executes the processing of

(2-1) determining whether or not a winning combination is included in symbol combinations containing any of the plurality of predetermined symbols, the winning combination awarding a benefit,

upon determining in the processing of (2-1) that the winning combination is included, the control unit producing individual-region animations for the predetermined symbols instead of the coupled-region animation, the individual-region animations being produced in the respective regions.

In the configuration described above, in a case of awarding a benefit, the individual-region animations are produced in the respective regions instead of the coupled-region animation.

Among the coupled-region animations produced in the coupled regions, the coupled-region animation produced in the region involved in awarding of the benefit is changed into the individual-region animations in the respective regions. Such a configuration is a new configuration. In this configuration, the animation is changed so that the player's attention is attracted to the corresponding regions. Since the individual-region animations are produced in these regions, the player can easily perceive that the benefit is being awarded.

In this gaming machine, further,

the control unit executes the processing of:

(3-1) starting scrolling of symbols in the display area based on a spin operation; and

(3-2) determining whether or not a winning combination is included in symbol combinations containing any of the plurality of predetermined symbols, the winning combination awarding a benefit,

upon determining in the processing of (3-2) that the winning combination is not included, the control unit maintaining the coupled-region animation until a next spin operation.

In the configuration described above, in a case of not awarding a benefit, the coupled-region animation is maintained. In a configuration ordinarily conceivable, an animation is terminated in a case of awarding no benefit. In the configuration described above, on the other hand, the animation is maintained, which can relieve disappointment at the fact that no benefit is awarded. Thus, the mood at the time of stopping the symbols can remain

In this gaming machine, further,

after the processing of (2-1), the control unit applies hatching to, in the display area, regions where symbols not involved in the winning combination are stopped.

In this configuration, the regions where symbols not involved in the winning combination are stopped are hatched.

Here, the hatching may be applied in the form of either solid painting or patterning. The degree of the solid painting may be any appropriate degree from 0% (transparent) to 100% (completely solid). The pattern may be a checkered pattern, a pattern formed by an aggregate of lines such as horizontal lines, vertical lines, or slant lines, or a pattern formed by an aggregate of signs such as dots or circles.

The configuration described above makes it easy to recognize the regions involved in the winning combination, to allow easy perception of the fact that the benefit is being awarded.

This gaming machine may be configured as follows.

The control unit causes a frame indicating the winning combination to be displayed in association with each symbol included in the winning combination.

In the configuration described above, the symbols involved in the winning combination can be easily checked, which allows easily perception of what kind of benefit can be awarded.

This gaming machine may be configured as follows.

Upon determining that the predetermined symbols are stopped, the control unit produces individual-region animations for the predetermined symbols, the individual-region animations being produced in regions where the predetermined symbols are stopped.

In the configuration described above, the animations are produced when the predetermined symbols are stopped. This allows easy perception of the fact that the predetermined symbols are stopped.

This gaming machine may be configured as follows.

The control unit causes, among the individual-region animations associated with the predetermined symbols in the display area, the individual-region animations produced in regions where symbols involved in the winning combination are stopped to be produced in the same fashion.

In the configuration described above, the individual-region animations in the regions involved in the winning combination are produced in the same fashion. This allows easy perception of the fact that a benefit based on the predetermined symbols is being awarded.

The present invention is able to provide a new effect for a symbol.

### BRIEF DESCRIPTION OF THE DRAWINGS

FIG. 1 shows an exemplary embodiment of a gaming machine;

FIG. 2 shows an example of an internal configuration of the gaming machine;

FIG. 3 is an explanatory diagram showing a functional flow of the gaming machine;

FIG. 4 is an explanatory diagram showing a functional flow of the gaming machine;

FIG. 5 is an explanatory diagram showing a configuration of connection in a game system;

FIG. 6 is a block diagram of the game system;

FIG. 7 is a block diagram of a PTS system;

FIG. 8 is a perspective view of a slot machine of the gaming machine;

FIG. 9 is an electrical block diagram showing the gaming machine;

FIG. 10 shows an exemplary configuration of a screen of a lower image display panel;

FIG. 11 shows an exemplary configuration of a screen of the lower image display panel;

FIG. 12 shows an example of reel positions;

FIG. 13 shows an example of position data;

FIG. 14 shows imageries of an activated payline;

FIG. 15A shows an example of symbol arrays;

FIG. 15B shows an example of symbol arrays;

FIG. 15C shows an example of symbol arrays;

FIG. 15D shows an example of symbol arrays;

FIG. 16A shows an example of symbol arrays;

FIG. 16B shows an example of symbol arrays;

FIG. 16C shows an example of symbol arrays;

FIG. 16D shows an example of symbol arrays;

FIG. 17A shows an example of symbol arrays;

FIG. 17B shows an example of symbol arrays;

FIG. 17C shows an example of symbol arrays;

FIG. 17D shows an example of symbol arrays;

FIG. 18A shows an example of symbol arrays;

FIG. 18B shows an example of symbol arrays;

FIG. 18C shows an example of symbol arrays;

FIG. 18D shows an example of symbol arrays;

FIG. 19 shows an example of a replacement symbol determination table;

FIG. 20 shows an example of a replacement symbol determination table;

FIG. 21 shows an example of a replacement symbol determination table;

FIG. 22 shows an example of a replacement symbol determination table;

FIG. 23 shows an example of a video reel group determination table;

FIG. 24A shows an example of symbol arrays;

FIG. 24B shows an example of symbol arrays;

FIG. 25 shows an example of a symbol configuration;

FIG. 26 shows an example of a denomination set range;

FIG. 27 shows a correspondence relationship between play-line buttons and the number of activated paylines.

FIG. 28 shows a correspondence relationship between configurations and BET multiplying factors;

FIG. 29 shows an example of a payout table;

FIG. 30 shows an example of a payout table;

FIG. 31A shows an exemplary case in which no free game is triggered;

FIG. 31B shows an exemplary case in which a free game is triggered;

FIG. 32 shows an example of a spin table determination table;

FIG. 33 shows an example of a game specification concerning a BGM and a background image;

FIG. 34 shows an example of a lottery level determination table;

FIG. 35A shows an example of a lottery table selection table;

FIG. 35B shows an example of a lottery table selection table;

FIG. 36A shows an example of a lottery table;

FIG. 36B shows an example of a lottery table;

FIG. 36C shows an example of a lottery table;

FIG. 36D shows an example of a lottery table;

FIG. 37 shows an example of a spin table determination table;

FIG. 38 shows an example of a correspondence relationship between the total number of games and the rate of increment;

FIG. 39 shows an example of a correspondence relationship between the total number of games and an incrementation sound;

FIG. 40 shows an example of a table that defines types of a jackpot;

FIG. 41 shows an example of a table that defines a progressive level;

FIG. 42 shows an example of an incremental ratio table;

FIG. 43 shows an example of a base value table;

FIG. 44 shows an example of a maximum value table;

FIG. 45 shows an example of a fixed payout setting table;

FIG. 46 shows an example of a wheel-A contents determination table;

FIG. 47 shows an example of a progressive payout setting table;

FIG. 48 shows an example of a progressive payout setting table;

FIG. 49 shows an example of a wheel-B contents determination table;

FIG. 50 shows an example of a wheel-B contents determination table;

FIG. 51 shows an example of a flowchart of a normal game running process;

FIG. 52 shows an example of a flowchart of a jackpot-related process;

FIG. 53 shows an example of a flowchart of a symbol lottery process;

FIG. 54 shows an example of a flowchart of a mystery symbol lottery process;

FIG. 55 shows an example of a flowchart of a symbol display control process;

FIG. 56 shows an example of a flowchart of a symbol display control process;

FIG. 57 shows an example of a flowchart of a number-of-payouts determination process;

FIG. 58 shows an example of a flowchart of a free game running process;

FIG. 59 shows an example of a flowchart of a number-of-games lottery process;

FIG. 60 shows an example of a flowchart of a jackpot execution process;

FIG. 61 shows an example of an animation determination table;

FIG. 62 shows an example of how mystery symbols are changed;

FIG. 63 shows an example of how animations are changed;

FIG. 64 shows an example of how animations are changed;

FIG. 65 shows an example of how animations are changed;

FIG. 66 shows an example of a win effect;

FIG. 67 shows an example of a win effect;

FIG. 68 shows an example of a number-of-games determination effect;

FIG. 69 shows an example of a number-of-games determination effect;

FIG. 70 shows an example of a mystery symbol addition effect;

FIG. 71 shows an exemplary configuration of a screen for a jackpot effect;

FIG. 72 shows an example of a jackpot effect;

FIG. 73 shows an example of a jackpot effect;

FIG. 74 shows an example of a jackpot effect;

FIG. 75 shows an example of a jackpot effect;

FIG. 76 shows an example of a jackpot effect;

FIG. 77 shows an example of a specific embodiment of a slot machine;

FIG. 78 shows an example of a specific embodiment of a slot machine;

FIG. 79 shows an example of a specific embodiment of a slot machine;

FIG. 80 shows an example of a jackpot effect using a signage;

FIG. 81 shows an outline of a game flow; and

FIG. 82 shows an example of a gaming machine according to another embodiment.

### DETAILED DESCRIPTION OF THE PREFERRED EMBODIMENT

### Outline of Gaming Machine as One Embodiment of Present Invention

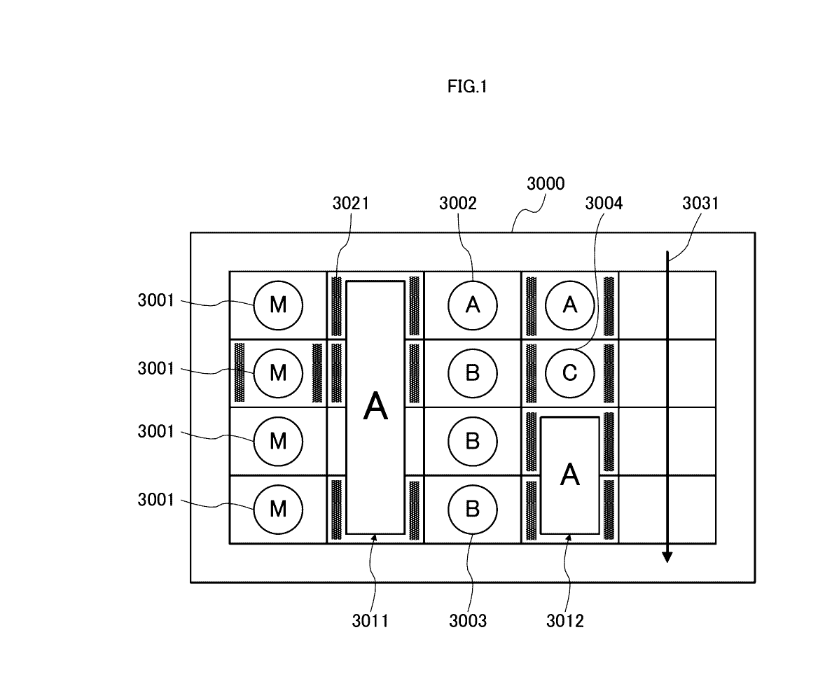

A gaming machine of the present invention will be described based on the accompanying drawings. FIG. 1 shows an exemplary embodiment of the gaming machine (a screen 3000 displayed in the gaming machine). The screen 3000 shown in FIG. 1 is taken as an example for describing an outline of the gaming machine.

The gaming machine includes one or more video reels, and the one or more video reels have successive mystery symbols 3001 that can be changed into all types of symbols. A first video reel, which is configured to stop first, also has successive mystery symbols 3001. Although successive wild symbols are normally not provided to the first video reel, this gaming machine is able to stop and display successive wild symbols on the first video reel by way of the successive mystery symbols 3001. Thus, the gaming machine is a gaming machine capable of using the first video reels As successive wild symbols.

This gaming machine includes a secondary video reel that highlights the frames of symbols 3001, 3002, 3003, 3004 of a base video reel. In a case where a predetermined number of symbols 3021 on the secondary video reels are displayed (for example, in a case of full-screen display), a jackpot is triggered.

Thus, this gaming machine is a gaming machine capable of triggering a jackpot by using double video reels. In this configuration, when a symbol frame expansion effect 3011, 3012 is produced on the base video reel, the symbol 3021 does not disturb the frame expansion effect because the symbol 3021 highlights the right and left parts of the symbol frame of the, base video reel. In this configuration, moreover, a jackpot can be triggered even though different symbols are stopped and displayed on the base video reel.

In this gaming machine, animations having different motions are provided depending on whether or not a win (winning) occurs as a result of the stopping of the video reels. More specifically, if a predetermined symbol (for example, a picture symbol) is successively stopped and displayed, the frame expansion effect (animation) is produced for each sequence of four, three, and two stop symbols. In a case of no win, and more specifically in a case of an expansion animation not related to any win, the animation is produced in a looped manner until a next spin. In a case of a win, the animation returns to an animation associated with each single symbol, and any symbol appearing on the screen as a whole and not related to the win is hatched to make a payline easy to view.

Here, the animation is a motion expressed by a plurality of still images. A moving image, a video image, or the like, is adoptable as the animation. As a file format thereof, any appropriate file format is adoptable such as APNG (Animated Portable Network Graphics), AVI (Audio Video Interleave), ASF (Advanced Systems Format), DivX Media Format, Matroska, MPEG-2 TS, MP4, Multiple-image Network Graphics, Ogg, Ogg Media, QuickTime, animation GIF, Flash Video, or WebM.

The illustration shows that a fifth video reel 3031 is scrolling.

The screen 3000 is merely an example, and this configuration is not limiting.

For example, the number of video reels is not limited to five. It may be less than five, that is, four or less, or alternatively it may be more than five, that is, six or more.

For example, the number of symbols stopped on one video reel is not limited to four. It may be less than four, that is, three or less, or alternatively it may be more than four, that is, five or more.

For example, the successive mystery symbols 3001 may be configured to inevitably change into other symbols, or may be configured not to change in some cases. The successive mystery symbols 3001 may be configured such that the number of successive mystery symbols 3001 successively arranged on the video reel is a value (first value) corresponding to the number of symbols stoppable and displayable in all display areas. Alternatively, they may be configured such that the number of successive mystery symbols 3001 successively arranged on the video reel is a second value greater than the first value. Alternatively, they may be configured such that the number of successive mystery symbols 3001 successively arranged on the video reel may be a third value smaller than the first value.

For example, the animation may not necessarily be produced for a predetermined symbol. The animation may be produced for all symbols.

For example, the base video reels and the secondary video reel may be scrolled at the same speed or may be scrolled at different speeds.

For example, a configuration in which a first video reel, a second video reel, a third video reel, a fourth video reel, and a fifth video reels Are arranged in the mentioned order from the left side when viewed from a player is not limiting. A configuration in which the first video reel, the second video reel, the third video reel, the fourth video reel, and the fifth video reels Are arranged in the mentioned order from the right side is also adoptable. A configuration in which the first video reel, the second video reel, the third video reel, the fourth video reel, and the fifth video reels Are arranged in the mentioned order from the upper side is also adoptable. A configuration in which the first video reel, the second video reel, the third video reel, the fourth video reel, and the fifth video reels Are arranged in the mentioned order from the lower side is also adoptable.

For example, a configuration in which the reels are stopped sequentially from the first video reel is not limiting. A configuration in which predetermined video reels (the second to fourth video reels, the secondary video reel, etc.) are stopped simultaneously is also adoptable.

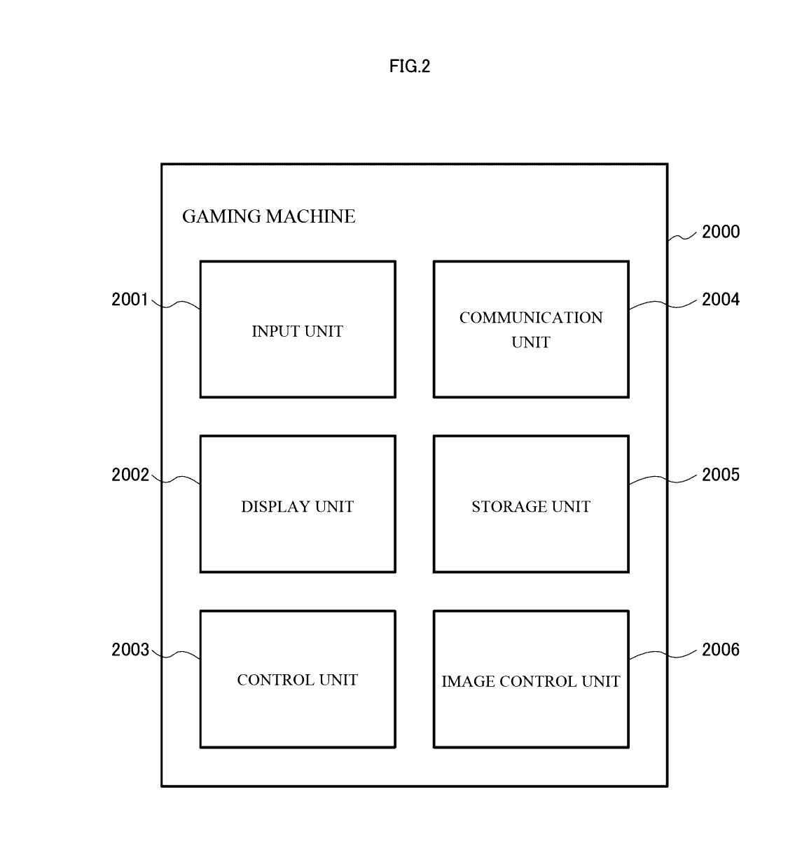

FIG. 2 shows an example of an internal configuration of a gaming machine 2000. The gaming machine 2000 includes an input unit 2001, a display unit 2002, a control unit 2003, a communication unit 2004, a storage unit 2005, and an image control unit 2006. Devices that implement the elements 2001 to 2006 may depend on the type of the gaming machine 2000, such as a slot machine, a personal computer, a smart phone, or a tablet.

The input unit 2001 inputs various information to the gaming machine 2000 based on an operation made by a user. A physical button, a physical keyboard, a mouse, a user interface displayed on a liquid crystal touch panel, or the like, functions as the input unit 2001.

The display unit 2002 displays symbols or the like. A LCD (Liquid Crystal Display), a liquid crystal touch panel, a CRT (Cathode Ray Tube) display, or the like, functions as the display unit 2002.

The control unit 2003 controls the elements 2001, 2002, and 2004 to 2006. A CPU (Central Processing Unit), an MCU (Micro-Control Unit), a motherboard, a GPU (Graphics Processing Unit), a video card (graphic board), or the like, functions as the control unit 2003.

The communication unit 2004 is communicable with a base station included in a network. In other words, the communication unit 2004 is communicable with a device connected to the network. A communication device including wired communication and wireless communication (such as wired LAN, wireless LAN, and a communication module for mobile phone communication) functions as a communication unit 2004.

The storage unit 2005 stores various types of information (such as programs for controlling the gaming machine 2000, tables, or the like). A ROM (Read Only Memory), a RAM (Random Access Memory), a silicon disk, a hard disk, or the like, functions as the storage unit 2005.

The image control unit 2006 controls, for example, displaying images and producing display effects on the display unit 2002. A CPU, a GPU, a motherboard, a video card (graphic board), or the like, functions as the image control unit 2006. It may be acceptable that the control unit 2003 implements part or all of the functions of the image control unit 2006. In a case where the control unit 2003 implements all of the functions of the image control unit 2006, the image control unit 2006 may not necessarily be provided.

In the following, a characteristic configuration of the gaming machine 2000 will be described from various aspects. The configuration of the gaming machine 2000 is, however, not limited to the following configuration.

(First Aspect of Gaming Machine)

The gaming machine 2000 according to a first aspect includes a display unit 2002 and a control unit 2003. The display unit 2002 displays a video reel group having a plurality of types of symbols. The control unit 2003 executes the processing of: (1-1-1) determining symbols to be stopped on the display unit 2002; (1-1-2) causing the symbols determined in the processing of (1-1-1) to be stopped on the display unit 2002; and (1-1-3) awarding a benefit (e.g., a payout or a bonus game) based on a combination of symbols stopped on the display unit 2002. The plurality of types of symbols include wild symbols and mystery symbols. Of the video reel group, a first video reel which is configured to stop first is provided with the mystery symbol. The control unit 2003 determines the mystery symbol, and if the mystery symbol is stopped on the display unit 2002, replaces the mystery symbol with a symbol of another type (wild symbols, normal symbols (ordinary symbols), picture symbols, feature symbols, etc.) among the plurality of types of symbols.

In the configuration described above, the mystery symbol is arranged in the first video reel. The mystery symbol may be either provided or not provided in the video reels other than the first video reel.

A configuration that provides the first video reel with the mystery symbol is a new configuration which is unprecedented. When the mystery symbol is stopped, the player pays attention to what type of symbols will replace the mystery symbol. Thus, the player can enjoy the game with freshness.

In addition, the mystery symbol can be replaced with the wild symbol, and the number of symbol combinations that cause a benefit to be awarded can be increased due to the presence of the wild symbol. This allows the player to expect that a large benefit may be awarded. A replacing symbol can be determined by an appropriate method. For example, it may be determined by a lottery, may be determined based on the current time, may be determined based on the number of games that have been played on the gaming machine 2000 on that day, or may be determined based on the amount of a jackpot payout.

In a case where, for example, the mystery symbol is stopped and not replaced with another symbol at the time when the second video reel stops, the expectation for awarding of a benefit is maintained irrespective of what types of symbols are stopped in the second video reel.

Accordingly, this configuration is able to enhance a sense of expectation for awarding of a benefit.

This gaming machine 2000 may be configured as follows.

A plurality of the mystery symbols are arranged in the first video reel. The control unit 2003 determines the plurality of mystery symbols, and if the plurality of mystery symbols are stopped on the display unit 2002, replaces the plurality of mystery symbols with symbols of one type among the other types.

In the configuration described above, a plurality of mystery symbols are arranged in the first video reel. Replacement may be conducted either concurrently or stepwise (in the order from the upper display regions to the lower display regions, the order from the left video reel to the right video reel, or the order including a combination thereof).

In a case where, for example, a plurality of mystery symbols are stopped, the mystery symbols are replaced concurrently or stepwise. This can attract the player's attention, and further enhance a sense of expectation.

In a case where, for example, a plurality of mystery symbols are stopped and replaced with the wild symbols concurrently or stepwise, the player can expect that a larger benefit may be awarded.

Accordingly, this configuration is able to further enhance a sense of expectation for awarding of a benefit.

This gaming machine 2000 may be configured as follows.

A plurality of the mystery symbols are successively arranged in the first video reel. The control unit 2003 determines the plurality of mystery symbols, and if the plurality of mystery symbols are successively stopped on the display unit 2002, replaces the plurality of mystery symbols with symbols of one type among the other types.

In the configuration described above, a plurality of the mystery symbols are successively arranged in the first video reel. Replacement may be conducted either concurrently or stepwise (in the order from the upper display regions to the lower display regions, the order from the left video reel to the right video reel, or the order including a combination thereof).

In a case where, for example, a plurality of mystery symbols are successively stopped, the player's attention and sense of expectation can be further enhanced.

In a case where, for example, a plurality of mystery symbols are successively stopped and replaced with the wild symbols, the player can expect that a still larger benefit may be awarded.

Accordingly, this configuration is able to further enhance a sense of expectation for awarding of a benefit.

This gaming machine 2000 may be configured as follows.

The mystery symbols are arranged in each video reel group. The control unit 2003 determines the mystery symbols in each video reel group, and if the mystery symbol is stopped on the display unit 2002, replaces the mystery symbol with a symbol of one type among the other types.

In the configuration described above, the mystery symbol is replaced each time the video reel stops.

The configuration described above is able to enhance the expectation for awarding of a benefit each time the video reel stops.

This gaming machine 2000 may be configured as follows.

Upon determining the mystery symbol, the control unit 2003 stops the first video reel so that the mystery symbol is stopped and displayed on the display unit 2002, and stops the rest of the video reels included in the video reel group other than the first video reel. After stopping all the video reels included in the video reel group, the control unit 2003 replaces the mystery symbol with a symbol of one of the other types.

In the configuration described above, when a mystery symbol is stopped, replacement of the mystery symbol is caused after all the video reels are stopped.

In a case where, for example, a mystery symbol is stopped and displayed in the first video reel which has been stopped first, replacement of the mystery symbol does not occur until the last video reel stops. This can keep the expectation for awarding of a benefit for a longer time.

This gaming machine 2000 may be configured as follows.

Upon determining the mystery symbol, the control unit 2003 determines by a lottery which type of symbol among the other types of symbols is to replace the mystery symbol.

In the configuration described above, the probability that a benefit will be awarded is adjustable by, for example, changing a lottery value. Accordingly, it is possible to balance a player's benefit and a store's benefit, without the need to change an arrangement of symbols in the video reel.

This gaming machine 2000 may be configured as follows.

The mystery symbols are arranged in all of the video reels included in the video reel group.

In the configuration described above, in a case where, for example, the mystery symbols are stopped in the plurality of video reels, the player's attention and sense of expectation can be further enhanced. Moreover, the player can expect awarding of a larger benefit.

Accordingly, this configuration is able to further enhance a sense of expectation for awarding of a benefit.

This gaming machine 2000 may be configured as follows.

The plurality of types of symbols include a feature symbol. Upon determining that a predetermined combination is formed by the feature symbol based on combinations of symbols stopped on the display unit 2002, the control unit 2003 awards a free game as the benefit, the free game being a more advantageous state than the normal game.

In the configuration described above, the mystery symbol may be replaced with the feature symbol.

Such a configuration in which the mystery symbol may be replaced with the feature symbol is a new configuration which is unprecedented. When the mystery symbol is stopped, the player can expect obtaining of the free game, too.

Accordingly, this configuration is able to further enhance a sense of expectation for awarding of a benefit.

This gaming machine 2000 may be configured as follows.

The control unit 2003 determines the number of games playable in the free game, for each of the feature symbols stopped on the display unit 2002.

The magnitude of the number of games playable in the free game is one of the concerns of the player. Thus, for example, stopping of the mystery symbol, which is related to the number of games playable in the free game, allows the player to expect awarding of a large benefit.

Accordingly, this configuration is able to further enhance a sense of expectation for awarding of a benefit.

The determination of the number of games may be made for all the feature symbols stopped on the display unit 2002, may be made for the feature symbol related to triggering of the free game, or may be made for the feature symbol that forms a winning combination of the free game.

(Second Aspect of Gaming Machine)

The gaming machine 2000 according to second embodiment includes a display unit 2002 and a control unit 2003. The display unit 2002 stops and displays first symbols (e.g., normal symbols, picture symbols, feature symbols, wild symbols, mystery symbols) included in a group of first video reels (e.g., base reels), and stops and displays second symbols (e.g., JP symbols) included in a group of second video reels (e.g., secondary reels) in superimposition over the first symbols. The control unit 2003 executes the processing of: (2-1-1) awarding a jackpot based on a combination of the second symbols stopped on the display unit 2002; and (2-1-2) awarding a benefit (e.g., a payout or a free game) different from the jackpot based on a combination of the first symbols stopped on the display unit 2002.

In the configuration described above, the first symbols related to a benefit different form the jackpot are included in the first video reel group, while the second symbols related to the jackpot are included in the second video reel group. The first symbols of the first video reel and the second symbols of the second video reel are displayed in superimposition.

Such a double-reel configuration is a new configuration. For example, this configuration enables the stopped first symbols and the stopped second symbols to be recognized at a glance. In addition, for example, this configuration allows the player to watch stopping of the symbols with expectation for both a benefit resulting from the first symbols and a jackpot resulting from the second symbols.

Moreover, in the configuration described above, for example, even when no benefit is awarded from a combination of first symbols, there is a possibility that the jackpot may be awarded from a combination of second symbols. Accordingly, the sense of expectation for the jackpot is not spoiled by the first symbols stopped.

In the configuration described above, the benefit based on the first symbols and the jackpot based on the second symbols may be simultaneously awarded. Even when no benefit is awarded based on the stopping form of the first symbols, the sense of expectation for obtaining the jackpot can be enhanced since the second symbols are stopped.

The second symbols arranged in the second video reels may be JP symbols of one kind, or may be JP symbols of two or more kinds. The second symbols arranged in the second video reels may be JP symbols alone, or may be other symbols in addition to JP symbols.

This gaming machine 2000 may be configured as follows.

The display unit 2002 includes a display area in which regions for stopping the first symbols and the second symbols are arranged in a plurality of rows and a plurality of columns. The control unit 2003 executes the processing of: (2-2-1) determining the first symbols to be stopped in the display area and stopping the first symbols; and (2-2-2) determining the second symbols to be stopped in the display area and stopping the second symbols so as to highlight each frame across which the first symbols are not arranged adjacent to each other.

In the configuration described above, the second symbols are displayed so as to highlight each frame across which the first symbol are not arranged adjacent to each other.

Even when, for example, an effect associated with first symbols is produced over a plurality of regions where the first symbols are successively stopped, the effect is not disturbed by the second symbols because the second symbols highlight the frames across which the first symbols are not arranged adjacent to each other.

In the configuration described above, in a case of producing an effect over a plurality of regions where the first symbols are successively stopped, the effect can be enjoyed to the full extent with enhancement of the sense of expectation for obtaining the jackpot.

The display area may be formed of an appropriate number of rows and an appropriate number of columns, such as sixteen regions defined by four rows×four columns, fifteen regions defined by three rows×five columns, or twenty regions defined by four rows×five columns. It is also acceptable that, for example, the number of rows varies depending on the columns, such as the first column including three rows while the second column including four rows.

This gaming machine 2000 may be configured as follows.

The control unit 2003 executes the processing of (2-3-1) determining whether or not the second symbols are stopped in all the regions of the display area. Upon determining in the processing of (2-3-1) that the second symbols are stopped in all the regions of the display area, the control unit 2003 awards the jackpot in the processing of (2-1-2).

In this configuration, the jackpot is awarded if the second symbols are stopped in all the regions of the display area.

The configuration described above allows easy recognition of whether or not the jackpot is awarded.

In the configuration described above, the second symbols being stopped in all the regions of the display area serves to trigger the jackpot. Accordingly, the sense of expectation for obtaining the jackpot can be enhanced each time the video reel stops.

This gaming machine 2000 may be configured as follows.

The second symbols are arranged in the second video reel configured to stop first and the second video reel configured to stop last.

In the configuration described above, in a case where the second symbol is stopped in the second video reel configured to stop first, the sense of expectation for obtaining the jackpot can be maintained until the second video reel configured to stop last stops, irrespective of how the first video reels are stopped.

This gaming machine 2000 may be configured as follows.

The display unit 2002 variably displays the first symbols and the second symbols while adopting the second symbol in the form of a frame of the corresponding first symbol. After the first symbols and the second symbols are stopped, the display unit 2002 displays the first symbols and the second symbols while adopting the second symbol in the changed form of an edge of the corresponding first symbol.

In the configuration described above, the second symbols adopted in the variable displaying and the second symbols adopted at the stopping are different, which can attract attention to the second symbols. The second symbols are displayed in the form of frames during the variable display and in the form of edges (right and left frames) at the stopping. This can enhance the sense of expectation for obtaining the jackpot based on the stopped second symbols, without spoiling the visibility of the first symbols.

This gaming machine 2000 may be configured as follows.

The gaming machine 2000 further includes an input unit 2001 that inputs the number of BETs based on a BET operation. A plurality of the second video reel groups are provided each corresponding to each number of BETs (e.g., the total number of BETs, the BET multiplying factor, the number of BETs for determining the number of activated paylines). Among the plurality of second video reel groups, the second video reel group corresponding to a higher number of BETs includes a larger number of the second symbols arranged therein. The control unit 2003 executes the processing of (A-1) selecting, among the plurality of second video reel groups, a second video reel group corresponding to the number of BETs inputted by the input unit.

The configuration described above enables the player to participate in the selection of the second video reel group. The player is able to play the game with an increased sense of expectation for obtaining the jackpot by, for example, increasing the number of BETs.

This gaming machine 2000 may be configured as follows.

Symbols arranged in the second video reel group include the second symbols and blanks.

In the configuration described above, symbols stopped in the second video reels are the second symbols or the blanks, which achieves a simple stopping form. Accordingly, whether or not the second symbols are stopped is easy to recognize. This allows easy perception of whether or not the jackpot can be obtained.

This gaming machine 2000 may be configured as follows.

The number of symbols arranged in each of the first video reels and the number of symbols arranged in each of the second video reels which are superimposed on the respective first video reels are different from each other.

In the configuration described above, a combination of the stopped first and second symbols varies each time it is viewed. This can avoid a situation where viewing the first symbols makes it no longer necessary to view the second symbols. The player is therefore able to view the stopping of the first symbols with expectation for a benefit obtained from the first symbols, and able to view the stopping of the second symbols with expectation for the jackpot.

(Third Aspect of Gaming Machine)

The gaming machine 2000 according to a third aspect includes a display unit 2002 and a control unit 2003. The display unit 2002 includes a display area in which regions for stopping symbols are arranged in a plurality of rows and a plurality of columns. The control unit 2003 executes the processing of: (3-1-1) stopping symbols in each of the columns; and (3-1-2) determining whether or not a plurality of predetermined symbols are successively stopped among the symbols stopped in the processing of (3-1-1). Upon determining in the processing of (3-1-2) that the plurality of predetermined symbols (for example, picture symbols) are successively stopped, the control unit 2003 produces a coupled-region animation for the predetermined symbols, the coupled-region animation being produced in a region obtained by coupling regions where the plurality of predetermined symbols are successively stopped.

In the configuration described above, a coupled-region animation for a plurality of predetermined symbols is produced in a region obtained by coupling regions where the predetermined symbols are successively stopped.

That is, if predetermined symbols are successively stopped, regions are coupled so that an animation is produced in a region corresponding to a plurality of regions, which is wider than a single region. This can attract the player's attention. Since the animation is associated with the predetermined symbols, it can be easily perceived that the predetermined symbols are stopped. The coupled-region animation can be produced in each column. When, for example, the coupled-region animations are successively produced in a plurality of columns, a player has a high expectation for a benefit.

The configuration described above is able to achieve new effects, that is, attracting the player's attention each time symbols are stopped in each column, allowing the player to easily perceive how the symbols are stopped in each column, and increasing the player's expectation for a benefit.

The display area may be formed of an appropriate number of rows and an appropriate number of columns, such as sixteen regions defined by four rows×four columns, fifteen regions defined by three rows×five columns, or twenty regions defined by four rows×five columns. It is also acceptable that, for example, the number of rows varies depending on the columns, such as the first column including three rows while the second column including four rows.

This gaming machine 2000 may be configured as follows.

The control unit 2003 executes the processing of (3-2-1) determining whether or not a winning combination is included in symbol combinations containing any of the plurality of predetermined symbols, the winning combination awarding a benefit. Upon determining in the processing of (3-2-1) that the winning combination is included, the control unit 2003 produces individual-region animations for the predetermined symbols instead of the coupled-region animation, the individual-region animations being produced in the respective regions.

In the configuration described above, in a case of awarding a benefit, the individual-region animations are produced in the respective regions instead of the coupled-region animation.

Among the coupled-region animations produced in the coupled regions, the coupled-region animation produced in the region involved in awarding of the benefit is changed into the individual-region animations in the respective regions. Such a configuration is a new configuration. In this configuration, the animation is changed so that the player's attention is attracted to the corresponding regions. Since the individual-region animations are produced in these regions, the player can easily perceive that the benefit is being awarded.

This gaming machine 2000 may be configured as follows.

As a larger number of regions are coupled, the coupled-region animation produced therein has a larger size.

The configuration described above produces a larger animation as a larger number of predetermined symbols are successively stopped. This can further attract the player's attention, thus making it easier to recognize the fact that the predetermined symbols are stopped.

This gaming machine 2000 may be configured as follows.

The control unit 2003 executes the processing of: (3-3-1) starting scrolling of symbols in the display area based on a spin operation; and (3-3-2) determining whether or not a winning combination is included in symbol combinations containing any of the plurality of predetermined symbols, the winning combination awarding a benefit. Upon determining in the processing of (3-3-2) that the winning combination is not included, the control unit 2003 maintains the coupled-region animation until a next spin operation.

In the configuration described above, in a case of not awarding a benefit, the coupled-region animation is maintained. In a configuration ordinarily conceivable, an animation is terminated in a case of awarding no benefit. In the configuration described above, on the other hand, the animation is maintained, which can relieve disappointment at the fact that no benefit is awarded. Thus, the mood at the time of stopping the symbols can remain

In addition, for example, upon perceiving how the symbols are stopped, the player can quickly start the next game by performing a spin operation.

This gaming machine 2000 may be configured as follows.

The control unit 2003 executes the processing of determining whether or not a winning combination is included in symbol combinations containing any of the plurality of predetermined symbols, the winning combination awarding a benefit. Upon determining that the winning combination is not included, the control unit 2003 maintains the coupled-region animation until a next spin operation.

In the configuration described above, even in a case where no benefit is awarded, the coupled-region animation can be enjoyed until a predetermined length of time elapses.

This gaming machine 2000 may be configured as follows.

After the processing of (3-2-1), the control unit 2003 applies hatching to, in the display area, regions where symbols not involved in the winning combination are stopped.

In this configuration, the regions where symbols not involved in the winning combination are stopped are hatched.

Here, the hatching may be applied in the form of either solid painting or patterning. The degree of the solid painting may be any appropriate degree from 0% (transparent) to 100% (completely solid). The pattern may be a checkered pattern, a pattern formed by an aggregate of lines such as horizontal lines, vertical lines, or slant lines, or a pattern formed by an aggregate of signs such as dots or circles.

The configuration described above makes it easy to recognize the regions involved in the winning combination, to allow easy perception of the fact that the benefit is being awarded.

This gaming machine 2000 may be configured as follows.

After the processing of (3-2-1), the control unit 2003 applies hatching to the other symbols different from the symbols involved in the winning combination, or sets the brightness of the other symbols to be lower than the brightness of the symbols involved in the winning combination.

The configuration described above allows easy recognition of the symbols involved in the winning combination, thereby allowing easier perception of the fact that the benefit is being awarded.

This gaming machine 2000 may be configured as follows.

The control unit 2003 causes a frame indicating the winning combination to be displayed in association with each symbol included in the winning combination.

The configuration described above allows easy recognition of the symbols involved in the winning combination, thereby allowing easy perception of what kind of benefit can be obtained.

This gaming machine 2000 may be configured as follows.

Upon determining that the predetermined symbols are stopped, the control unit 2003 produces individual-region animations for the predetermined symbols, the individual-region animations being produced in regions where the predetermined symbols are stopped.

In the configuration described above, the animations are produced when the predetermined symbols are stopped. This allows easy perception of the fact that the predetermined symbols are stopped.

This gaming machine 2000 may be configured as follows.

The control unit 2003 causes, among the individual-region animations associated with the predetermined symbols in the display area, the individual-region animations produced in regions where symbols involved in the winning combination are stopped to be produced in the same fashion.

In the configuration described above, the individual-region animations in the regions involved in the winning combination are produced in the same fashion. This allows easy perception of the fact that a benefit based on the predetermined symbols is being awarded.

(Outline of Gaming Machine)

The “slot machine” mentioned above is a type of a game terminal included in the gaming machine 2000 (gaming machine 300). Although this embodiment illustrates a slot machine 10 as one example of the game terminal, this is not limiting. A type of equipment including a terminal controller that is able to independently run any base game is applicable as the game terminal.

In this embodiment, the base game is run by the slot machine 10. The base game is a slot game in which a plurality of symbols are rearranged. The base game is not limited to the slot game. Any game is adoptable as the base game so long as the game is independently runnable in a game terminal such as the slot machine 10. That is, the base game is a game having a concept opposite to a common game. For example, a normal game and a bonus game are classified as the base game.

The rearrangement of symbols in the slot game is performed on a lower image display panel 141. The slot game may include a normal game, a bonus game, a rescue process, and the like. In the normal game, a process of rearranging symbols on the lower image display panel 141 and awarding a normal payout in accordance with the rearranged symbols is executed. The bonus game is run if rearranged symbols satisfy a predetermined condition in the normal game.

The “bonus game” is synonymous with a feature game. A game of any type is adoptable as the bonus game so long as the game provides a play state that is more advantageous than the normal game. In addition, a combination with another bonus game is also adoptable so long as it provides an advantageous play state to the player, that is, a play state that is more advantageous than the normal game. For example, the bonus game may be configured to provide various states such as a state that enables a greater game value to be obtained than the normal game, a state that enables a game value to be obtained with a higher probability than the normal game, or a state that enables a game value to be less consumed than the normal game, either alone or in combination.

For example, the bonus game may be configured to provide a fixed payout, or may be configured as a free game that is runnable by betting of a game value less than that of the normal game (including zero). The bonus game may employ a symbol lottery table having a higher payout rate than that of the normal game. The bonus game may be a pick-up bonus in which a plurality of selectable options are presented to the player. The pick-up bonus may present a fixed payout, a free game, or the like, as the options. The options in the pick-up bonus may include triggering of an additional pick-up bonus that enables the player to select from options. Preferably, the options in the pick-up bonus are arranged at random. Preferably, the options in the pick-up bonus are presented such that contents of the options are not displayed before the player makes a selection. The bonus game of this embodiment will be detailed later. The rescue process is executed upon satisfaction of a rescue start condition.

The “game value” is a coin, a bill, or electrically valuable information equivalent to them. In the present invention, the game value is not particularly limited. For example, the game value may be a game medium such as a medal, a token, electronic money, or a ticket. The ticket is not particularly limited. For example, the ticket may be a barcoded ticket which will be described later. The “game value” may be an electronic game point equivalent to the game medium, as mentioned above.

The “free game” is a game that is runnable by betting of less game values than the normal game. Being “runnable by betting of less game values” includes a case where the bet is “0”. Thus, the “free game” may be a game that is run without requiring betting of game values and that pays out an amount of game values in accordance with rearranged symbols. In other words, the “free game” may be a game that is started not based on consumption of any game value. The “normal game”, on the other hand, is a game that is run on condition that a game value is bet and that pays out an amount of game values in accordance with rearranged symbols. In other words, the “normal game” is a game that is started based on consumption of game values as a prerequisite.

The “rearrangement” represents a state where symbols are arranged again after an arrangement of symbols is dissolved. The “arrangement” represents a state where symbols are visually recognizable by an external player.

The “normal payout in accordance with rearranged symbols” is a normal payout corresponding to a winning combination obtained as a result of rearrangement. The “bonus payout in accordance with rearranged symbols” is a bonus payout corresponding to a winning combination obtained as a result of rearrangement. The “winning combination” represents that an award is established. Details of the winning combination will be described later.

(Functional Flow of Gaming Machine 300: Slot Machine)

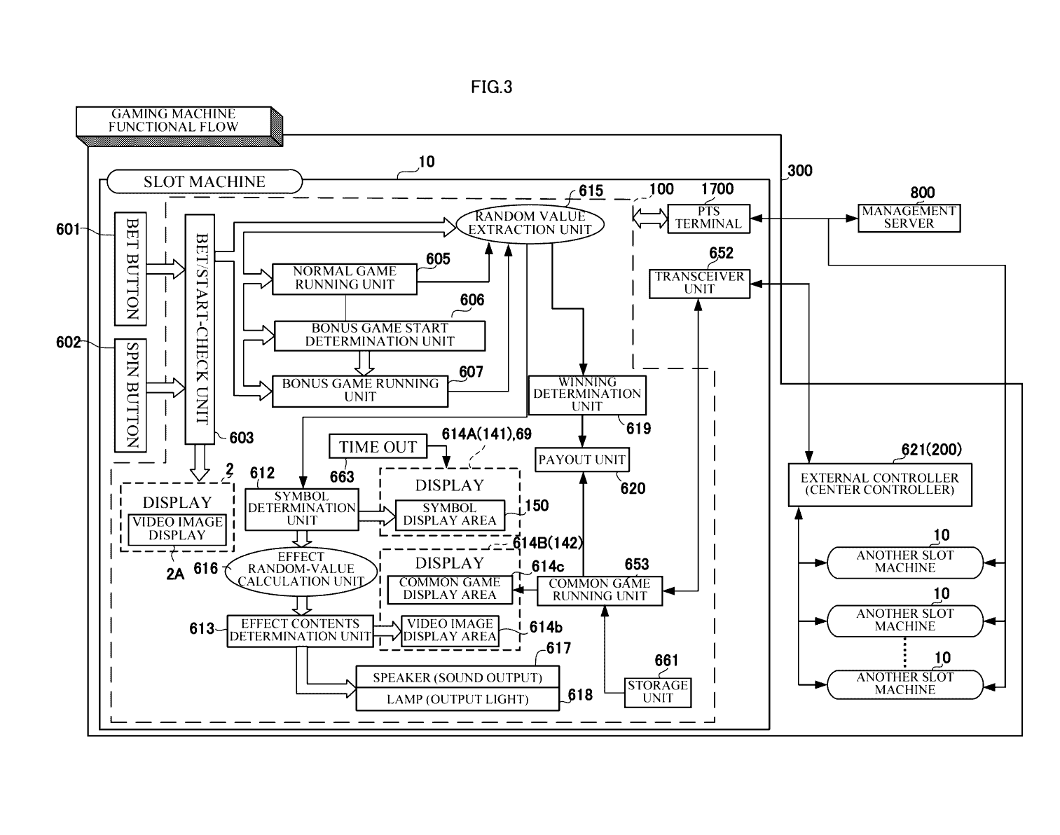

The gaming machine 300 having the above-described configuration includes a slot machine 10 and an external controller 621 (center controller 200) that is in data communicable connection with the slot machine 10, as shown in FIG. 3. The external controller 621 is in data communicable connection with a plurality of slot machines 10 installed in a hall.

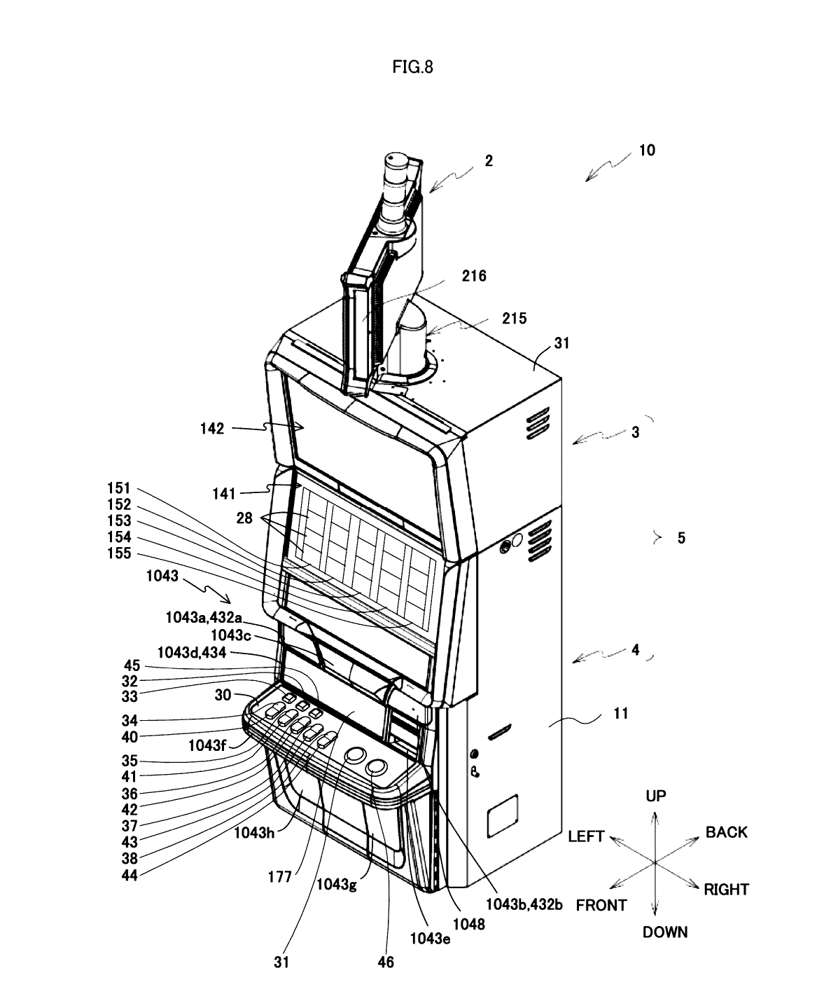

The slot machine 10 includes a BET button 601, a spin button 602, a display 614A (e.g., a lower image display panel 141 shown in FIG. 8), and a display 614B (e.g., a middle image display panel 142 shown in FIG. 8), and also includes a game controller 100 that controls these component parts. Each of the BET button 601 and the spin button 602 is an input device of one type. The slot machine 10 further includes a transceiver unit 652 that enables data communication with the external controller 621.

The BET button 601 mentioned above has a function of receiving a bet amount by being operated by the player. The spin button 602 has a function of receiving a start of a game such as the normal game by being operated by the player, that is, by receiving a start operation made thereon.

The display 614A has a function of displaying still image information and moving image information. The still image information includes various symbols, numerical values, codes, or the like. The moving image information includes effect video images, or the like. The display 614A, which further includes a touch panel 69 as an input device, has a function of receiving various instructions made by player's pressing operations thereon. The display 614 (A, B) includes a symbol display area 150, a video image display area 614b, and a common game display area 614c. The symbol display area 150 displays a reel screen including symbols. The display area 150 also displays a superimposition of a moving image (e.g., an animation) over a still image (e.g., symbols). The video image display area 614b displays, in the form of a moving image or a still image, various types of effect video image information to be executed during a game progress. The common game display area 614c is an area for displaying a common game.

For example, the video image display area 614b displays effects related to the bonus game described above.

In this embodiment, the symbol display area 150 and an area for displaying option images in the bonus game are set on the same screen of the lower image display panel 141. This, however, is not limiting. In addition, the common game display area 614c may be presented concurrently with the symbol display area 150 and the video image display area 614b, or alternatively may be replacedly presented only when the common game is run.

The display 614B includes the video image display area 614b as shown in FIG. 3. The display 614B has a function of displaying still image information and moving image information in the video image display area 614b. The still image information includes numerical values, codes, or the like. The moving image information includes effect video images, or the like. For example, the display 614B displays the amount of money or a payout table in the video image display area 614b. This display area also displays a superimposition of a moving image over a still image.

The game controller 100 includes a bet/start-check unit 603, a normal game running unit 605, a bonus game start determination unit 606, a bonus game running unit 607, a random value extraction unit 615, a symbol determination unit 612, an effect random-value calculation unit 616, an effect contents determination unit 613, a speaker 617, a lamp 618, a winning determination unit 619, and a payout unit 620.

The normal game running unit 605 has a function of running the normal game on condition that the BET button 601 is operated. The bonus game start determination unit 606 determines whether or not to run the bonus game based on a combination of symbols rearranged in the normal game. To be specific, the bonus game start determination unit 606 has a function of, for example, if a feature symbol 503 is rearranged in a predetermined condition, determining that a bonus game is won and shifting the processing to the bonus game running unit 607 so as to cause the bonus game to be run in the next unit game.

Here, the “unit game” represents a series of operations from a start of receiving a bet to a state in which an award can be established. For example, the unit game of the normal game includes a bet time for receiving a bet, a game time for rearranging stopped symbols, and a payout time for executing a payout process to award a payout, each of which occurs once. The unit game of the normal game is called a unit normal game. In this embodiment, a time period from when the player operates the spin button 602 to start variably displaying symbols to when the symbols are rearranged is set to be approximately three seconds. This, however, is not limiting.

As an additional remark, it is to be noted that the unit game of the free game represents a series of operations from a determination of symbols to be stopped or from a start of scrolling symbols to a state in which an award can be established. For example, the unit game of the free game includes a game time for rearranging stopped symbols and a payout time for executing a payout process to award a payout, each of which occurs once.

The bonus game running unit 607 has a function of repeatedly running the free game a plurality of times only by an operation on the spin button 602. It may be possible that the bonus game running unit 607 has a function of selecting one of a plurality of option images in the bonus game.

The symbol determination unit 612 has functions of: determining symbols to be rearranged by using a random value supplied from the random value extraction unit 615; rearranging the determined symbols in the symbol display area 150 of the display 614; outputting symbol rearrangement information to the winning determination unit 619; and outputting an effect designation signal to the effect random-value calculation unit 616 based on the state of symbol rearrangement.

The winning determination unit 619 has functions of: upon reception of the symbol rearrangement information about symbols rearranged and displayed on the display 614, determining whether or not a win is occurring; upon determining that a win is occurring, calculating a total payout amount based on a winning combination; and outputting a payout signal to the payout unit 620, the payout signal being based on the payout amount. The payout unit 620 has a function of paying out game values to the player, the game values being paid out in the form of coins, medals, credits, or the like. The payout unit 620 also has a function of adding credit data of a credit to be paid out to credit data stored in an IC card inserted in a PTS terminal 700 which will be described later.

The game controller 100 further includes a storage unit 661 that stores various kinds of bet amount data. The storage unit 661 is a device that rewritably stores data, such as a hard disk device or a memory.

The game controller 100 further includes a common game running unit 653. The common game running unit 653 has a function of outputting bet amount information to the external controller 621 for each unit base game, the bet amount information being based on a bet amount that has been bet in the normal game. It may be possible that the common game running unit 653 has functions of: running the common game in accordance with a game start command given from the external controller 621; and receiving a bet input made through the BET button 601 for a bet amount corresponding to common-game bet amount data stored in the storage unit 661, the common-game bet amount data concerning an amount bettable on the common game.

The game controller 100 is connected to a PTS terminal 700. The PTS terminal 700 is a unit in which an LCD, a microphone, a human body detection camera, etc. are integrated. The PTS terminal 700 has a function of, for example, producing a game effect by mutual communication with the game controller 100. In particular, the PTS terminal 700 has a card slot in which the IC card can be inserted. This allows the player to insert the IC card into the card slot so that the credit stored in the IC card can be used on the slot machine 10.

Upon reception of credit data from the PTS terminal 700, the game controller 100 updates a credit indicated in a display frame that is provided below the display 614B. Upon settlement of a game credit, the game controller 100 outputs settled credit data to the PTS terminal 700.

The PTS terminal 700 included in each of the plurality of slot machines 10 constituting the gaming machine 300 is communicably connected to a management server 800, and centrally manages downloading of images, the IC card, and the credit.

(Functional Flow of Gaming Machine 300: External Controller)

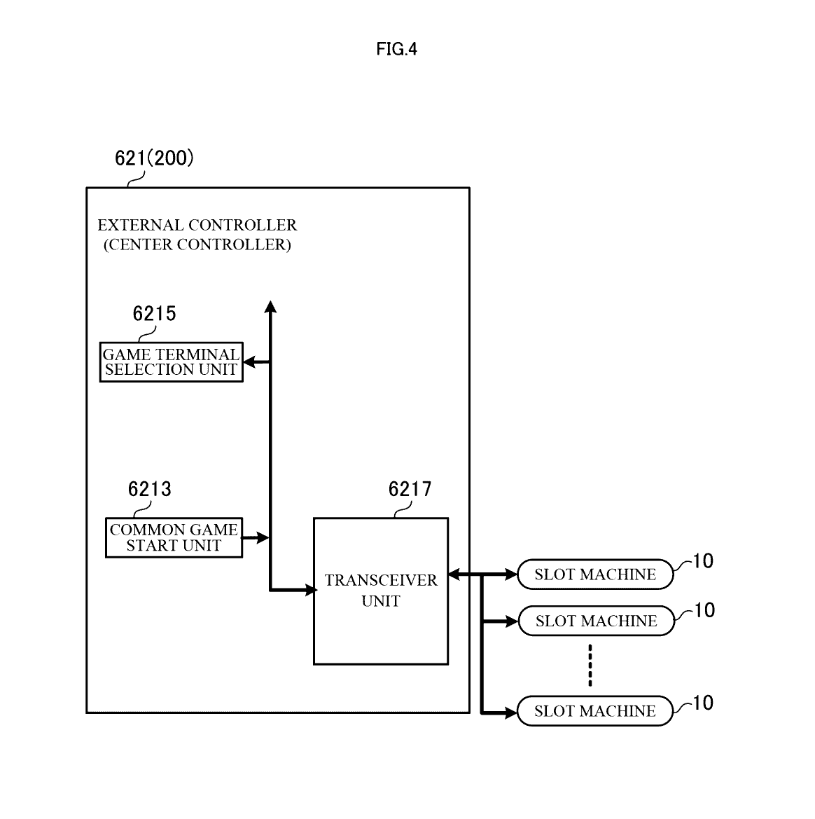

The slot machine 10 having the above-described configuration is connected to the external controller 621, as shown in FIG. 4. The external controller 621 has a function of remotely operating and monitoring the status of operations of the slot machines 10 and various kinds of processing such as a change of game setting values. The external controller 621 also has a function of determining whether or not a common game start condition is satisfied for each game terminal which is the slot machine 10, and upon determining that the common game start condition is satisfied in any of the game terminals, running a common game in the plurality of slot machines 10.

In more detail, the external controller 621 includes a common game start unit 6213, a game terminal selection unit 6215, and a transceiver unit 6217. The common game start unit 6213 has functions of: determining whether or not the common game start condition is satisfied based on an accumulated value of the bet amount information which is transmitted from the slot machine 10 for each unit base game; outputting the game start command to the plurality of slot machines 10; and displaying on a common display device the states until the common game start condition is satisfied.

The determination of whether or not the common game start condition is satisfied can be not only based on the accumulated value of the bet amount information but also based on all accumulated values that increase with repetition of the unit base game. For example, the number of times the base game is played, a game period for which the base game has been played, or the like, can be adopted as the accumulated value.

The common game start unit 6213 also has a function of outputting the game start command to the slot machine 10 in which the accumulated value that increases with repetition of the base game satisfies a game running condition. This configuration, in which the slot machine 10 whose accumulated value is less than a minimum setting value is not entitled to participate in the common game by the common game start unit 6213, can motivate the player to aggressively repeat the base game.

The common game start unit 6213 also has a function of monitoring a non-input duration in which the start operation is kept unperformed, and outputting the game start command to the slot machines 10 except the slot machine 10 whose non-input duration is equal to or longer than a timeout duration. Accordingly, if the base game has not been run for the timeout duration or longer in a slot machine 10, the common game start unit 6213 is able to determine that no player is present at the slot machine 10. Thus, running of the common game in such a slot machine 10 can be avoided.

The game terminal selection unit 6215 has a function of selecting a specific slot machine 10 from the plurality of slot machines 10 and outputting a common game start command signal to the specific slot machine 10. The common game start command signal authorizes the specific slot machine 10 to start the common game. The transceiver unit 6217 has a function of enabling transmission and reception of data to and from the slot machines 10.

(Operation of Gaming Machine 300)

Operations of the gaming machine 300 configured with the above-described functional blocks will be described. In this embodiment, the “game terminal” shown in the flowcharts represents the slot machine 10 configured to run a slot game. This, however, is not limiting.

(Operation of Slot Machine 10)

The slot machine 10 serving as the game terminal executes a terminal-side process. More specifically, a base game process (e.g., the normal game) is executed first. A series of operations is performed as follows.

(Credit/Start-Check)

First, after a credit is applied, the slot machine 10 checks whether or not the BET button 601 is pressed by a player, and subsequently checks whether or not the spin button 602 is pressed by the player.

(Symbol Determination)

Next, if the spin button 602 is pressed by the player, the slot machine 10 extracts random values for symbol determination, and determines symbols to be displayed to the player when symbol arrays 170 stop scrolling, for a plurality of respective video reels displayed on the display 614A.

(Symbol Display)

Next, the slot machine 10 starts scrolling the symbol array 170 of each of the video reels, and then stops scrolling so that the determined symbols are displayed to the player.

(Winning Determination)

After scrolling of the symbol array 170 of each video reel is stopped, the slot machine 10 determines whether or not a combination of symbols displayed to the player is a combination related to winning

(Payout)

Then, when the combination of symbols displayed to the player is a combination related to winning, the slot machine 10 offers benefits according to the type of the symbol combination to the player.

For example, if a combination of symbols related to a payout of a credit (coins) is displayed, the slot machine 10 pays out a credit to the player, the number of the credit corresponding to the combination of symbols.

Then, whether or not a bonus combination is won is determined. If the bonus combination is won, a bonus game process is executed. For example, if the number of feature symbols 503 rearranged in the symbol display area 150 is equal to or larger than a predetermined value, it is fixed that the free game is to be run. At this time, a lottery may be held to determine whether or not to run the bonus game. If the bonus combination is not won, the normal game is run again. During a period in which the base game including the above-mentioned normal game and bonus game is run, running state information is transmitted to the external controller 621. The running state information indicates starting and ending of a unit game of the normal game or the like and a bet amount for the unit game. This enables the external controller 621 to centrally manage the running state information of the respective slot machines 10.

(Operation of External Controller 621)

While the slot machine 10 is operating in the above-described manner, the external controller 621 executes a center-side process in synchronization with the slot machine 10, as follows.

First, the external controller 621 receives the running state information from the slot machine 10, to obtain the state of running of the base game. Then, the external controller 621 determines whether or not the common game start condition is satisfied in any of the slot machines 10 based on, for example, the number of times the base game has been repeated or an accumulated bet amount. If the common game start condition is not satisfied, the external controller 621 keeps obtaining the state of running of the base game in each slot machine 10.

If the common game start condition is satisfied, the game start command is simultaneously outputted to the slot machines 10 satisfying the game running condition. Then, a specific slot machine 10 is selected from the slot machines 10 satisfying the game running condition, and a common game start authorization command is outputted to the specific slot machine 10.

Thereafter, the external controller 621 waits until receiving the common game start command transmitted from the specific slot machine 10. Upon reception of the common game start command as a trigger, a win-or-lose of the common game is determined as a game result. For example, win, lose, or draw is determined as the game result. If the determined game result is not draw, a draw game result included in a series of game results temporarily stored is at least partially skipped, and the rest of the series of game results is sequentially outputted as game result information to the slot machines 10.

Then, based on a winning or losing game result, whether or not the common game is won is determined. If the common game is lost, the state of running of the base game in each slot machine 10 is newly obtained. If the common game is won, a payout amount is calculated based on the bet amount that has been bet in the common game at each slot machine 10. The payout amount is transmitted as payout information to each slot machine 10.

The external controller 621 is not limited to the above-described configuration. For example, in addition to or instead of the above-described configuration, a configuration is adoptable in which the running state information (payout amount) indicating the bet amount on the unit game, which is transmitted from each slot machine 10, is stored and the payout amount is reset in response to a request from each slot machine 10.

(Overall Configuration of Game System)

A game system 350 including the gaming machine 300 with the above-described functions will be described.

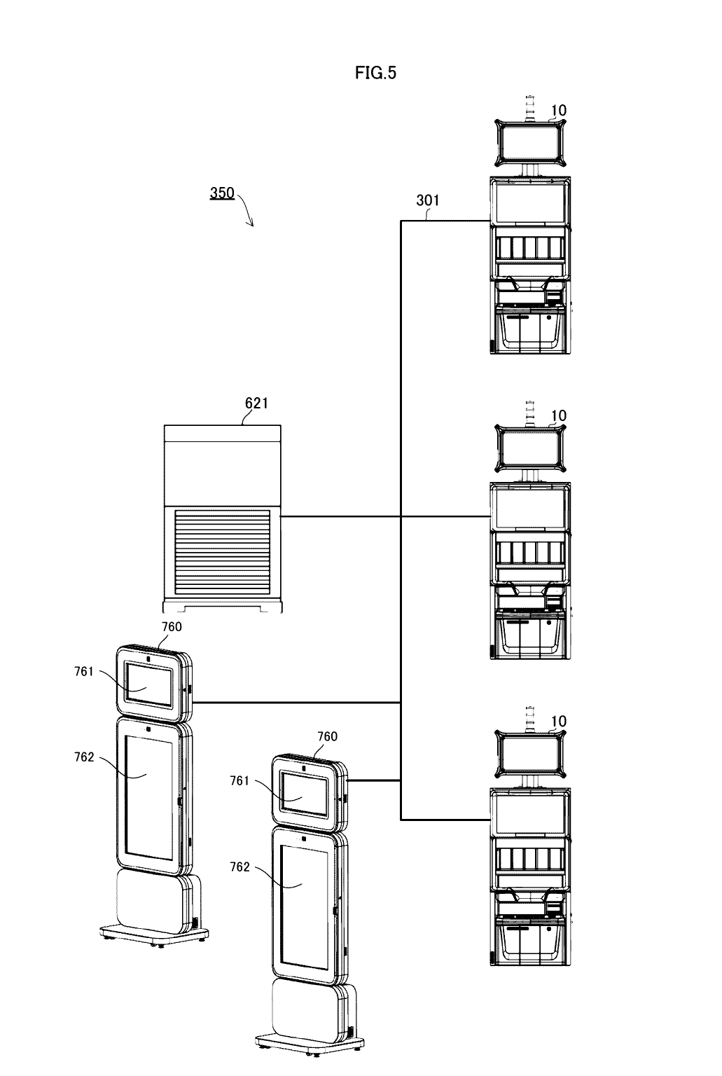

Referring to FIG. 5, the game system 350 includes a plurality of slot machines 10, one or more signages 760, and an external controller 621 that is connected to each of the slot machines 10 and the signages 760 through a communication line 301.

The external controller 621 controls the plurality of slot machines 10. In this embodiment, the external controller 621 is a so-called hall server which is installed in a game facility having the plurality of slot machines 10. Each of the slot machines 10 is provided with a unique identification number, and the external controller 621 identifies transmission sources of data transmitted from the respective slot machines 10 based on the identification numbers. Also when transmitting data to the slot machines 10, the external controller 621 identifies transmission destinations based on the identification numbers.

The signage 760 is an information display apparatus used mainly to display store advertisements (including a billboard), a hall floor guide, a jackpot status, and the like. The signage 760 is connected to a game system server via a network. The signage 760 includes two display units (an LCD 761 and an LCD 762 with a touch panel function)

It is to be noted that the game system 350 may be built within a single game facility where various games can be conducted, such as a casino, or may be built across a plurality of game facilities. Further, in a case of the game system 350 built in a single game facility, the game system 350 may be built in each floor or in each section of the game facility. The communication line 301 may be a wired or wireless line, and can adopt a dedicated line, an exchange line or the like.

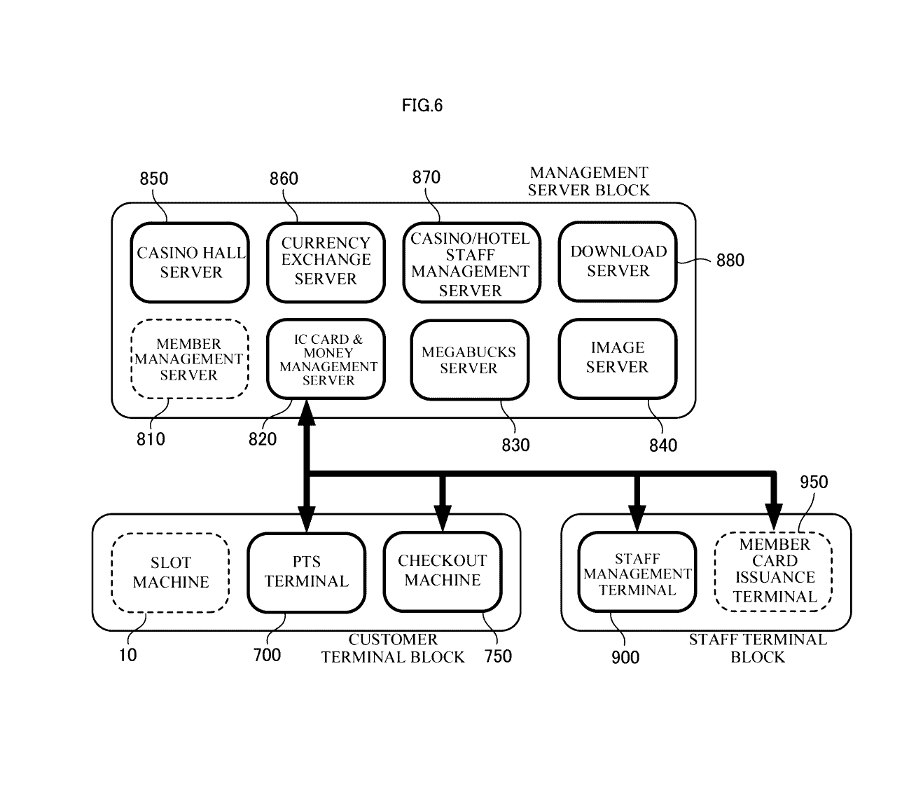

Referring to FIG. 6, the game system is roughly divided into three blocks, namely, a management server block, a customer terminal block, and a staff terminal block. The management server block includes a casino hall server 850, a currency exchange server 860, a casino/hotel staff management server 870, and a download server 880.

The casino hall server 850 is a server for managing the entire casino hall where the slot machines 10 are installed. The currency exchange server 860 is a server for generating exchange rate data based on currency exchange information and the like. The casino/hotel staff management server 870 is a server for managing staff persons of the casino hall or staff persons of a hotel associated with the casino hall. The download server 880 is a server for downloading the latest version of game-related information, news information, etc., and forwarding the information to the players via the PTS terminals 700 of the slot machines 10.

The management server block also includes a member management server 810, an IC card & money management server 820, a Megabucks server 830, and an image server 840.

The member management server 810 is a server for managing member information of players playing on the slot machines 10. The IC card & money management server 820 is a server for managing IC cards used on the slot machines 10. More specifically, the IC card & money management server 820 is a server for storing fractional cash data in association with identification codes and outputting the fractional cash data to the PTS terminals 700. The IC card & money management server 820 also generates and manages denomination rate data, etc. The Megabucks server 830 is a server for, for example, managing Megabucks which is a game configured such that the sum of bet amounts bet on a plurality of slot machines 10 installed in a plurality of casino halls is awarded as a payout. The image server 840 is a server for downloading the latest version of a game-related image, a news image, etc., and forwarding the image to the players via the PTS terminals 700 of the slot machines 10.

The customer terminal block includes the slot machine 10, the PTS terminal 700, and a checkout machine 750. The PTS terminal 700 is attachable to the slot machine 10 and mutually communicable with the management server 800. The checkout machine 750 is a machine for making settlement by providing cash in exchange for cash data stored in the player's IC card and for storing cash data into the IC card in exchange for coins, bills, or the like.

The staff terminal block includes a staff management terminal 900 and a member card issuance terminal 950. The staff management terminal 900 is a terminal by which the staff person of the casino hall manages the slot machines 10. Particularly in this embodiment, the staff person of the casino hall checks whether or not the number of IC cards stored in the PTS terminal 700 is too larger or too small. The member card issuance terminal 950 is a terminal by which a player playing a game in the casino hall issues a member card.

(PTS Terminal 700)

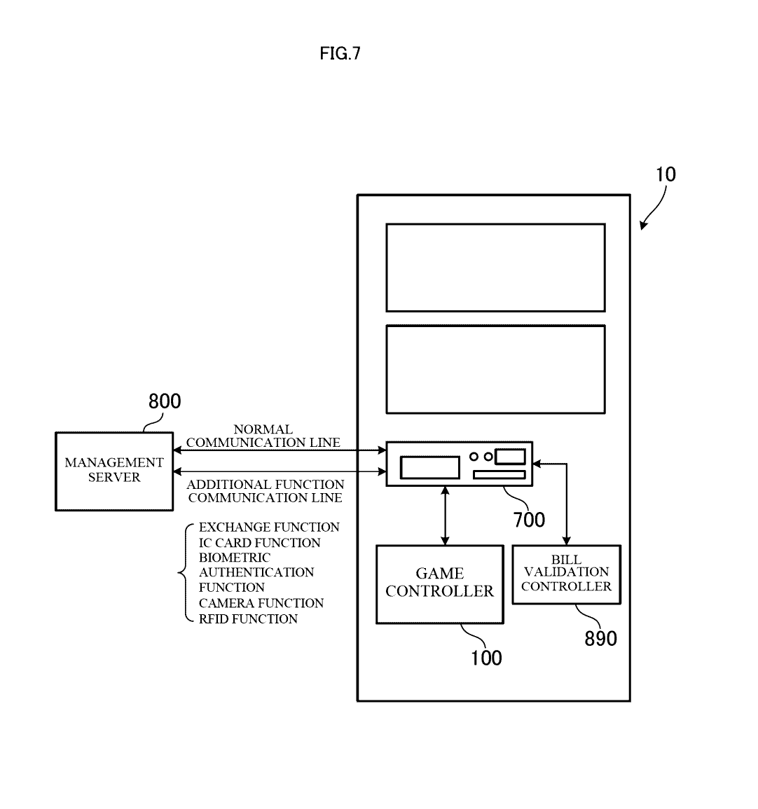

Referring to FIG. 7, the PTS terminal 700 is incorporated in a PTS system. The PTS terminal 700 attached to the slot machine 10 is communicably connected to the game controller 100 of the slot machine 10 and a bill validation controller 890.

The PTS terminal 700 produces sound or image effects for the game and updates the credit data based on communication with the game controller 100. The PTS terminal 700 transmits the credit data necessary for settlement based on communication with the bill validation controller 890.

The PTS terminal 700 is communicably connected to the management server 800. The PTS terminal 700 communicates with the management server 800 via two lines, namely, a normal communication line and an additional function communication line.

The normal communication line allows the PTS terminal 700 to transmit and receive data including cash data, identification code data, player's member information, and the like. The additional function communication line allows the PTS terminal 700 to conduct communications concerning newly added functions. In this embodiment, the additional function communication line allows the PTS terminal 700 to conduct communications concerning an exchange function, an IC card function, a biometric authentication function, a camera function, and an RFID (Radio Frequency IDentification) function which is a function for individual identification with use of radio waves.

(Machine Configuration of Slot Machine)

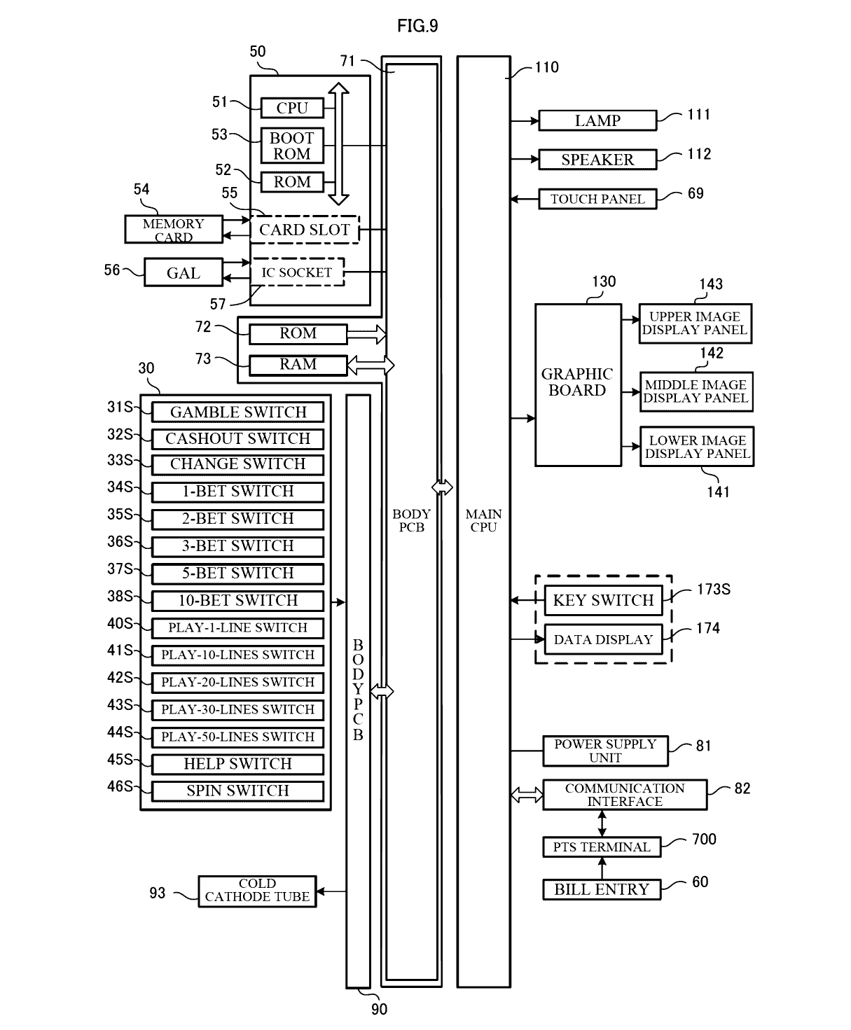

An overall structure of the slot machine 10 will be described with reference to FIGS. 8 and 9.

A bill or electrically valuable information equivalent to the bill is used as a game medium in the slot machine 10. Specifically, this embodiment adopts credit-related data such as cash data stored in the IC card.

The slot machine 10 includes topper equipment 2 and a gaming machine body 5 with the topper equipment 2 arranged on an upper wall thereof. The gaming machine body 5 includes two image display panels 141, 142 (the displays 614A, 614B in FIG. 3). The gaming machine body 5 includes a top apparatus 3 provided with a middle image display panel 142 and an apparatus body 4 provided with a lower image display panel 141. The apparatus body 4 has the top apparatus 3 arranged on an upper wall thereof.

The topper equipment 2 has a function of making the slot machine 10 prominent even from a remote place, and also has a function of making game contents of the slot machine 10 visible even from a remote place.

The top apparatus 3 has a function of displaying game-related information such as specific game contents, a payout amount, a payout table, rules, and the like. The apparatus body 4 has a function of running the game.

The topper equipment 2 is arranged on the upper wall of the top apparatus 3 such that the topper equipment 2 is at the highest position in the slot machine 10. The topper equipment 2 has a rotation shaft coaxially extending in the vertical direction of the slot machine 10. The topper equipment 2 is rotatable in forward and reverse directions within a predetermined angular range about the rotation shaft. This allows the topper equipment 2 to be switchable between a front facing posture and a tilted posture. With the front facing posture, a display surface (video image display unit 2a) of a liquid crystal display device for displaying game contents faces frontward. With the tilted posture, the display surface (video image display unit 2a) faces obliquely frontward. The front facing posture is a posture taken in a normal state including a game running state, a waiting state, and the like. The front facing posture allows people (players, persons involved in the game facility, etc.) at a distance from the slot machine 10 to visually recognize the game contents. The tilted posture is an extraordinary posture taken at a time of changing the display of the topper equipment 2. With the tilted posture, a side plate cover 216 (replacement mechanism) provided in a right side portion of the topper equipment 2 is placed in a front position, which enables an operation for changing the display of the topper equipment 2 to be performed from the front side of the slot machine 10.

The top apparatus 3 includes a top box 31 and an middle image display panel 142 (liquid crystal display device) arranged on a front surface of the top box 31. The middle image display panel 142 displays a payout amount, a payout table, and the like.

The apparatus body 4 is opened in its front surface and lower surface. A screen displayed on the lower image display panel 141 has a symbol display area 150 in its center part. The symbol display area 150 is made up of twenty display blocks 28 that form five columns and four rows. Symbols included in the respective columns constitute pseudo reels 151a to 155a (a group of video reels A) and pseudo reels 151b to 155b (a group of video reels B). On the pseudo reels 151 to 155, the symbols included in the columns move downward with their speeds changed as a whole, so that the symbols displayed in the display blocks 28 are rotated (variably displayed) in the vertical direction and then stopped for rearrangement. Details of a display screen of the lower image display panel 141 will be described later.

While this embodiment illustrates the case where the slot machine 10 is a so-called video slot machine, the slot machine 10 of the present invention may adopt a so-called mechanical reel in substitution for some of all of the pseudo reels 151 to 155.

The touch panel 69 is provided on the front surface of the lower image display panel 141 (liquid crystal display device). The touch panel 69 enables the player to input various instructions by touching and operating the display screen of the lower image display panel 141. The touch panel 69 transmits an input signal to the main CPU 71 (see FIG. 9).

A control panel 30 is arranged below the lower image display panel 141. As shown in FIG. 8, the control panel 30 has buttons. The control panel 30 has a change button 33, a cashout button 32, and a help button 45, which are arranged farther from the player. The control panel 30 has a 1-BET button 34, a 2-BET button 35, a 3-BET button 36, 5-BET button 37, and a 10-BET button 38, which are arranged in a middle region. The control panel 30 also has a play-1-line button 40, a play-10-lines button 41, a play-20-lines button 42, a play-30-lines button 43, and a play-50-lines button 44, which are arranged in a central region closer to the player. The control panel 30 has a spin button 46, which is arranged in a right region closer to the player. A gamble button 31 is arranged on the left side of the spin button 46. These buttons 31 to 38, 40 to 46 have built-in LEDs, though not shown. The ON/OFF of each of the LEDs is controllable.

The change button 33 is an operation button used when the player leaves the slot machine 10 or asks a staff person of the game facility for money exchange.

The cashout button 32 is an operation button used for redeeming a credit deposited in the slot machine 10. The cashout button 32 is a so-called settlement button by which credit data about a credit obtained in games is added to the credit data stored in the IC card inserted in the PTS terminal 700.

The help button 45 is a button pressed when the player has a question about how to play the game, or the like. If the help button 45 is pressed, for example, various kinds of help information are displayed on the upper image display panel 143, the lower image display panel 141, and the like.

The BET buttons 34 to 38 are buttons for selecting a multiplying factor (BET multiplying factor) to be applied to the activated payline. The 1-BET button 34 is a button for playing the game with application of 1 BET (the multiplying factor is “1”) to each activated payline. The 2-BET button 35 is a button for playing the game with application of 2 BET to each activated payline. The 3-BET button 36 is a button for playing the game with application of 3 BET to each activated payline. The 5-BET button 37 is a button for playing the game with application of 5 BET to each activated payline. The 10-BET button 38 is a button for playing the game with application of 10 BET to each activated payline.

The play-1-line button 40 is a button that activates one payline when pressed. As a result, the number of activated paylines (activated paylines) becomes “1”. The play-10-lines button 41 is a button that activates ten paylines when pressed. As a result, the number of activated paylines becomes “10”. The play-20-lines button 42 is a button that activates twenty paylines when pressed. As a result, the number of activated paylines becomes “20”. The play-30-lines button 43 is a button that activates thirty paylines when pressed. As a result, the number of activated paylines becomes “30”. The play-50-lines button 44 is a button that activates fifty paylines when pressed. As a result, the number of activated paylines becomes “50”.

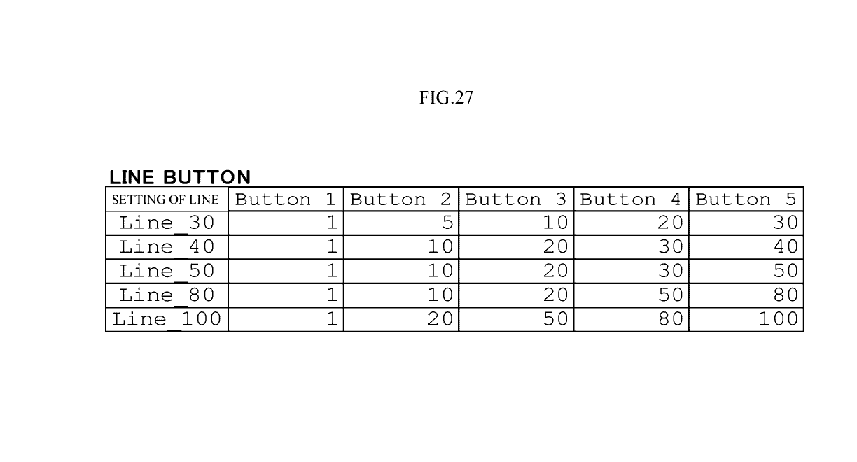

In this embodiment, the number of paylines to be activated upon pressing of each of the BET buttons 34 to 38 is set in association with the maximum number of paylines activatable in a unit game (the maximum number of activated paylines) (see FIG. 27), and the number of activated paylines can be set as appropriate via a setting screen, etc. In this embodiment, a case where the maximum number of activated paylines is set to be “50” will be illustrated as an example.

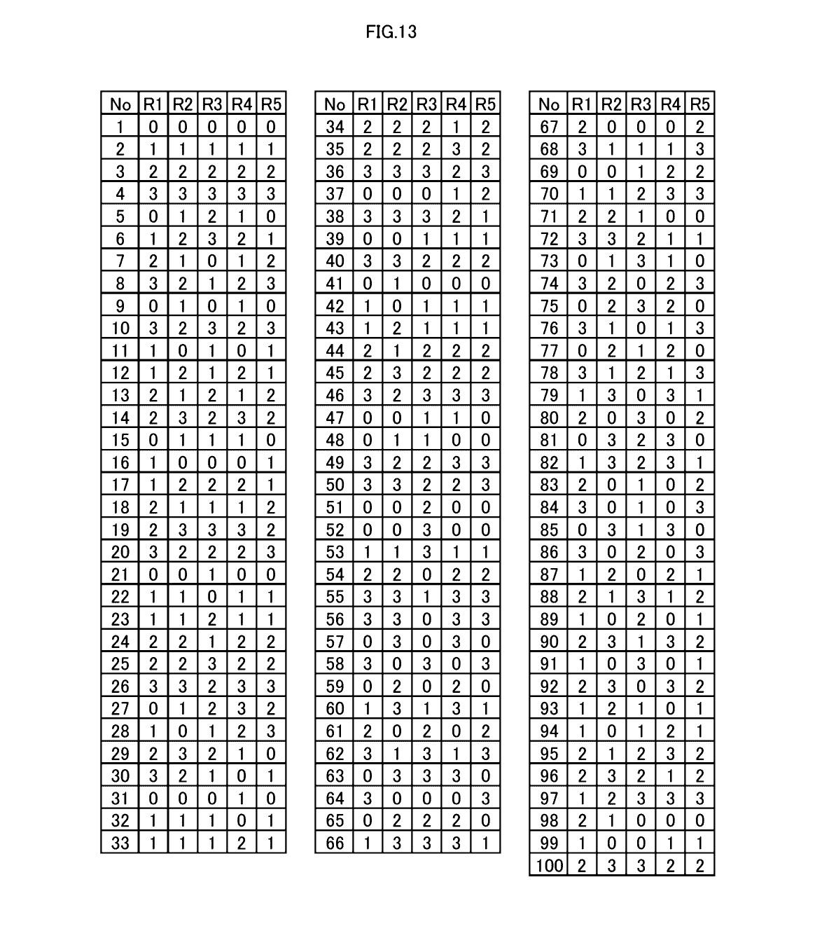

The number of paylines activated upon pressing of the play-1-line button 40 is only “1” (e.g., No. 1 in FIG. 13). The number of paylines activated upon pressing of the play-10-lines button 41 is “1” to “10” (e.g., Nos. 1 to 10 in FIG. 13). The number of paylines activated upon pressing of the play-20-lines button 42 is “1” to “20” (e.g., Nos. 1 to 20 in FIG. 13). The number of paylines activated upon pressing of the play-30-lines button 43 is “1” to “30” (e.g., Nos. 1 to 30 in FIG. 13). The number of paylines activated upon pressing of the play-50-lines button 44 is “1” to “50” (e.g., Nos. 1 to 50 in FIG. 13). This configuration is not limiting. For example, a configuration that constantly activates a predetermined number of paylines (for example, fifty paylines) is also acceptable.

A BET operation is performed, for example, as follows. First, by using the play-line buttons 40 to 44, the player determines a value based on which the number of BETs used in one game is determined. Then, by using the BET buttons 34 to 38, the player selects a BET multiplying factor (a multiplying factor to be applied when a payout is obtained: a payout multiplying factor). For example, if a game is started with selection of the play-50-lines button 44 and the 2-BET button 35, the total number of BETs used in one game is [50 credits×2=100 credits], while the payout multiplying factor is “2”. Either the BET buttons 34 to 38 or the play-line button 40 to 44 can be operated first.

The spin button 46 is a button used for starting scrolling the symbol arrays 170 having symbols. The spin button 46 is also used for starting a spin under the same BET condition (the number of BETs, the BET multiplying factor) as previous.

The gamble button 31 is an operation button used for shifting to a gamble game after the bonus game ends, for example. The gamble game is a game played by using obtained credits.

A lower door device 1043 to which the controller 30 is mounted includes a front mask part 1043c, speaker parts 1043a, 1043b, a PTS part 1043d, and a bill part 1043e. The front mask part 1043c is arranged in an upper central portion of the lower door device 1043. The speaker parts 1043a, 1043b are arranged in a horizontally symmetric manner about the front mask part 1043c. The bill part 1043e is arranged on the right side of the PTS part 1043d. The lower door device 1043 further includes a control panel part 1043f, a bill covering part 1043g, and a lower front covering part 1043h. The control panel part 1043f is arranged below the PTS part 1043d and the bill part 1043e. The bill covering part 1043g is arranged at a right-side position below the control panel part 1043f. The lower front covering part 1043h is arranged on the left side of the bill covering part 1043g. These parts 1043a to 1043h are formed by assembling various members to a lower door base member 1048.

The front mask part 1043c has a front mask cover provided on a forefront surface thereof. The front mask cover has its apex on the front side. The speaker parts 1043a, 1043b have speaker covers 432a, 432b provided on forefront surfaces thereof. The speaker covers 432a, 432b have a large number of holes. The speaker parts 1043a, 1043b also have speakers arranged behind the speaker covers 432a, 432b, respectively. The PTS part 1043d has a PTS cover 434 provided on a forefront surface thereof. A PTS device 700 (not shown) is attached in replacement of the PTS cover 434 as need arises.

The PTS terminal 700 is a single unit in which various devices having a microphone function, a camera function, a speaker function, a display function, etc., are integrated. More specifically, the PTS terminal 700 includes an LCD, a human body detection camera, a microphone, a bass reflex type (bass/reflex type) speaker, and the like. The human body detection camera is able to detect the presence or absence of the player due to its camera function. The microphone is used when the player participates in a game with his/her voice and when the player is authenticated based on voice recognition. The speaker produces sound effects for the game, and outputs an alarm sound when the IC card is left inserted. The speaker also outputs an alarm sound when an authentication of the inserted IC card is failed.

The PTS terminal 700 further includes an LED and a card slot. The LED lights up in multicolor, thereby warning about the number of remaining IC cards accumulated in a card stacker. The card slot has a mechanism allowing an IC card to be inserted therein and taken out therefrom. The IC card has a display unit. The IC card, which is completely inside while the player is playing the game, is ejected such that the display unit thereof is exposed at a time of settlement. This enables the player to check the update of credit-related data such as cash data. Alternatively, the IC card may not be completely inside but held with its display unit exposed while the player is playing the game. This enables the player to check the update of the credit all the time during the game.

If the human body detection camera detects the absence of the player at a time of credit settlement, the IC card is retracted inside and stored in the card stacker. Accordingly, for example, even when the player who has confirmed on the display unit that the amount of remaining credits is small intentionally leaves the slot machine 10 with the IC card inserted, a situation where the IC card is left inserted for a long time is prevented.

The PTS terminal 700 is provided with a VFD 177. As shown in FIG. 8, a game status area is provided in the middle of the VFD 177, to display a game status. The game status area displays a bonus state, winning contents, an obtained credit, and the like. In addition to them, a credit, the total number of bets, a denomination, a line, a bet, and a win meter are displayed.

(Electrical Configuration of Slot Machine)

Next, a configuration of a circuit included in the slot machine 10 will be described with reference to FIG. 9.

A gaming board 50 is provided with: a CPU 51, a ROM 52, and a boot ROM 53, which are mutually connected by an internal bus; a card slot 55 corresponding to a memory card 54; and an IC socket 57 corresponding to a GAL (Generic Array Logic) 56.

The memory card 54 includes a non-volatile memory, and stores a game program and a game system program. The game program includes a program related to a game progress and a program for producing effects by images and sounds. Further, the aforementioned game program includes a symbol determination program. The symbol determination program is a program for determining symbols to be rearranged in the display blocks 28.

The game program further includes: normal game symbol table data representing a normal game symbol table that indicates the correspondence relationship among each symbol of each symbol array 170, a code number, and a random value; symbol number determination table data representing a symbol array determination table; code number determination table data representing a code number determination table; and odds data representing the correspondence relationship among an activated reel position number (activate area), the type and number of rearranged symbols, and a payout amount, etc.

Further, the card slot 55 is configured such that the memory card 54 can be inserted thereinto and removed therefrom, and is connected to a motherboard by an IDE bus. Thus, the type and contents of the game to be played on the slot machine 10 can be changed by taking the memory card 54 out of the card slot 55, writing another game program into the memory card 54, and inserting the memory card 54 into the card slot 55.

The GAL 56 is a type of PLD (Programmable Logic Device) having a fixed OR array structure. The GAL 56 is provided with a plurality of input ports and output ports, and predetermined input into the input port causes output of the corresponding data from the output port.

Further, the IC socket 57 is configured so that the GAL 56 can be inserted thereinto and removed therefrom, and is connected to the motherboard by a PCI bus. The contents of the game to be played on the slot machine 10 can be changed by replacing the memory card 54 with a card having another program written therein or by rewriting the program of the memory card 54 into another program.

The CPU 51, the ROM 52 and the boot ROM 53 mutually connected by the internal bus are connected to the motherboard by a PCI bus. The PCI bus enables a signal transmission between the motherboard and the gaming board 50, and power supply from the motherboard to the gaming board 50.

The ROM 52 stores an authentication program. The boot ROM 53 stores a pre-authentication program, a program (boot code) to be used by the CPU 51 for activating the pre-authentication program, and the like.

The authentication program is a program (tamper check program) for authenticating the game program and the game system program. The pre-authentication program is a program for authenticating the aforementioned authentication program. The authentication program and the pre-authentication program are written along a procedure (authentication procedure) for proving that the program to be the subject has not been tampered.

The motherboard, which is configured with a general-purpose mother board commercially available (a printed circuit board on which basic parts of a personal computer are mounted), includes a main CPU 71, a ROM (Read Only Memory) 72, a RAM (Random Access Memory) 73, and a communication interface 82. The motherboard corresponds to the game controller 100 of this embodiment.

The ROM 72 includes a memory device such as a flash memory, and stores a program such as BIOS (Basic Input/Output System) to be executed by the main CPU 71, and permanent data. When the BIOS is executed by the main CPU 71, processing for initializing predetermined peripheral devices is conducted; further, through the gaming board 50, processing of loading the game program and the game system program stored in the memory card 54 is started. In this embodiment, the ROM 72 may be either rewritable or non-rewritable.

The RAM 73 stores data which are used in operation of the main CPU 71 and programs such as the symbol determination program. For example, when the processing of loading the aforementioned game program, game system program or authentication program is conducted, the RAM 73 can store the program. The RAM 73 is provided with working areas used for operations in execution of these programs. Examples of the areas include: an area that stores a counter for managing the number of plays, the number of BETs, the number of payouts, the number of credits and the like; and an area that stores symbols (code numbers) determined by a lottery.

The communication interface 82 is for communicating with the external controller 621 such as a server, through the communication line 301. Further, the motherboard is connected with a later-described door PCB (Printed Circuit Board) 90 and a body PCB 110 by respective USBs. The motherboard is also connected with a power supply unit 81. The motherboard is also connected with the PTS terminal 700 by a USB.

A bill entry 60 is electrically connected to the PTS terminal 700. The bill entry 60 identifies whether or not a bill is proper, and receives a genuine bill into a cabinet 11. Upon reception of the genuine bill, the bill entry 60 transmits an input signal based on the amount of the bill to the PTS terminal 700. The input signal includes information such as credit data of the received bill. A credit equivalent to the bill received into the cabinet 11 is added as a credit owned by the player.

When power is supplied from the power supply unit 81 to the motherboard, the main CPU 71 of the motherboard is activated, and then power is supplied to the gaming board 50 through the PCI bus so as to activate the CPU 51.

The door PCB 90 and the body PCB 110 are connected with input devices such as a switch and a sensor, and peripheral devices the operations of which are controlled by the main CPU 71.

The door PCB 90 is connected with the control panel 30 and a cold cathode tube 93.

The control panel 30 is provided with a gamble switch 31S, a cashout switch 32S, a change switch 33S, a 1-BET switch 34S, a 2-BET switch 35S, a 3-BET switch 36S, a 5-BET switch 37S, a 10-BET switch 38S, a play-1-line switch 40S, a play-10-lines switch 41S, a play-20-lines switch 42S, a play-30-lines switch 43S, a play-50-lines switch 44S, a help switch 45S, and a spin switch 46S, which correspond to the above-mentioned buttons, respectively. Each of the switches detects the corresponding button being pressed by the player, and outputs a signal to the main CPU 71.

The cold cathode tube 93 functions as an effect mechanism (e.g., a lamp 111) and as a backlight installed on the rear face sides of the lower image display panel 141, and lights up based on a control signal outputted from the main CPU 71.

The body PCB 110 is connected with the lamp 111, a speaker 112, the touch panel 69, a graphic board 130, a key switch 173S, and a data display 174. The lamp 111 lights up, blinks, or turns off based on a control signal outputted from the main CPU 71. The speaker 112 outputs sounds such as BGM, based on a control signal outputted from the main CPU 71.

The touch panel 69 detects a place on the lower image display panel 141 touched by the player's finger or the like, and outputs to the main CPU 71 a signal corresponding to the detected place.

The graphic board 130 controls display of images conducted by the respective lower image display panel 141, middle image display panel 142, and upper image display panel 143, based on a control signal outputted from the main CPU 71. The graphic board 130 is provided with a VDP (Video Display Processor) for generating image data, a video RAM for storing the image data generated by the VDP, and the like. It is to be noted that the image data used in generation of image data by the VDP is included in the game program that has been read from the memory card 54 and stored into the RAM 73.

The key switch 173S is provided in a keypad 173, and outputs a predetermined signal to the main CPU 71 when the keypad 173 has been operated by the player. The data display 174 displays data read by a card reader 172 and data inputted through the keypad 173, based on a control signal outputted from the main CPU 71.

(Configuration of Screen of Image Display Panel)

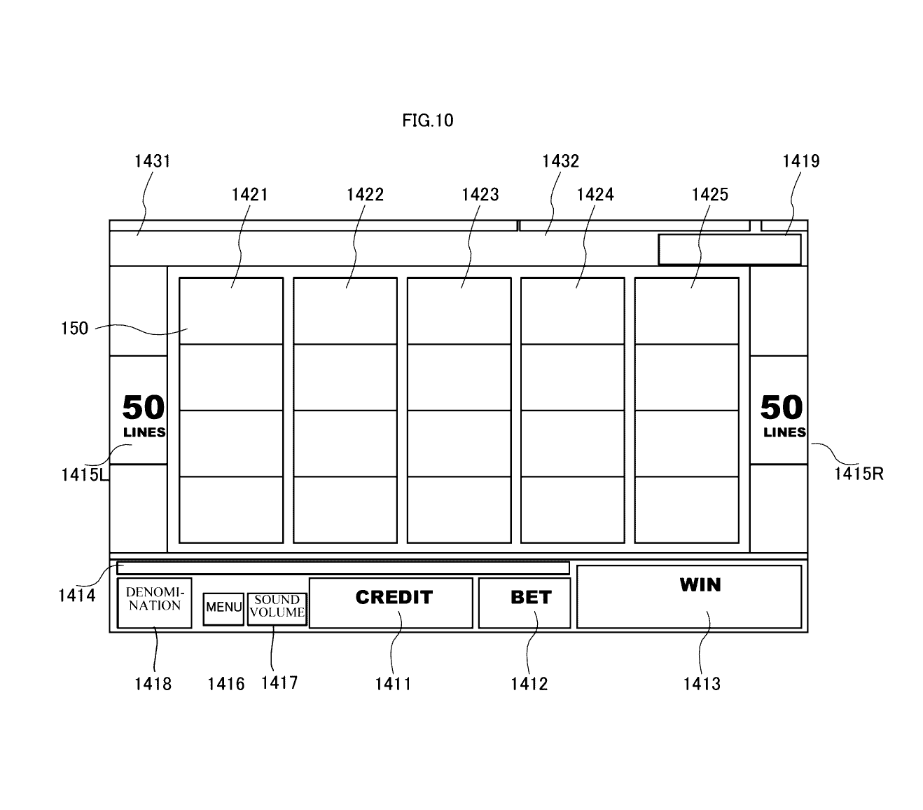

FIG. 10 shows an exemplary configuration of the screen of the lower image display panel 141 in the normal game. The lower image display panel 141 includes a credit meter indicator 1411, a BET meter indicator 1412, a WIN meter indicator 1413, a game state display part 1414, number-of-activated-payline indicators 1415L and 1415R, a MENU icon 1416, a sound volume icon 1417, a denomination indicator 1418, a time indicator 1419, a first display column 1421, a second display column 1422, a third display column 1423, a fourth display column 1424, a fifth display column 1425, an error history indicator 1431, and a system message indicator 1432.

In an upper portion of the screen of the lower image display panel 141, the error history indicator 1431, the system message indicator 1432, and the time indicator 1419 are arranged in the mentioned order from the left side.

In a middle portion of the screen of the lower image display panel 141, the number-of-activated-payline indicator 1415L, the symbol display area 150, and the number-of-activated-payline indicator 1415R are arranged in the mentioned order from the left side. In a lower portion of the screen of the lower image display panel 141, the denomination indicator 1418, the MENU icon 1416, the sound volume icon 1417, the credit meter indicator 1411, the BET meter indicator 1412, and the WIN meter indicator 1413 are arranged in the mentioned order from the left side.

The credit meter indicator 1411 is an area for indicating the total number of credits (the number of remaining credits). A default value thereof is “0”. Increase/decrease of the numerical value is effected at the following timing. In one example, a win credit (the number of payouts) is calculated based on a winning combination (a take-win which is winning of a game), and the total number of win credits obtained is added. In one example, the total number of BETs, which will be described below, is subtracted at a time of starting a game. The credit meter indicator 1411 is an area for indicating the total amount of credits (the amount of remaining credits). The total amount of credits is calculated as the total number of credits×denomination.

The BET meter indicator 1412 is an area for indicating the total number of BETs in the current game or the last game. The total number of BETs is calculated as the number of BETs (e.g., “1”, “10”, “20”, “30”, or “50”)×the BET multiplying factor (e.g., “1”, “2”, “3”, “5”, or “10” in Config_2). The numerical value thereof is re-calculated each time a game is started.

The BET meter indicator 1412 is an area for indicating the total BET amount in the current game or the last game. The total BET amount is calculated as the total number of BETs×denomination.

The WIN meter indicator 1413 is an area for indicating the total number of win credits obtained. The default value thereof is “0”.

The WIN meter indicator 1413 is also an area for indicating the total amount of win credits. The total amount of win credits is calculated as the total number of win credits×denomination.

The game state display part 1414 is an area for displaying BET information about the current game or the last game and the current game state. The number-of-activated-payline indicators 1415L, 1415R are areas for displaying the number of activate paylines (the number of activated paylines).

The MENU icon 1416 is an icon that allows touch interaction. If the touch interaction is made, a first page of a help screen is displayed. The MENU icon 1416 is darkened and the touch interaction is not allowed while it is inactivated, for example, while the symbol display columns 1421 to 1425 are rotating.

The help screen is displayed in a central region of the lower image display panel 141, though not shown. An EXIT touch icon, a PREY touch icon, a NEXT touch icon, a denomination indicator, a time indicator, and the like, are displayed below the help screen. The EXIT touch icon is for clearing the help screen and returning to a normal game screen. The PREY touch icon is for flipping the help screen one page before. The NEXT touch icon is for flipping the help screen one page ahead. The denomination indicator is the same as later-described one. The time indicator is the same as later-described one.

The sound volume icon 1417 is an icon that allows touch interaction. If the touch interaction is made, the volume of a game sound is changed. The sound volume icon 1417 is used for adjusting the volume of a sound outputted from the slot machine 10. Each time the touch interaction is made, the volume of a game sound is changed in the order of, for example, low (30%), middle (70%), high (100%), low, and middle. The sound volume is set low by default. After the slot machine 10 is activated and when the display of an audit (setting screen) is deactivated, the sound volume is reset to the default state.

The denomination indicator 1418 is an area for indicating the current denomination that has been set by the audit.

The time indicator 1419 is an area for indicating the current time.

In the symbol display area 150, the first display column 1421, the second display column 1422, the third display column 1423, the fourth display column 1424, and the fifth display column 1425 are arranged in the mentioned order from the left side.

Each of the first to fifth display columns 1421 to 1425 has the display blocks 28 in the first, second, third, and fourth stages thereof. The display block 28 is configured to display a symbol of each symbol array 170, that is, two symbols in total, namely, a symbol of the video reels A and a symbol of the video reels B.

The error history indicator 1431 is an area for indicating an error history. If there are two or more errors, they are indicated in a switching manner.

The system message indicator 1432 is an area for indicating information about a payout, a ticket history, communications, and the like.

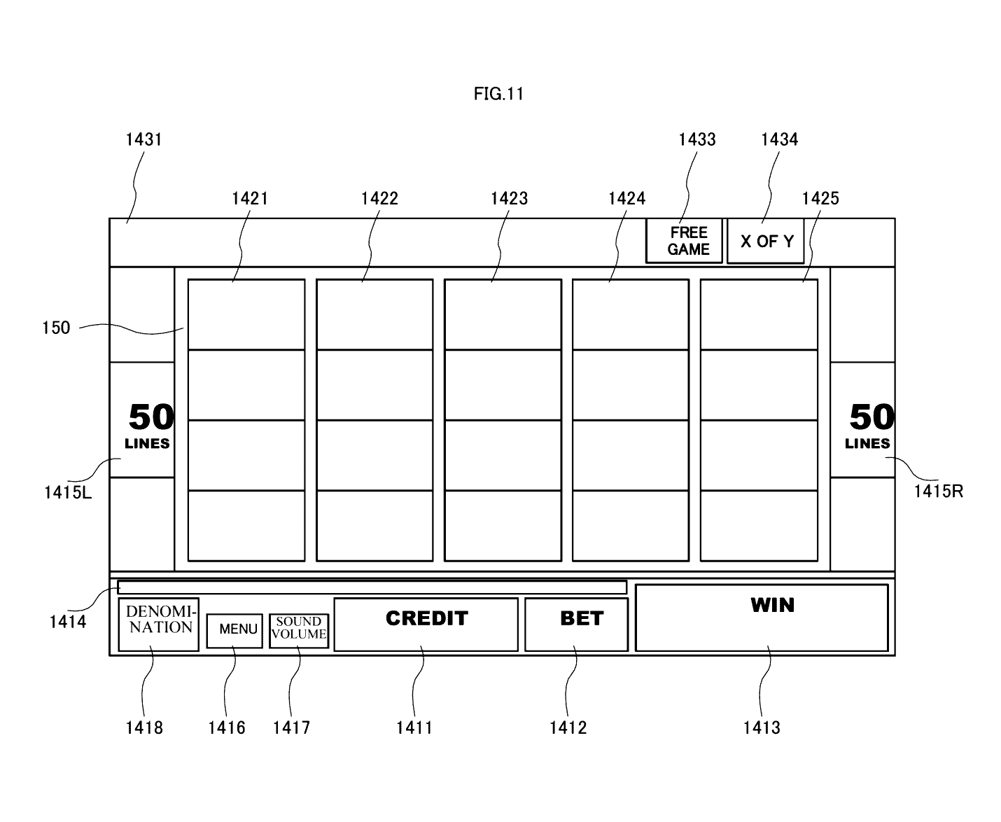

FIG. 11 shows an exemplary configuration of the screen of the lower image display panel 141 in the free game. The same configurations as those of FIG. 10 are denoted by the same reference signs, and descriptions thereof may be omitted as appropriate.

The lower image display panel 141 includes the credit meter indicator 1411, the BET meter indicator 1412, the WIN meter indicator 1413, the game state display part 1414, the number-of-activated-payline indicators 1415L and 1415R, the MENU icon 1416, the sound volume icon 1417, the denomination indicator 1418, the first display column 1421, the second display column 1422, the third display column 1423, the fourth display column 1424, the fifth display column 1425, a game type indicator 1433, and a number-of-game indicator 1434.

The time indicator 1419, the error history indicator 1431, the system message indicator 1432, or the like, may be provided.

In the credit meter indicator 1411, the total number of credits (the number of remaining credits) is updated when the free game ends. In the BET meter indicator 1412, the total number of BETs at the time of starting the free game is indicated during the free game. In the WIN meter indicator 1413, the total number of win credits is cumulatively displayed during the free game.

The game type indicator 1433 is an area for indicating the game type. An indication of “FREE GAME”, which indicates that the free game is currently played, is shown during the free game.

The number-of-game indicator 1434 is an area for indicating the total number of games and the current number of games. The total number of games represents the number of times the free game can be enjoyed. In the “X of Y” indication, the “X” starts increasing simultaneously (substantially simultaneously) with when the pseudo reels 151a to 155a start rotating (scrolling), to show to the player that the game is progressing one by one. Before the free game is started, the value “0” is applied to “X”. Simultaneously with the start of rotation of the pseudo reels 151a to 155a, the count of “+1” is applied to “X”, and a numeric character is displayed in an enlarged manner with issuance of a voice.

(Activated Payline)

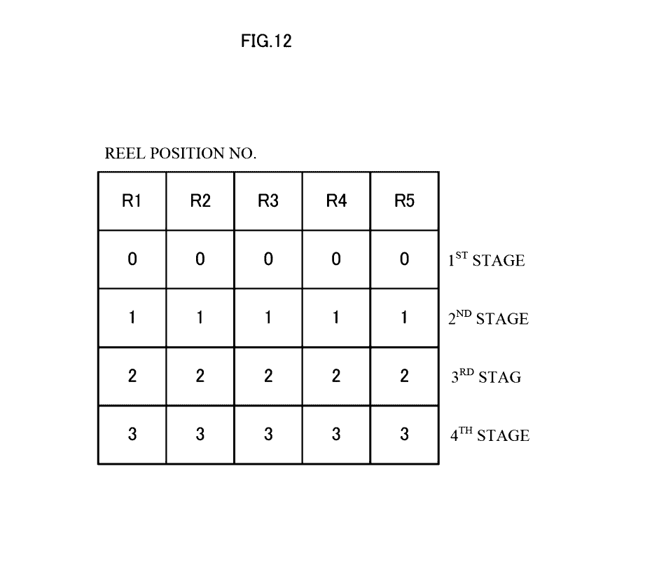

FIG. 12 shows an example of reel positions. The reel position is data that enables identification of the position of the display block 28 in the symbol display area 150. For example, the reel position is defined as “R1,1” for the display block 28 in the second stage of the leftmost first display column 1421.

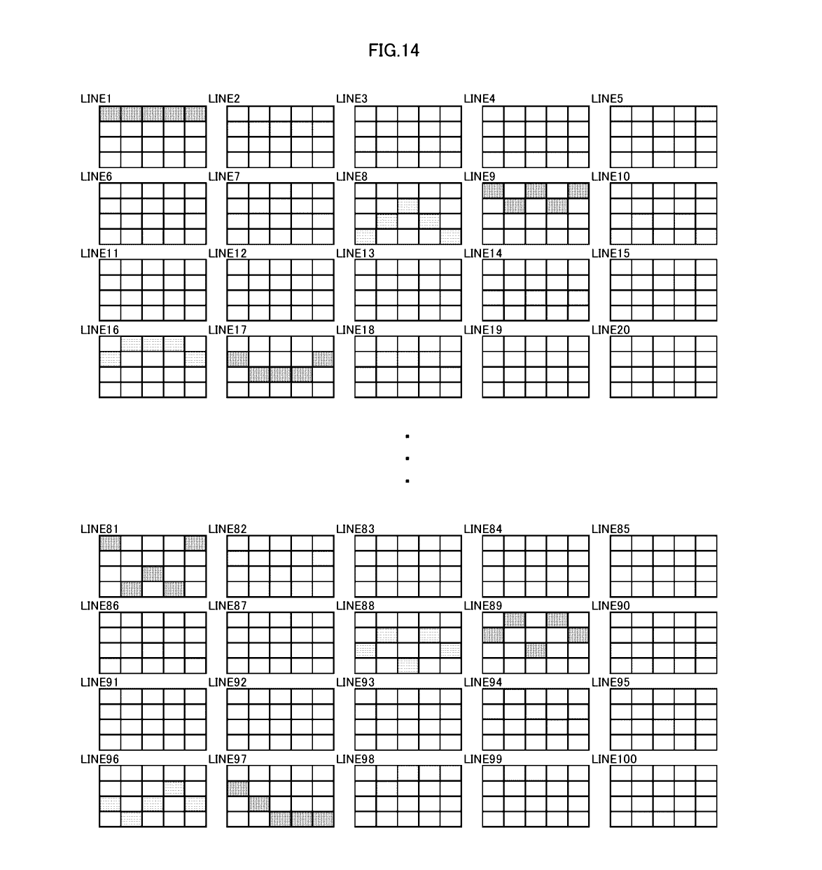

FIG. 13 shows an example of data (position data) that enables identification of the activated payline. FIG. 14 shows imageries of the activated payline. In FIG. 14, “LINE21” to “LINE80” are omitted.

For example, in the activated payline No. 1 (the first record in FIG. 13), the display blocks 28 having reel positions of “R1,0”, “R2,0”, “R3,0”, “R4,0”, and “R5,0” form an activated payline as shown in “LINE1” of FIG. 14.

In this slot machine 10, for example, if a BET operation designates “50” as the number of activated paylines, the activated paylines having the activated payline Nos. 1 to 50 are used. In this case, based on stopped symbols, whether or not winning is established is determined sequentially from the activated payline having the activated payline No. 1.

(Symbol Arrays of Video Reels A)

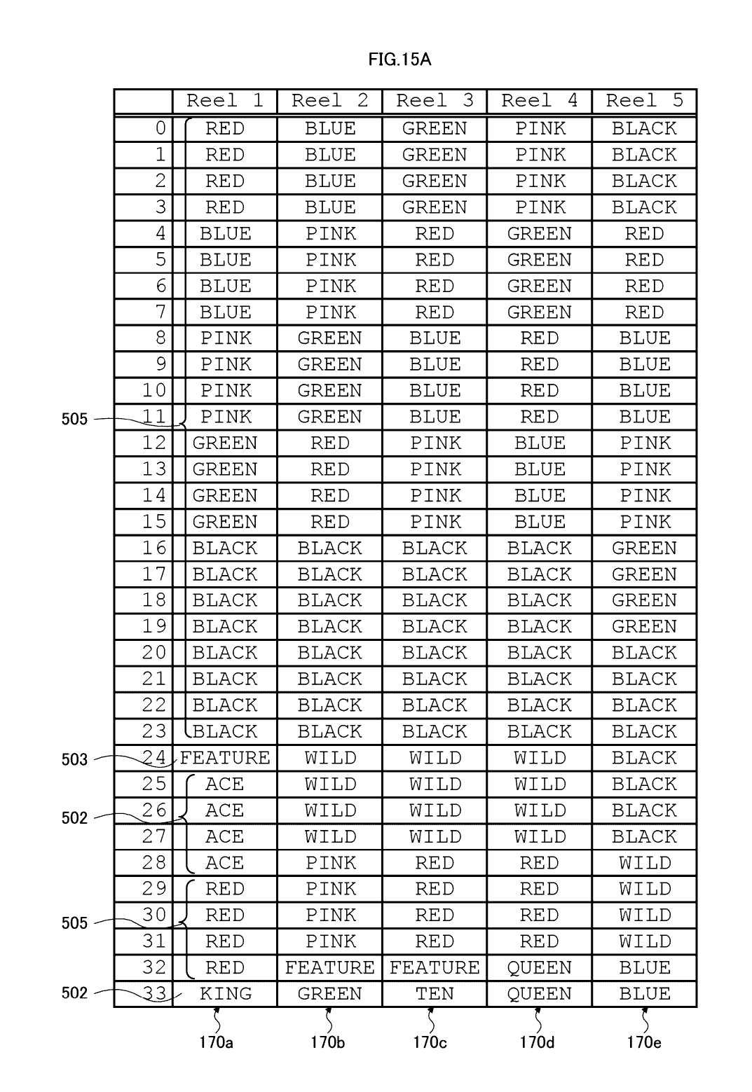

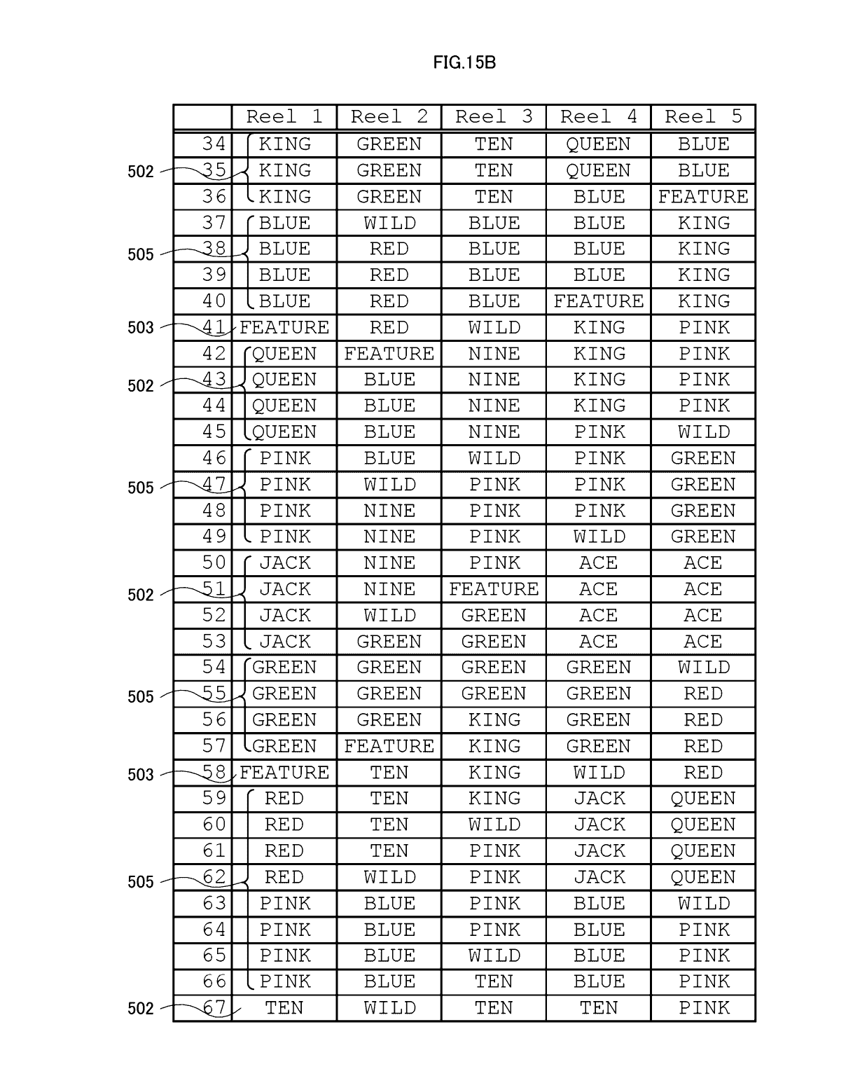

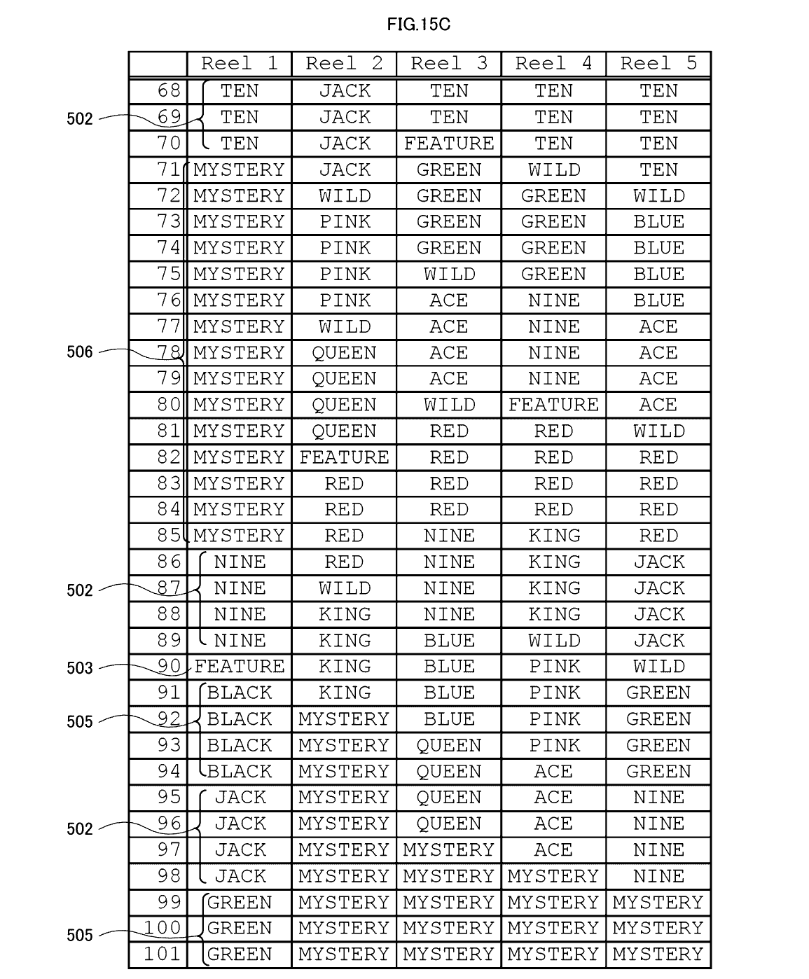

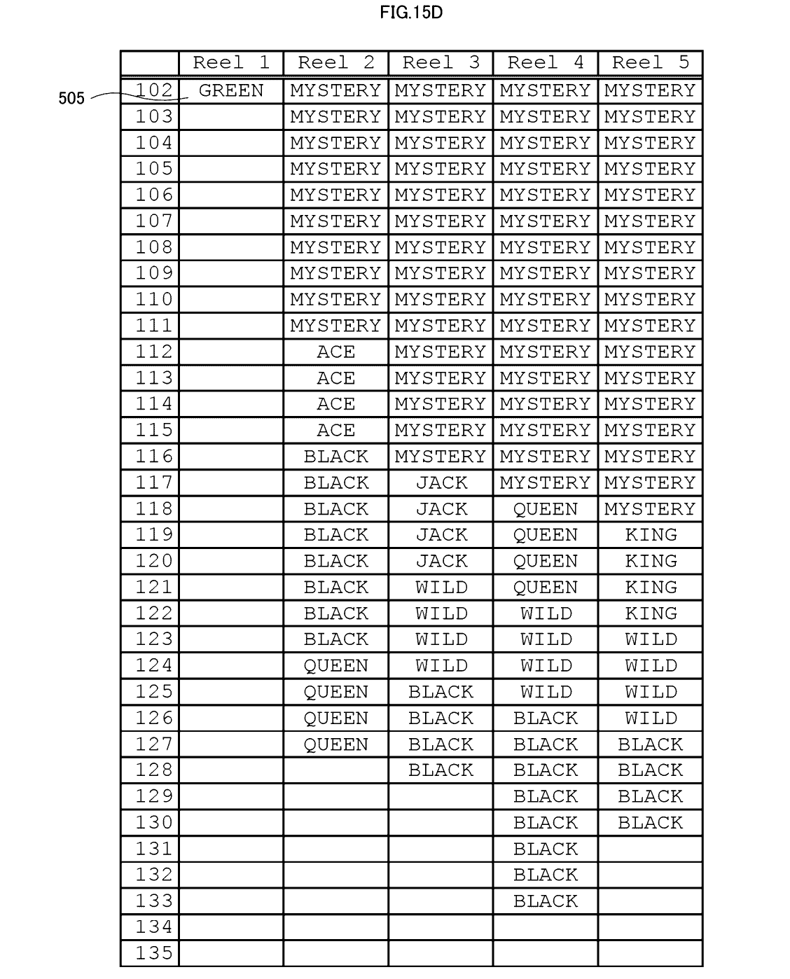

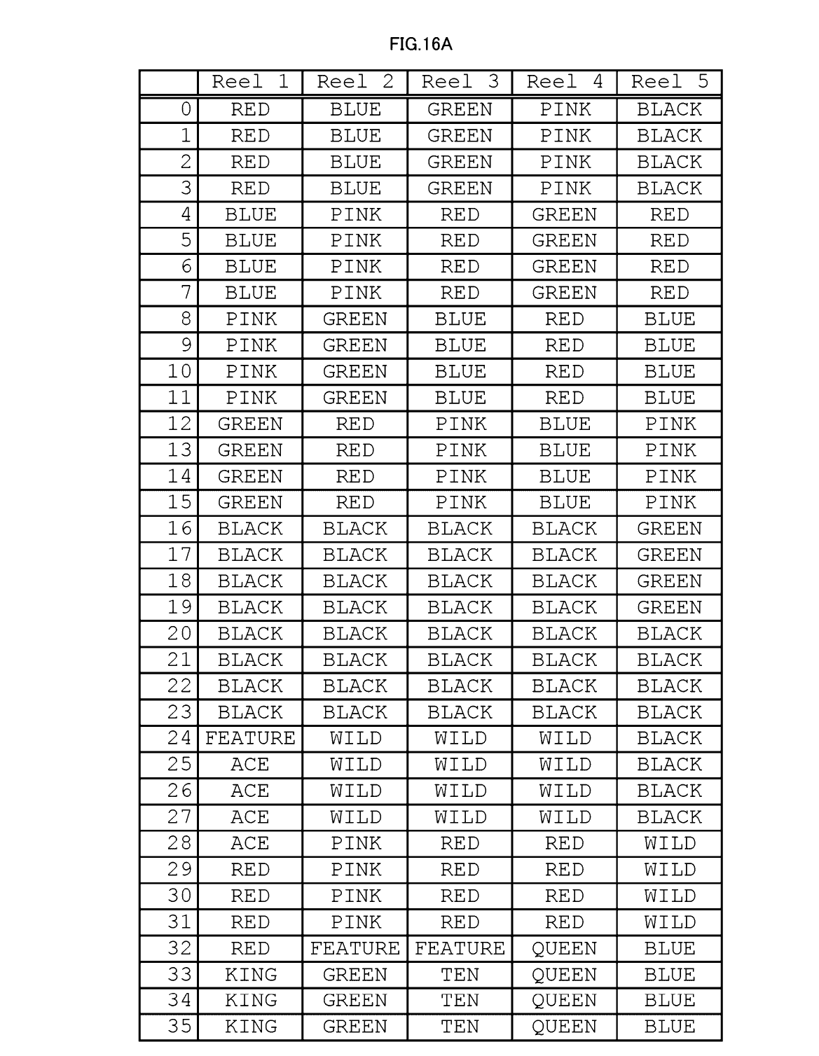

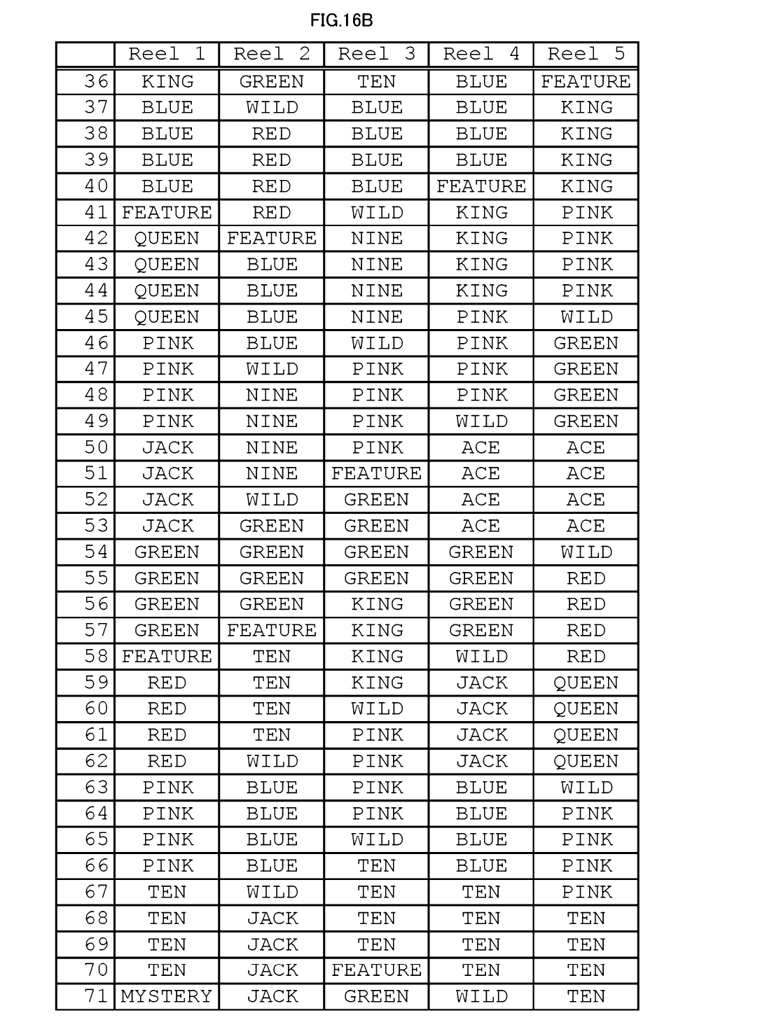

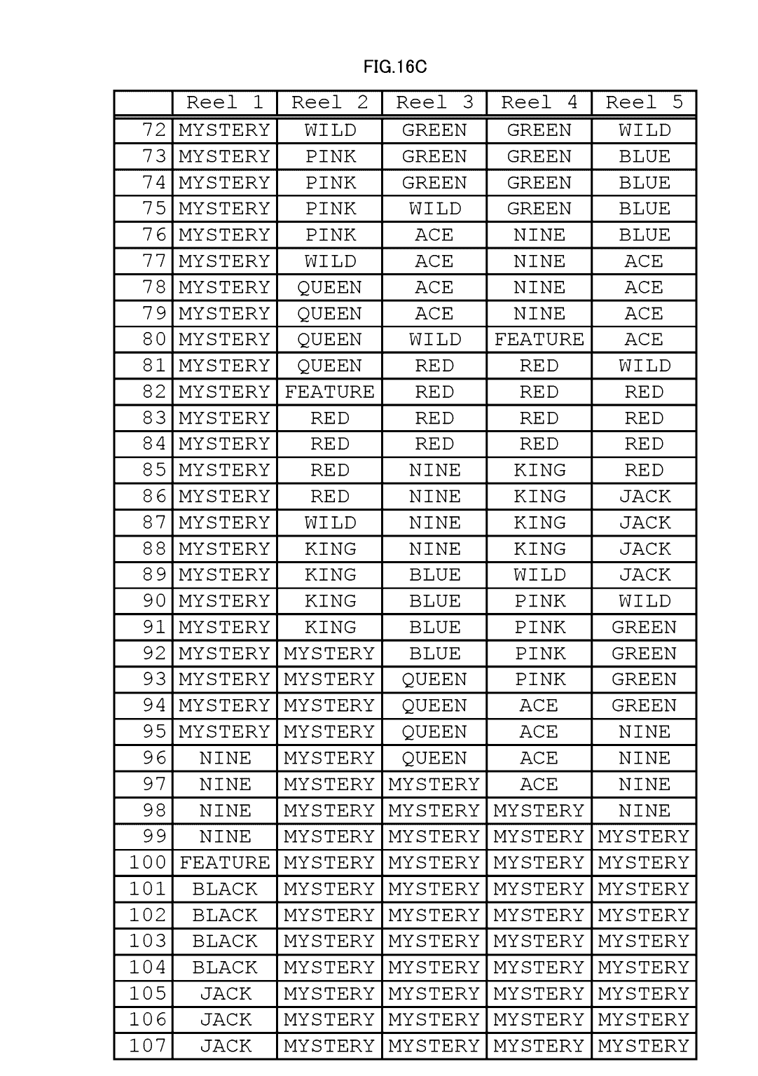

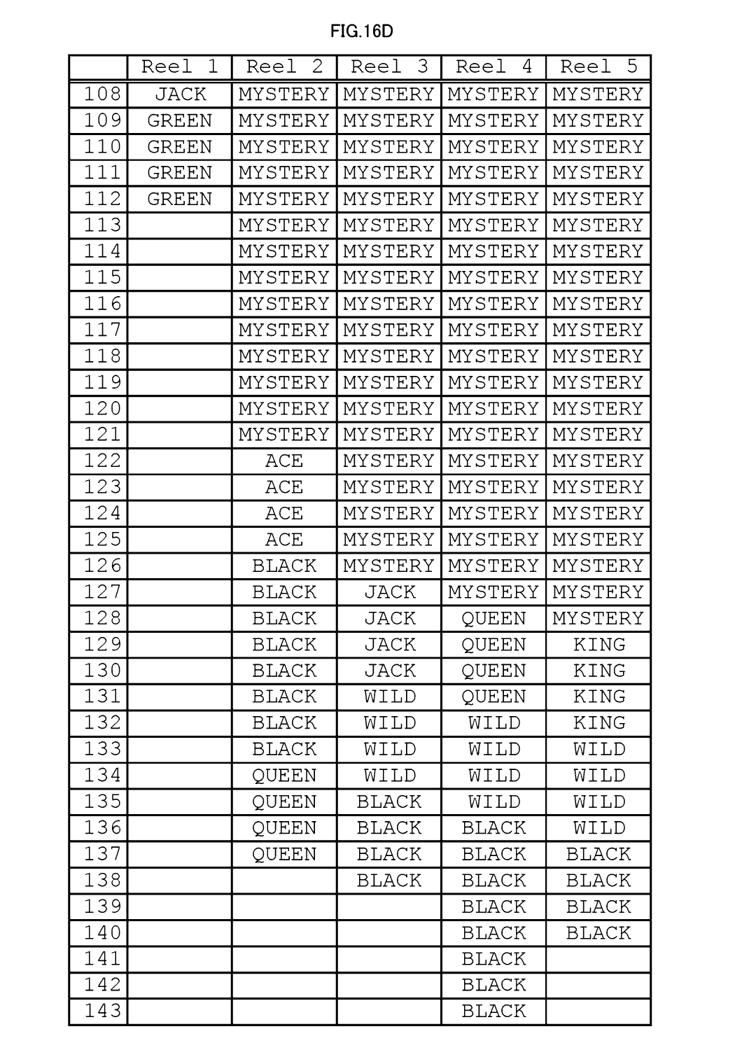

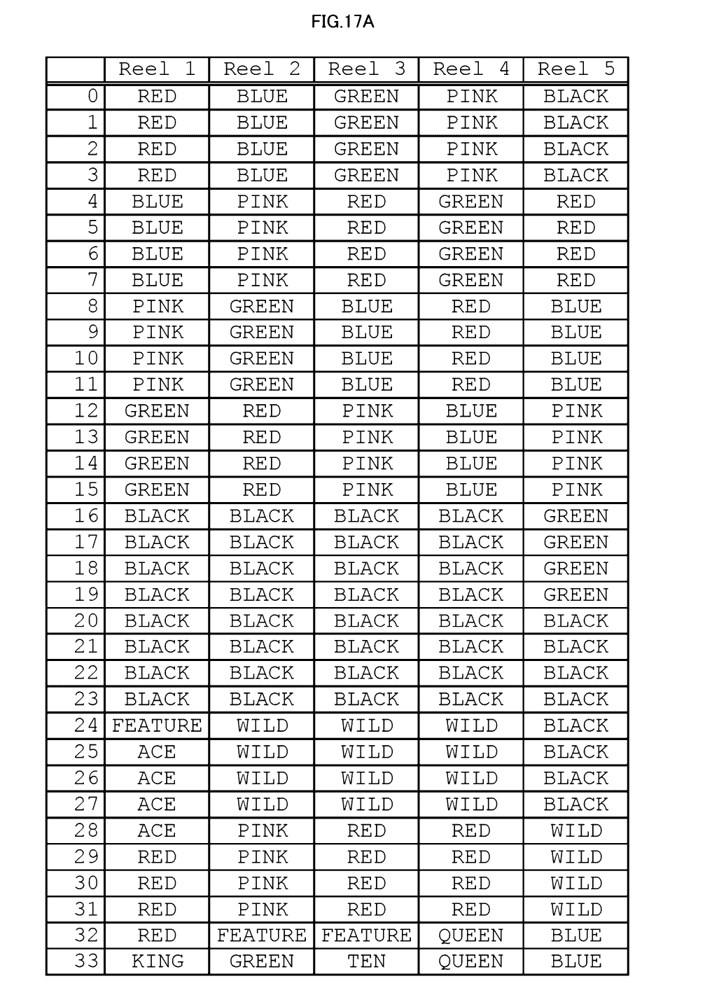

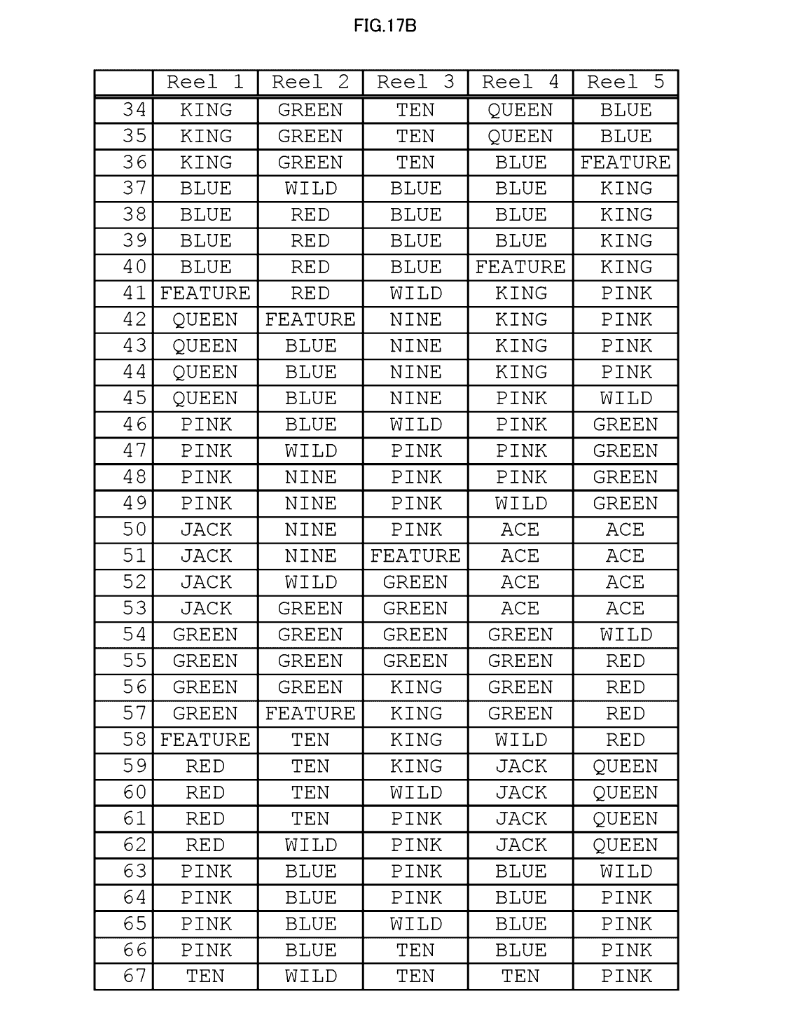

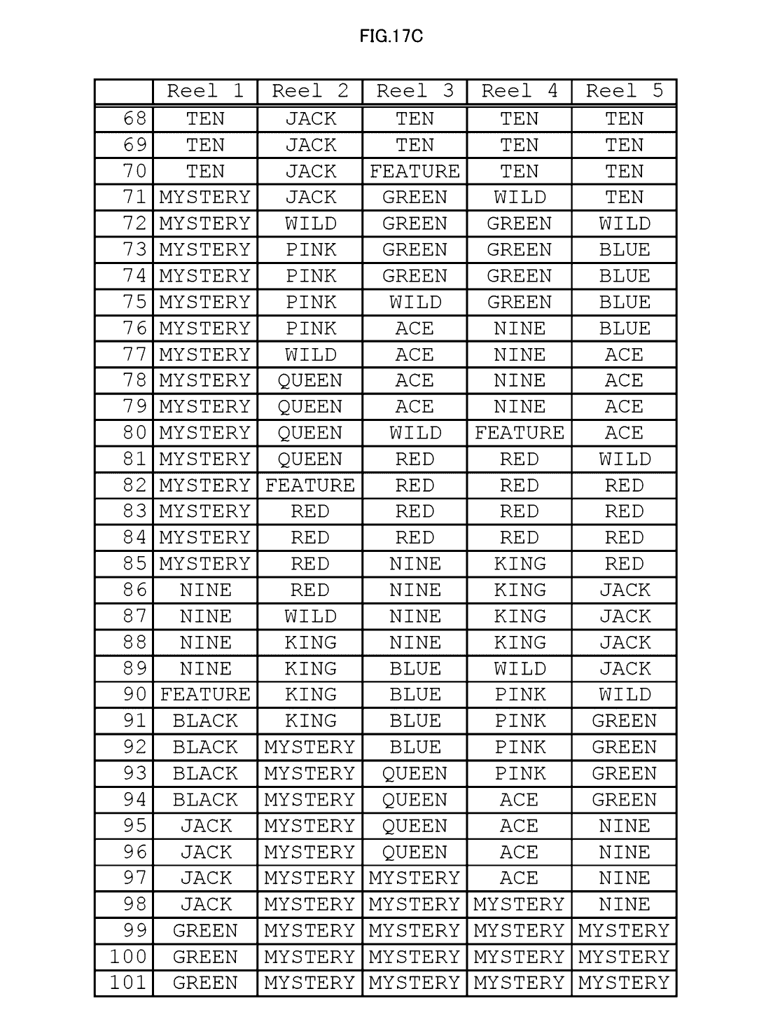

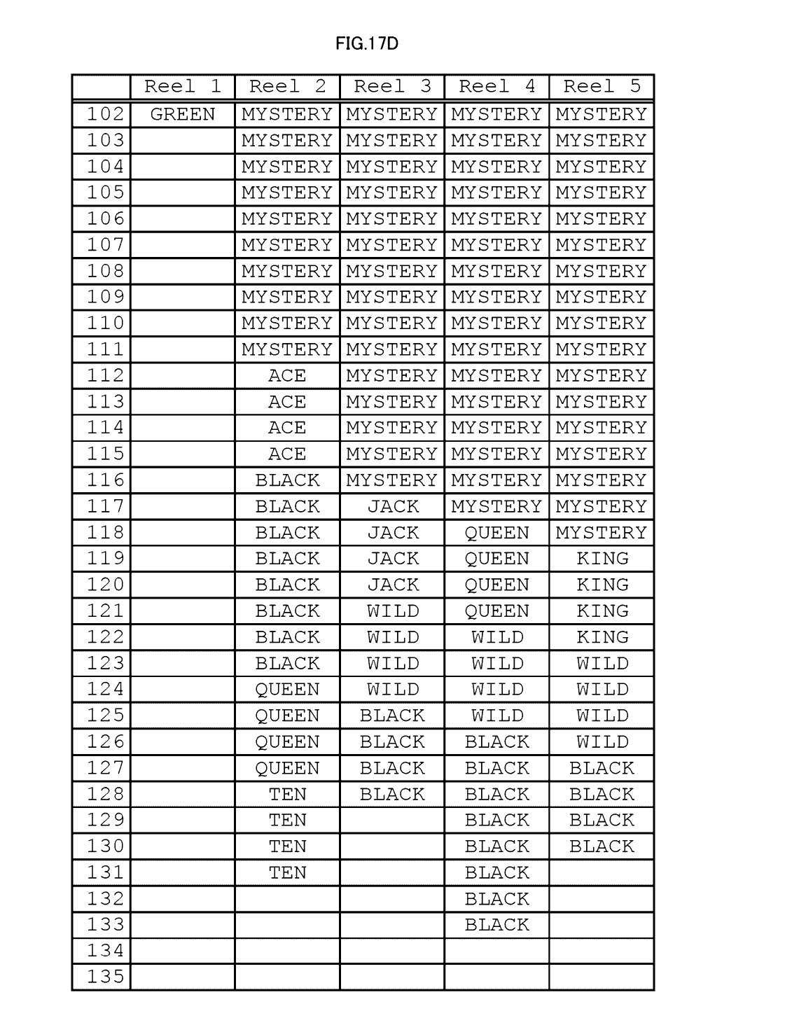

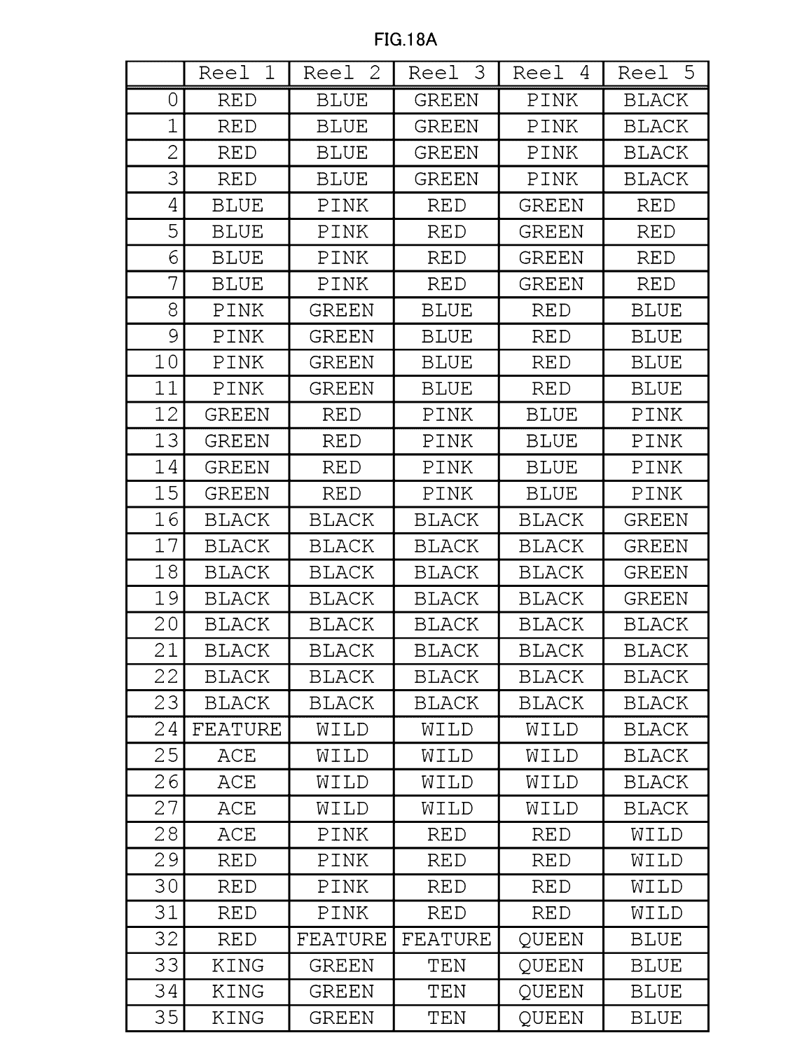

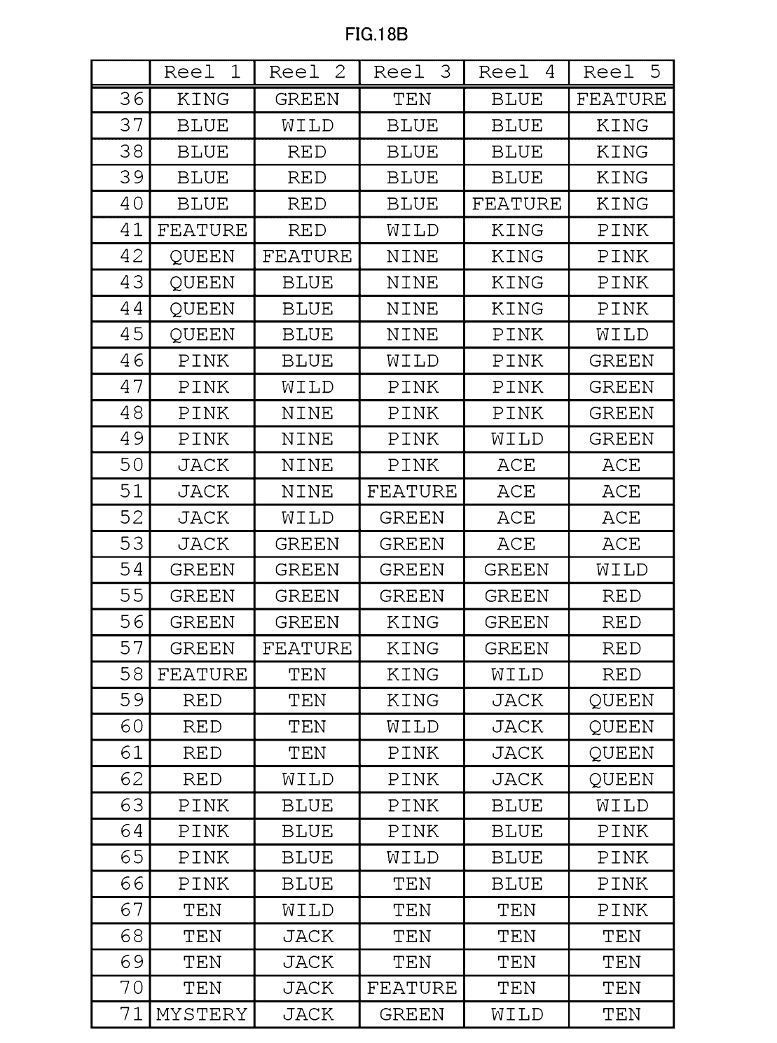

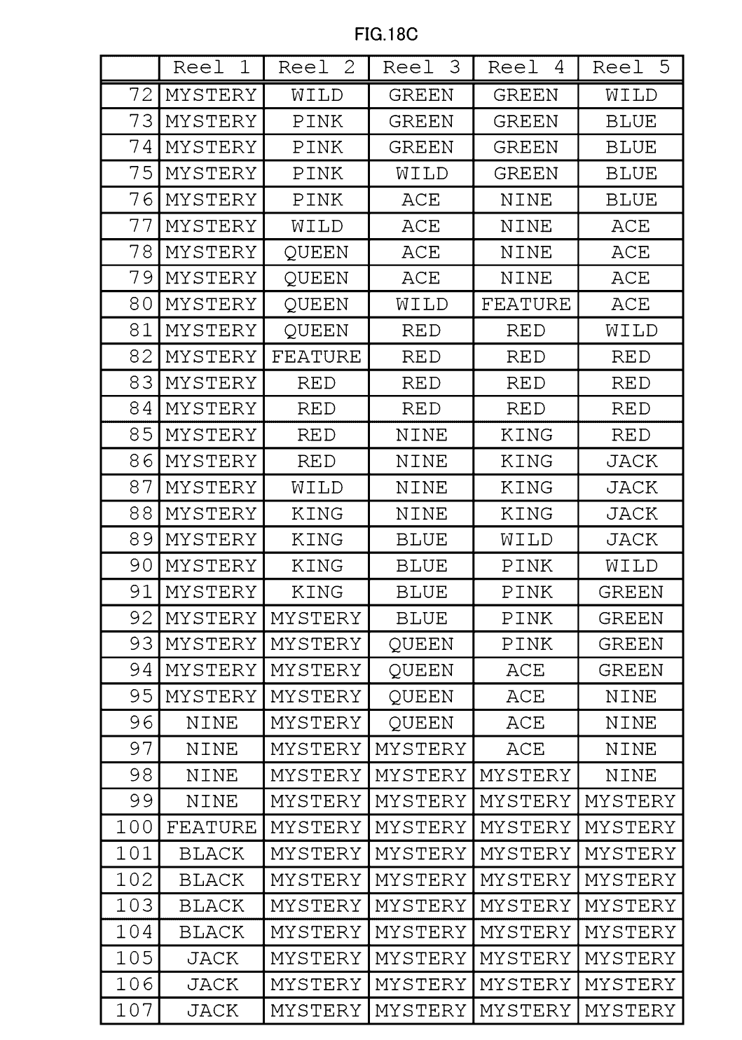

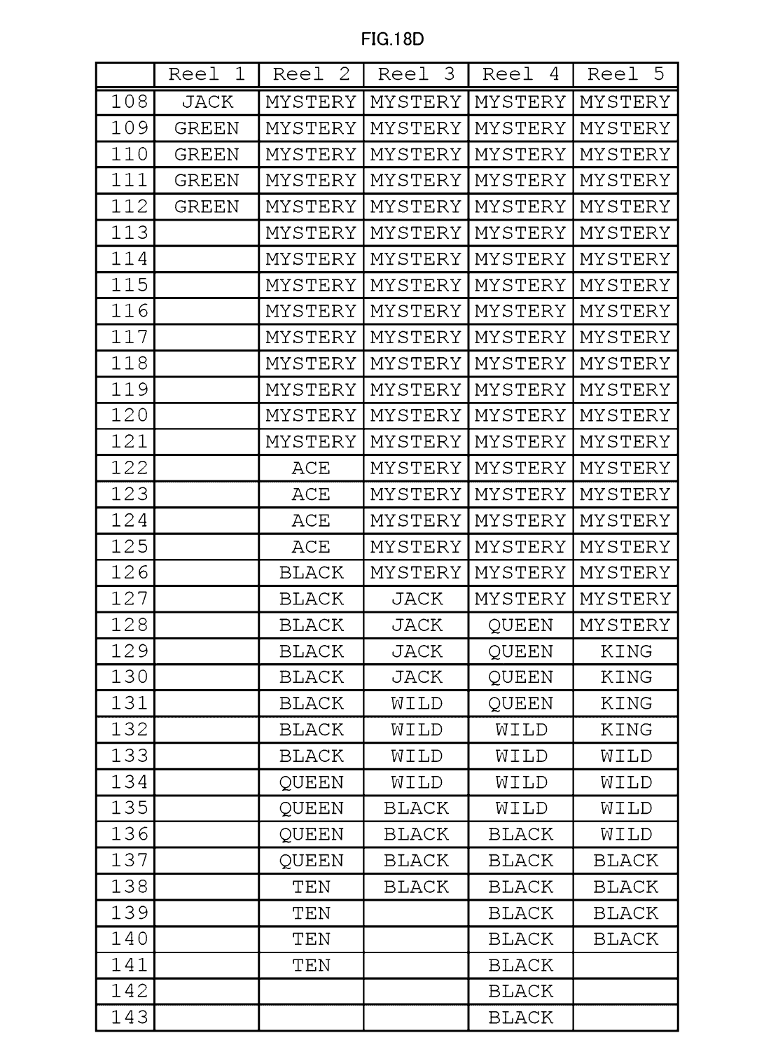

Exemplary symbol arrays 170 are shown in FIG. 15A to FIG. 18D. In this slot machine 10, the symbol arrays 170 for use in the normal game with a progressive function OFF are provided (FIGS. 15A to 15D). The symbol arrays 170 for use in the free game with the progressive function OFF are provided (FIGS. 16A to 16D). The symbol arrays 170 for use in the normal game with the progressive function ON are provided (FIGS. 17A to 17D). The symbol arrays 170 for use in the free game with the progressive function ON are provided (FIGS. 18A to 18D). In FIGS. 15 to 18, Reels 1 to 5 correspond to the pseudo reels 151a to 155a. The symbol arrays 170a to 170e that are variably displayed in the first to fifth display columns 1421 to 1425, respectively, are shown in Reels 1 to 5.

In FIGS. 15A to 15D, reference numerals are given to the symbols of Reel 1, with omission of reference numerals for the other symbols.

In this slot machine 10, the symbol arrays 170 are configured such that the symbol arrays 170 adopted for the free game are advantageous over those adopted for the normal game. For example, the symbol arrays 170 adopted for the free game have a configuration in which ten mystery symbols for each column (fifty mystery symbols in total) are added to the symbol arrays 170 adopted for the normal game.

The symbol arrays 170 are configured such that a higher advantage is given when no progressive service is applied (when the progressive function is OFF) than when the progressive service is applied (when the progressive function is ON). For example, the symbol arrays 170 used when the progressive function is OFF have a higher probability (the number of mystery symbols/the total number of symbols) of displaying a mystery symbol in the second symbol array (symbol array 170b) as compared with the symbol arrays 170 used when the progressive function is ON.

Each of the symbol arrays 170a to 170e includes one or more symbols. Five types of symbols, namely, normal symbols 502, feature symbols 503, wild symbols 504, picture symbols 505, and mystery symbols 506, are provided as the symbols.

The normal symbol 502 is a symbol that causes a payout.

The feature symbol 503 is a symbol that causes a payout and triggers running of the free game.

The wild symbol 504 is a symbol that causes a payout, and that can be substituted by the normal symbol 502 or the picture symbol 505 but cannot be substituted by the feature symbol 503 and the mystery symbol 506. If a combination of stopped or rearranged symbols includes a wild symbol 504, the wild symbol 504 is treated as a substitution for a plurality of types of symbols so as to obtain an advantageous combination.

The picture symbol 505 is a symbol that causes a payout. If a picture symbol 505 is stopped in the display block 28, an animation related to the picture symbol 505 is produced.

The mystery symbol 506 is a symbol to be replaced with any of the normal symbol 502, the feature symbol 503, the wild symbol 504, and the picture symbol 505.

One or more kinds of symbols are adoptable for the normal symbol 502, the feature symbol 503, the wild symbol 504, the picture symbol 505, and the mystery symbol 506.

In this embodiment, the normal symbols 502 include six kinds of symbols of “ACE”, “KING”, “QUEEN”, “JACK”, “TEN”, and “NINE”. The feature symbols 503 include one kind of symbols of “FEATURE”. The wild symbols 504 include one kind of symbols of “WILD”. The picture symbols 505 include five kinds of symbols of “BLACK”, “RED”, “BLUE”, “PINK”, and “GREEN”. The mystery symbols 506 include one kind of symbols of “MISTERY”.

For example, the symbol array 170a includes 103 symbols in total, made up of twenty-eight normal symbols 502, four feature symbols 503, zero wild symbol 504, fifty-six picture symbols 505, and fifteen mystery symbols 506.

As for the picture symbols 505 included in the symbol array 170a, the picture symbols 505 of each kind are successively arranged, and the number of the successive picture symbols 505 is equal to or larger than the maximum displayable number (in this example, four). This arrangement makes it possible that all the display blocks 28 of the first display column 1421 display the picture symbols 505 of the same kind.

As for the mystery symbols 506 included in the symbol array 170a, the mystery symbols 506 are successively arranged, and the number of the successive mystery symbols 506 is equal to or larger than the maximum displayable number (in this example, fifteen). This arrangement makes it possible that all the display blocks 28 of the first display column 1421 display the mystery symbols 506.

The symbol array 170a includes no wild symbol 504, but the wild symbols 504 can be successively displayed because there are the mystery symbols 506.

(Mystery Symbol)

The mystery symbol will be described. The mystery symbol is replaced with another symbol at a time of stopping of all the video reels. If, for example, mystery symbols are displayed in a plurality of display blocks 28, all of the mystery symbols are concurrently replaced with other symbols of the same type.

The replacing symbol is determined by using a replacement symbol determination table in which weighting is set. In this embodiment, four types of replacement symbol determination tables are provided corresponding to the state of selection of the progressive function (ON or OFF) and the game type (the normal game or the free game).

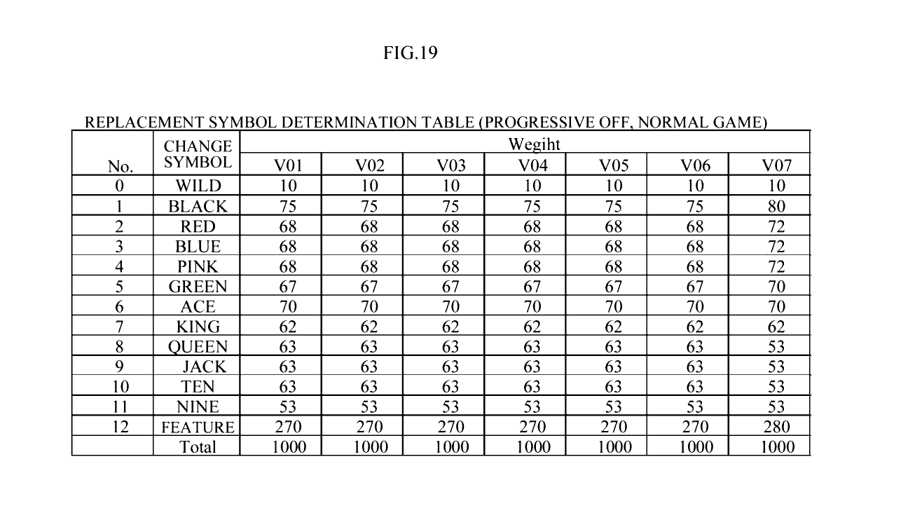

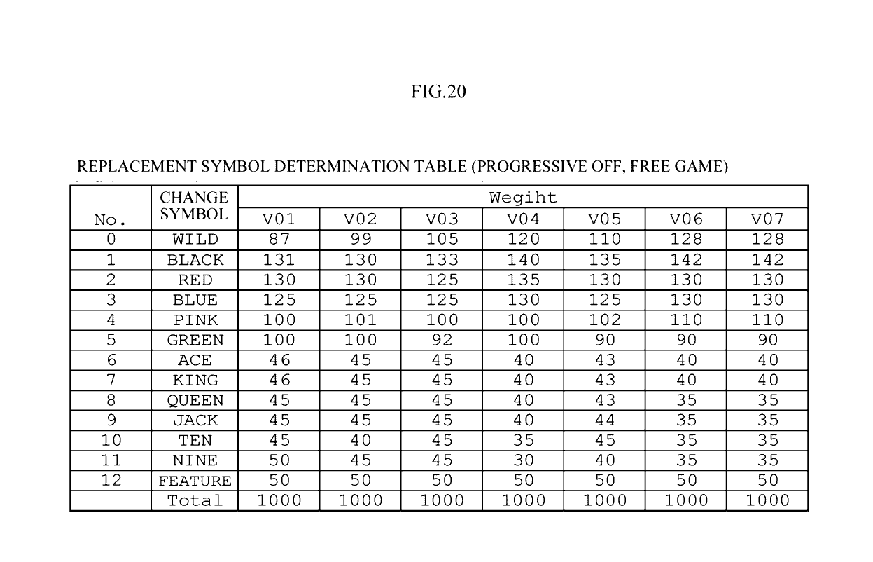

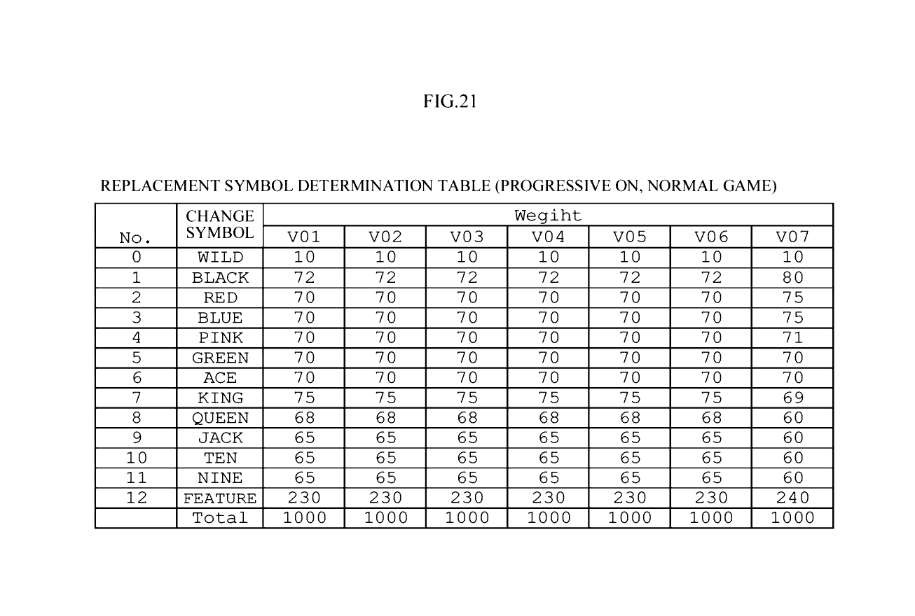

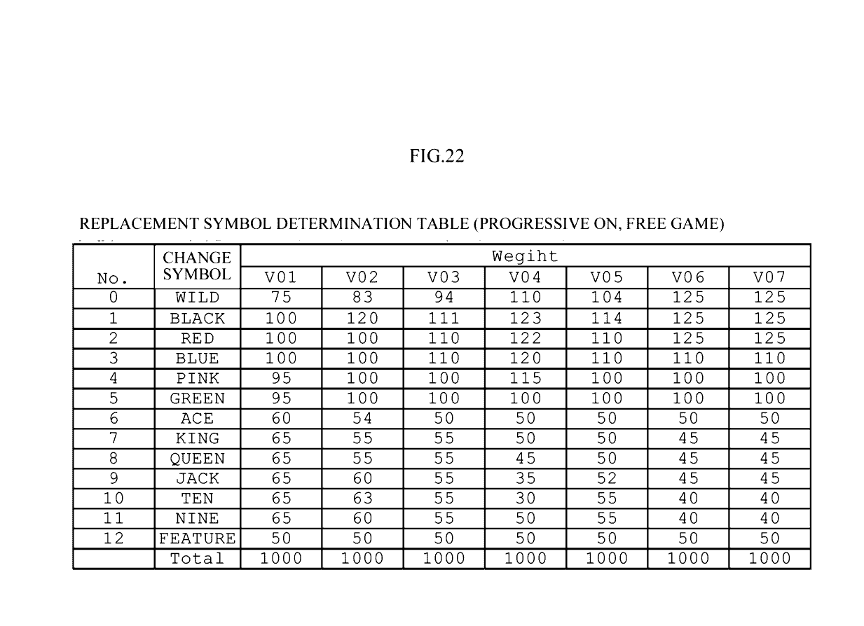

FIG. 19 shows an example of the replacement symbol determination table for use in the normal game with the progressive function OFF. FIG. 20 shows an example of the replacement symbol determination table for use in the free game with the progressive function OFF. FIG. 21 shows an example of the replacement symbol determination table for use in the normal game with the progressive function ON. FIG. 22 shows an example of the replacement symbol determination table for use in the free game with the progressive function ON.

In the replacement symbol determination table, a weighting (lottery value) is set in association with a replacement symbol (change symbol). In this example, one of seven patterns V01 to V07 is set in advance.

Basically, the replacement symbol determination table used when the progressive function is OFF is set such that the percentage of replacement with the picture symbol 505 is relatively higher and the percentage of replacement with the normal symbol 502 is relatively lower, as compared with the replacement symbol determination table used when the progressive function is ON.

The replacement symbol determination table for use in the normal game is set such that the percentage of replacement with the feature symbol 503 is relatively higher and the percentage of replacement with the picture symbol 505 is relatively lower, as compared with the replacement symbol determination table for use in the free game.

(Symbol Arrays of Video Reels B)

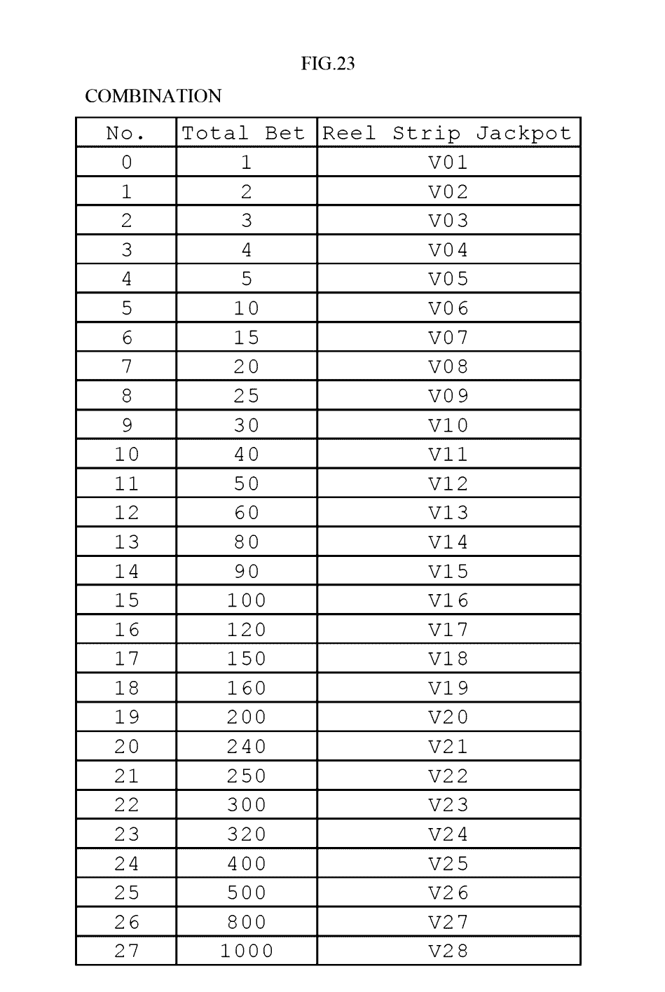

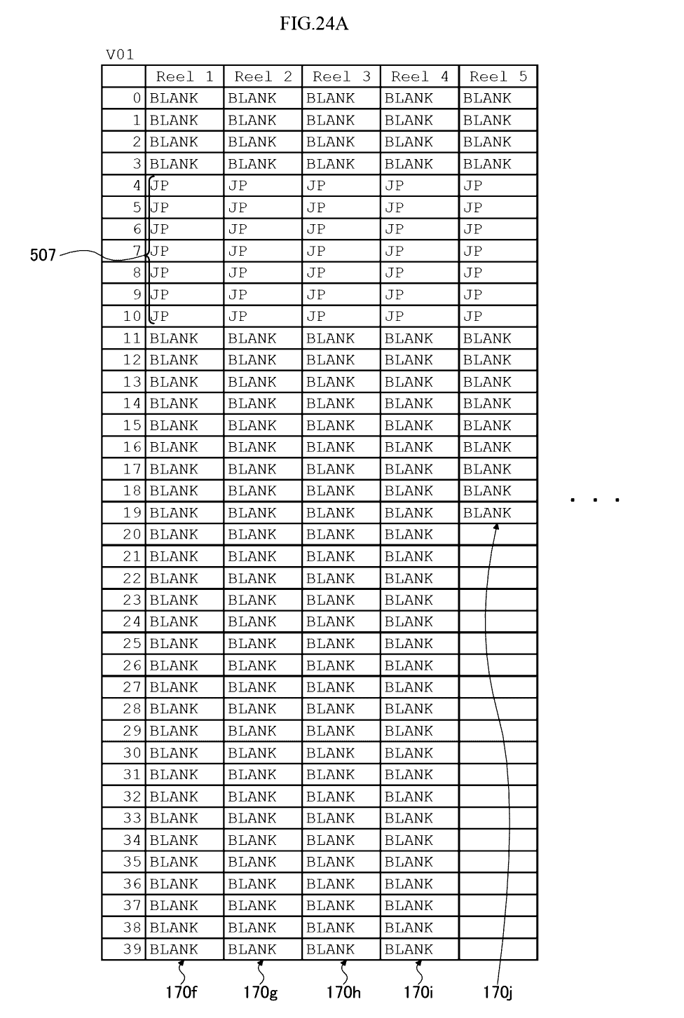

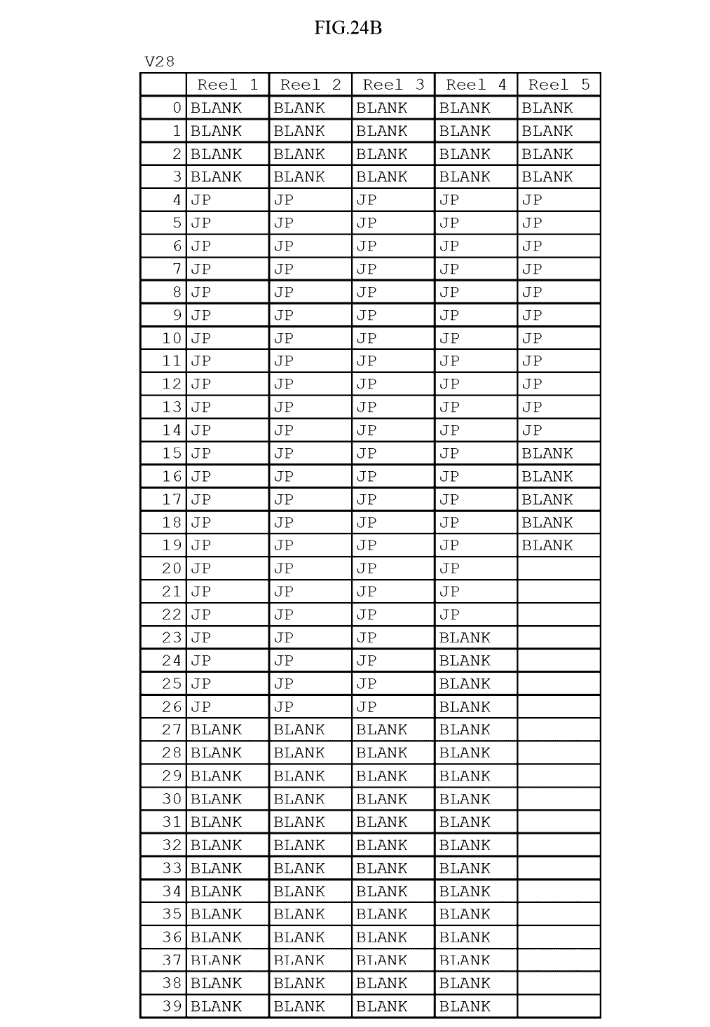

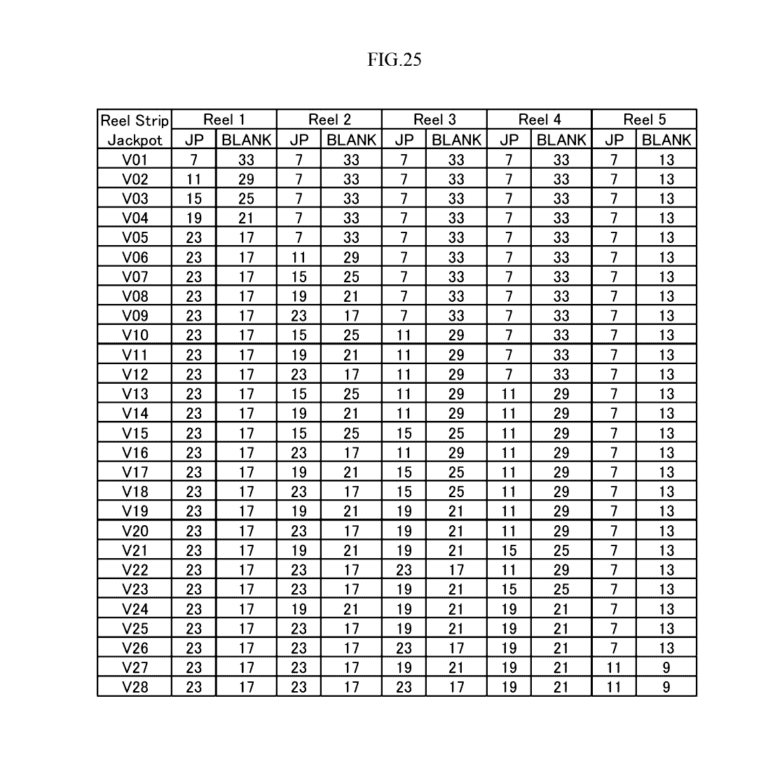

The symbol arrays of the video reels B will be described with reference to FIGS. 23 to 25. FIG. 23 shows the correspondence relationship (an example of the video reel group determination table) between the total number of BETs (Total Bet) and the group of video reels B. FIG. 24A shows an example of the symbol arrays for a video reel group that is adopted when the total number of BETs is “1” (when Reel Strip Jackpot is “V01”). FIG. 24B shows an example of the symbol arrays for a video reel group that is adopted when the total number of BETs is “1000” (when Reel Strip Jackpot is “V28”). FIG. 25 shows an example of a symbol configuration for the group of video reels B. In FIG. 25, “JP” represents the number of JP symbols 507 to be successively arranged in the fifth place (symbol NO. 4) and subsequent places in the symbol arrays, and “BLANK” represents the number of blanks (empties) other than the JP symbols 507.

Reels 1 to 5 in FIGS. 24A, 24B, and 25 correspond to the pseudo reels 151b to 155b, respectively. Symbol arrays 170f to 170j, which are variable in the first to fifth display columns 1421 to 1425, respectively, are illustrated.

As shown in FIG. 23, a plurality of kinds (in this example, twenty-eight kinds) of the group of video reels B are provided corresponding to the total number of BETs (Total Bet).

As shown in FIG. 25, the group of video reels B is basically provided such that the percentage of the JP symbol 507 [the number of JP symbols 507/(the number of JP symbols 507+the number of blanks)] increases as the total number of BETs increases. The symbols are basically arranged such that the video reel B arranged more leftward has a higher percentage of the JP symbol 507.

The symbols arranged on the video reels B include the JP symbols 507 of one kind and the blanks. This configuration, however, is not limiting. In a conceivable example, a plurality of kinds of the JP symbols 507 may be provided. In a conceivable example, another symbol distinguishable from the JP symbol 507, which does not hinder the visibility of stopping of symbols of the video reels A, may be adopted instead of the brank.

(Various Configurations of Slot Machine)

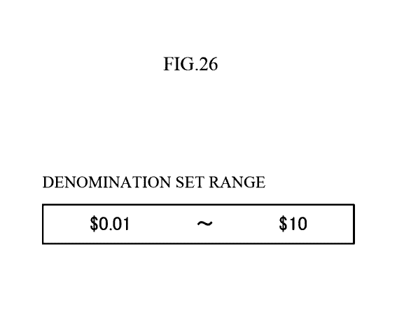

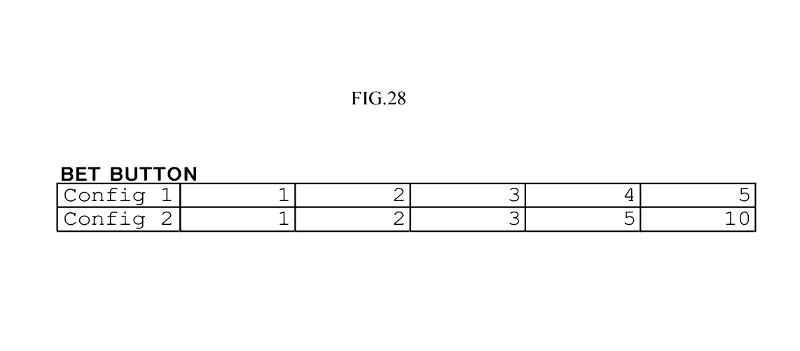

FIG. 26 shows an example of a denomination set range. This slot machine 10 basically permits 1 cent to 10 dollars (currency of the local country) to be selected as a monetary unit corresponding to 1 BET. In the predetermined configurations shown in FIG. 28, however, a predetermined currency unit cannot be selectable in some cases. The denomination set range is not limited to the range of 1 cent to 10 dollars. Any set range having appropriate lower and upper limit values is adoptable.

FIG. 27 shows the correspondence relationship between the play-line buttons and the number of activated paylines with respect to each maximum number of activated paylines. Although FIG. 27 shows five patters of the maximum number of activated paylines, this is not limiting. Four patterns or less may be provided, or six patterns or more may be provided. The number of activated paylines is also not limited to the values shown in FIG. 27.

FIG. 28 shows the correspondence relationship between configurations and the BET multiplying factors. The slot machine 10 allows two types of configurations (Config_1 or Config_2). In a case of Config_2 for example, the player is able to select the BET multiplying factor (1, 2, 3, 5, or 10) by using the BET buttons.

The number of types of configurations is not limited to two. One type may be provided, or three types or more may be provided. The BET multiplying factor is also not limited to the values shown in FIG. 28.

(Winning Combination)

Upon pressing of the spin button 46 to start the game, the symbol arrays 170 (pseudo reels) start scrolling. After elapse of a predetermined length of time from the start of scrolling, the scrolling stops (rearrangement). A lottery for symbols to be rearranged in the normal game is held when the spin button 46 is pressed. A lottery for symbols to be rearranged in the free game is held immediately before the start of scrolling of the symbol arrays 170.

In this embodiment, upon pressing of the spin button 46, the activated payline is determined based on the pressed play-line button 40 to 44.

The slot machine 10 makes determinations about a win for each activated payline, a win for the free game, and a win for a jackpot. In other words, the slot machine 10 determines whether or not a winning combination is formed.

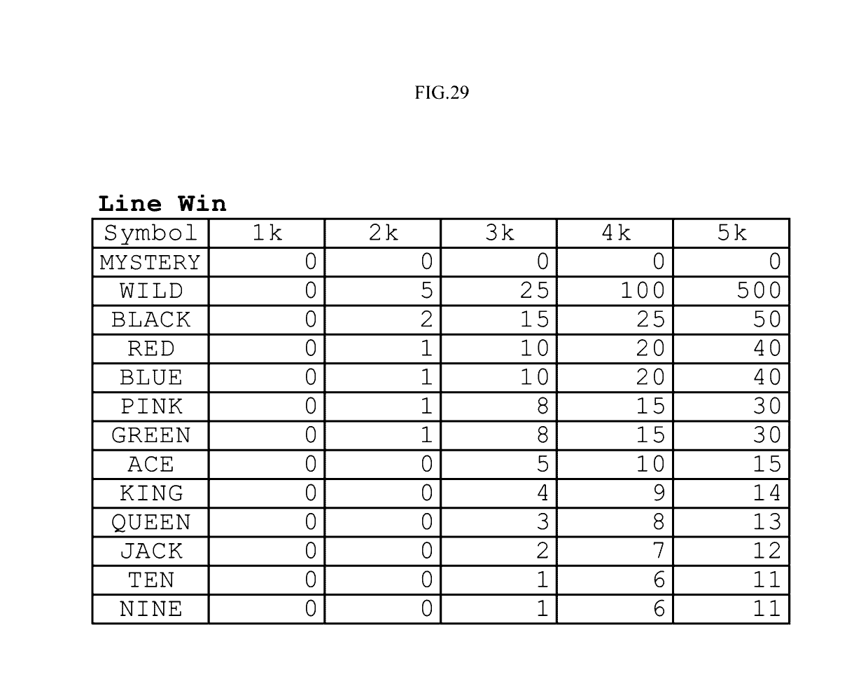

The winning combination is establishment of an award. The winning combination is a combination of symbols stopped on the activated payline that provides an advantageous state to the player, or a combination of symbols stopped in the pre-designated display blocks that provides an advantageous state to the player. For example, a winning combination is established when a predetermined number or more of symbols of the same kind are successively rearranged on the activated payline, as shown in FIG. 29.

The advantageous state represents a state in which a number of payouts in accordance with the winning combination are added to the credit, a state in which the bonus game (e.g., the free game or jackpot) is started, or the like.

The winning combination includes a winning combination that causes a bonus win and a winning combination that causes a payout win.

The bonus win is caused by the feature symbol 503 that triggers running of the free game and the JP symbol 507 that triggers execution of the jackpot. In a case of the free game triggered, a payout is awarded in accordance with the number of the triggering feature symbols 503 rearranged in the symbol display area 150.

The payout win is caused by the normal symbol 502, the feature symbol 503, the wild symbol 504, and the picture symbol 505.

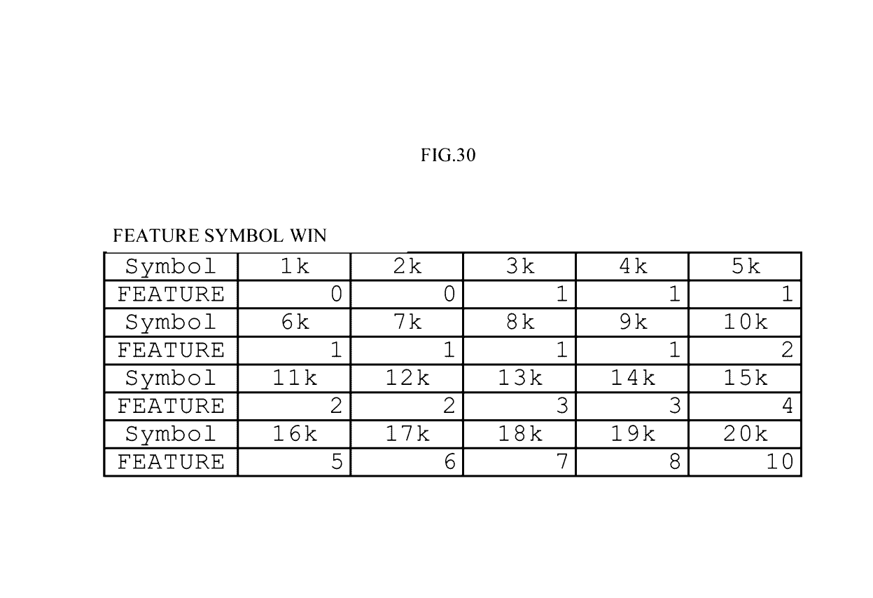

FIGS. 29 and 30 show examples of a payout table (payout table) indicating the relationship between winning combinations and payouts.

In a payout table shown in FIG. 29, the number of payouts to be awarded when a predetermined number or more of symbols of the same kind are successively stopped on the activated payline from the first display column 1421 arranged leftmost is defined for each kind of the stopped symbols. For example, when the symbols of “ACE” are stopped in the first to third display columns 1421 to 1423 on the activated payline, and in other words, when three symbols of “ACE” are successively stopped on the activated payline, it is determined that the number of payouts is “5”.

Focusing on one kind of symbol, the number of payouts is defined so as to increase as the number of the symbols successively stopped increases.

In a payout table shown in FIG. 30, a numerical value (multiplying factor) is defined based on which a payout (bonus-in payout: the number of payouts) to be awarded when a free game start condition is satisfied (when an award is established) is calculated. In the configuration adopted in this embodiment, the total number of BETs×the multiplying factor is awarded as the bonus-in payout. This configuration, however, is not limiting. For example, a predefined number of payouts (a single fixed value) may be awarded. Alternatively, the total number of BETs×the number of active feature symbols 503, the number of BETs×the multiplying factor, or the number of BETs×the number of active feature symbols 503 may be awarded.

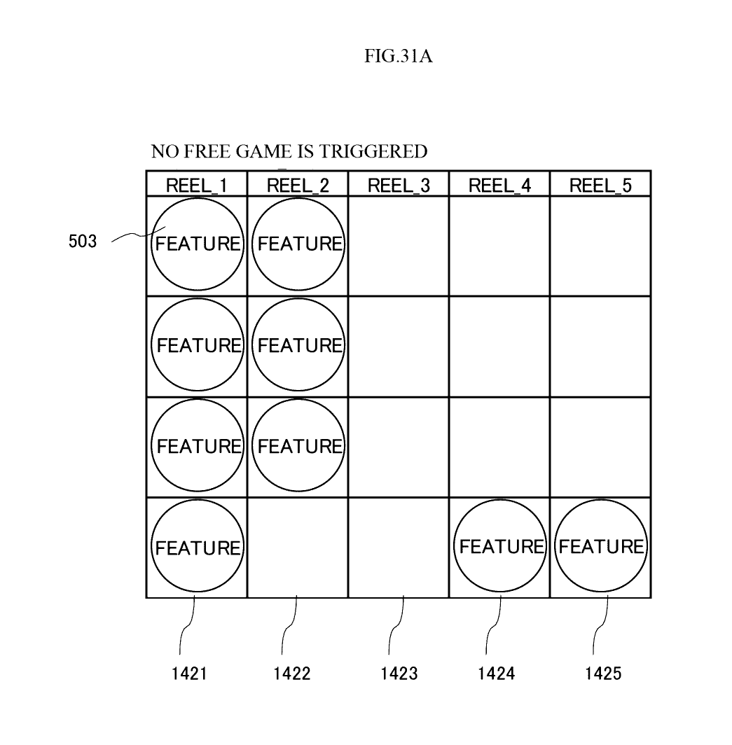

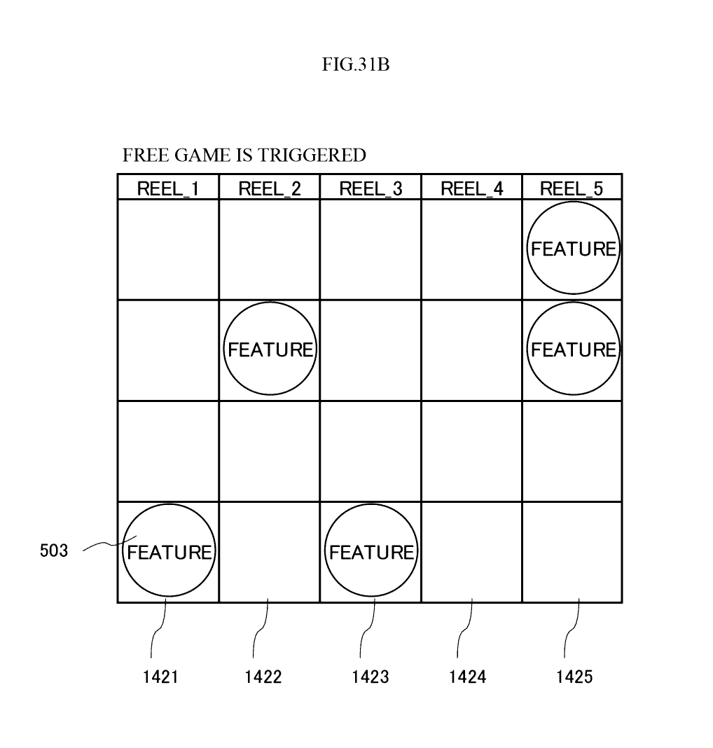

A more specific description of the free game start condition and the number of payouts will be given with reference to FIGS. 31A and 31B. FIG. 31A shows an exemplary case in which no free game is triggered and FIG. 31B shows an exemplary case in which the free game is triggered.

In the slot machine 10, the free game start condition is satisfied (the free game is triggered) when at least one feature symbol 503 is stopped in each of the first display column 1421, the second display column 1422, and the third display column 1423.

In FIG. 31A, therefore, the free game is not triggered no matter how many feature symbols 503 are stopped in the first display column 1421, the second display column 1422, the fourth display column 1424, and the fifth display column 1425. In FIG. 31B, on the other hand, the free game is triggered because the feature symbol 503 is stopped in each of the first to third display columns 1421 to 1423.

The number of payouts caused by the feature symbol 503 is determined based on satisfaction of the free game start condition and also based on the number of feature symbols 503 (active feature symbols 503) of each display column in which feature symbols 503 are successively stopped. Hereinafter, the number of active feature symbols 503 will be referred to as a Kind number as appropriate.

In the example shown in FIG. 31A, the free game start condition is not satisfied, and therefore no payout is caused no matter how many feature symbols 503 are displayed. In the example shown in FIG. 31B, no feature symbol 503 is stopped in the fourth display column 1424, and therefore the feature symbols 503 stopped in the fifth display column 1425 are not active, so that the number of active feature symbols 503 is three. Thus, it is determined that the number of payout is the total number of BETs×“1”.

The free game start condition is not limited to the above-described one. For example, stopping on the activated payline may be added to the above-described start condition.

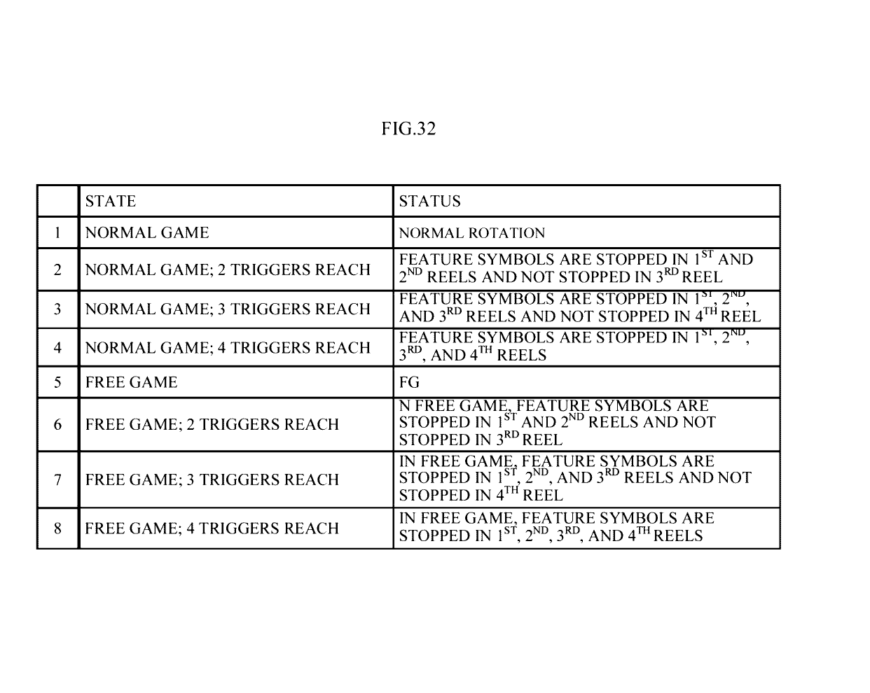

FIG. 32 shows an example of a spin table determination table. Number (No.) of a spin table to be used in accordance with the game state is defined. In a narrower sense, the spin table determination table defines number (No.) of a spin table to be used in accordance with how the feature symbols 503 are stopped.

(Free Game)

Next, the free game will be described. The free game is run upon occurrence of a bonus win caused by the feature symbols 503. Occurrence of the free game involves production of a sound effect such as a beep sound for announcing the occurrence of the free game.

In the free game, free-game symbol arrays 170 (FIGS. 16A to 16D or FIGS. 18A to 18D) are adopted. Scrolling and stopping of the symbol arrays 170 are automatically executed. If a winning combination occurs, a payout is awarded in accordance with the type and number of symbols. The group of video reels B is not displayed during the free game.

The free game adopts the symbol arrays 170 different from those of the normal game. Instead, the same symbol arrays 170 as those of the normal game may be adopted. In addition, while the group of video reels B is not displayed in the free game, a configuration in which the group of video reels B is displayed is also adoptable.

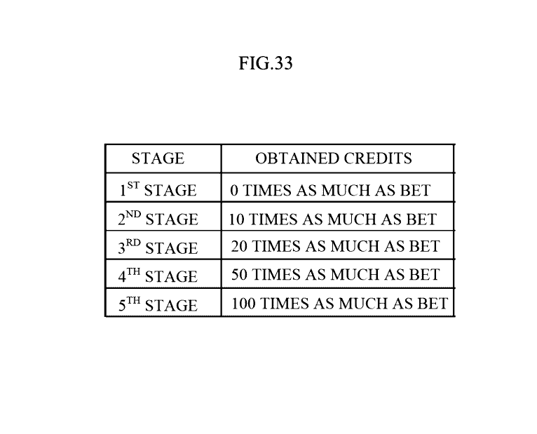

In the configuration adopted herein, BGM (background music) and a background image are changed as the obtained credit increases during the free game. In this example, the BGM and the background image can be changed in steps (five stages) shown in FIG. 33. The steps (stages) are based on how many times the total number of BETs is multiplied into the obtained credit (based on the number of obtained credits).

Upon occurrence of a bonus win caused by the feature symbol 503 during the free game, a re-trigger is caused so that the number of free games is added.

This embodiment puts no limitation on the number of times the re-triggering can be caused. This, however, is not limiting, and a limitation may be put on the number of times the re-triggering can be caused. For example, the number of times the re-triggering can be caused may be associated with the number of activated paylines such that the number of times the re-triggering can be caused has a higher limit value as the number of activated paylines increases.

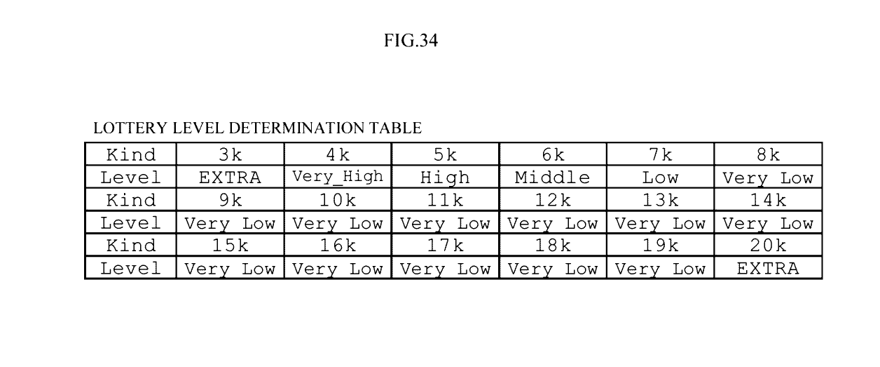

In the slot machine 10, the number of free games is determined by a lottery upon triggering of the free game. The number of obtainable games is determined by a lottery which is held for each active feature symbol 503. A lottery result (the sum total) of all the active feature symbols 503 serves as the total number of games. More specifically, tables shown in FIGS. 34 to 36D are used to determine the number of games.

FIG. 34 shows an example of a lottery level determination table that defines the level (lottery level) of the magnitude of the number of games obtained by a lottery. The lottery level determination table defines a plurality of lottery levels (EXTRA, Very High, High, Middle, Low, Very Low) in association with the number (Kind) of active feature symbols.

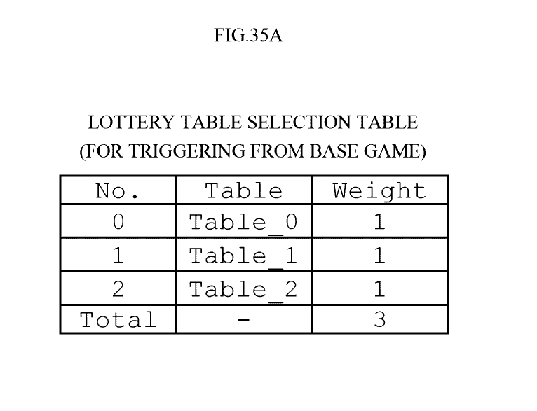

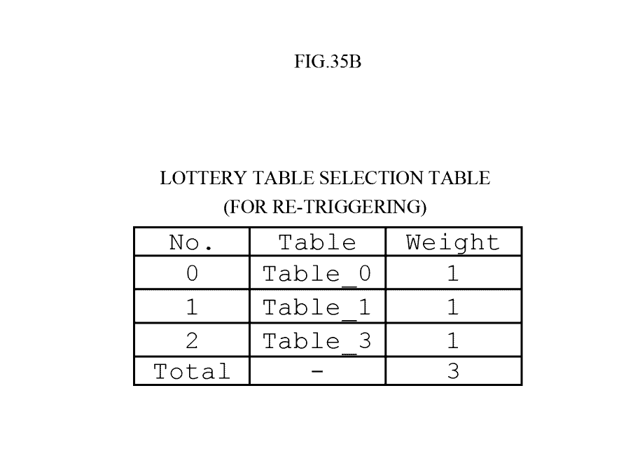

FIGS. 35A and 35B show examples of a lottery table selection table that defines selectable lottery tables. A lottery table selection table shown in FIG. 35A is a table for triggering from the normal game, and a lottery table selection table shown in FIG. 35B is a table for triggering from the free game (re-triggering).

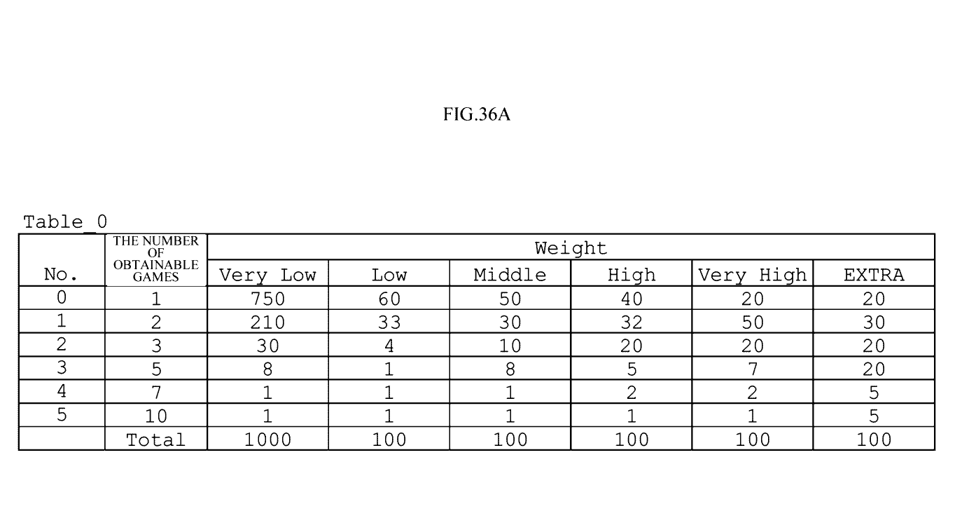

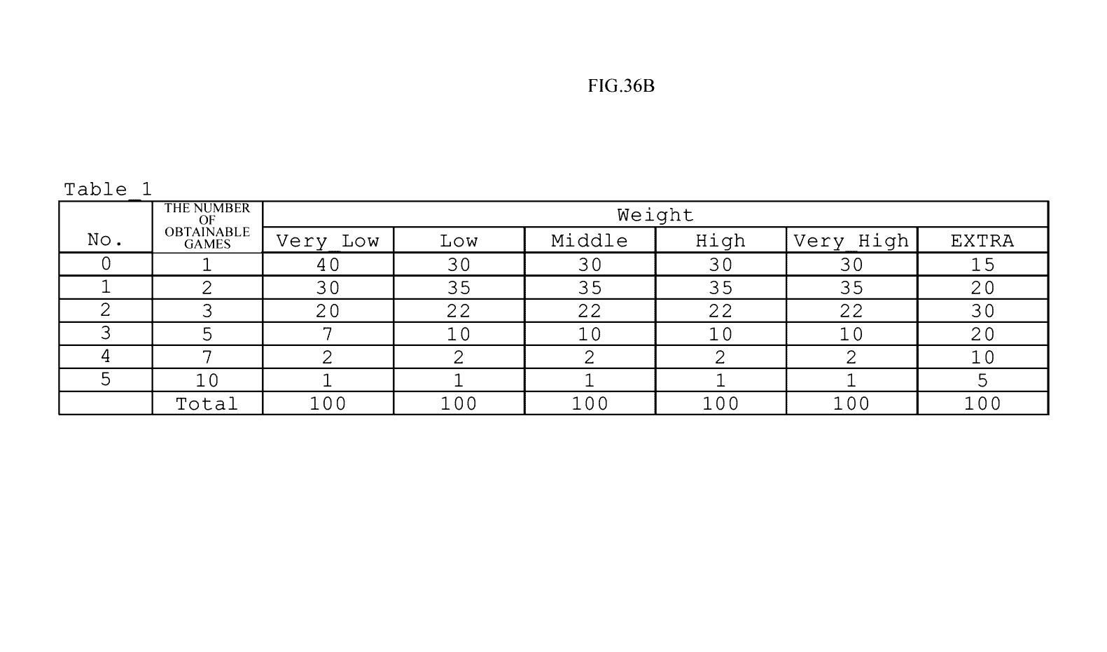

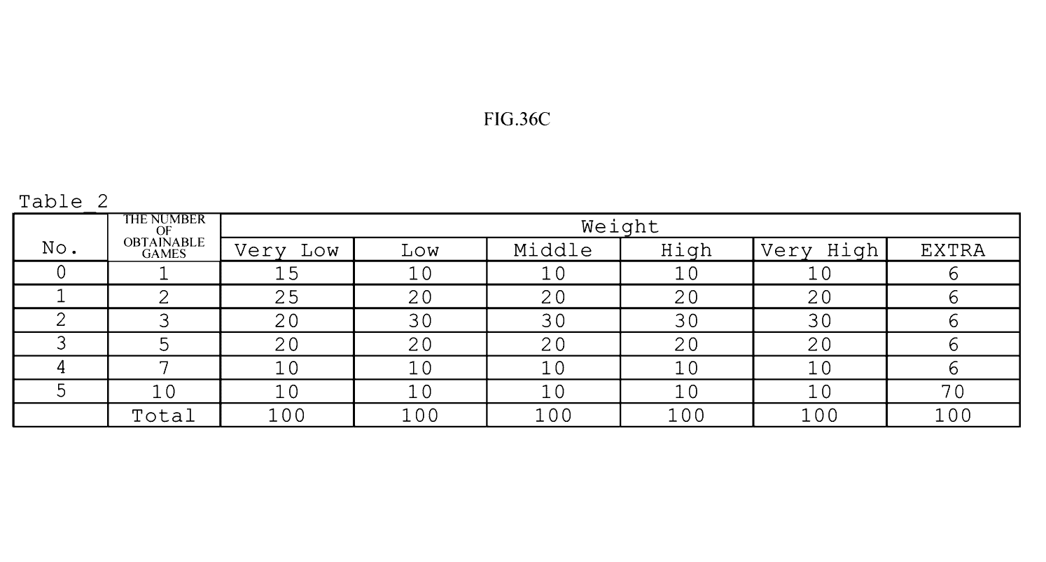

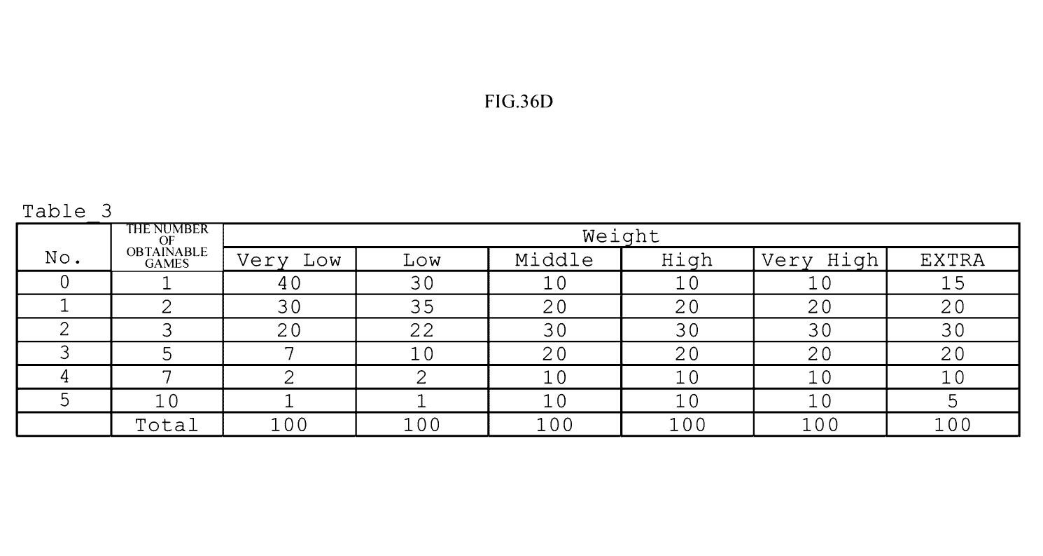

FIGS. 36A to 36D show examples of a lottery table. In the lottery tables, a weighting (lottery value) is defined in association with the number of obtainable games and the lottery level.

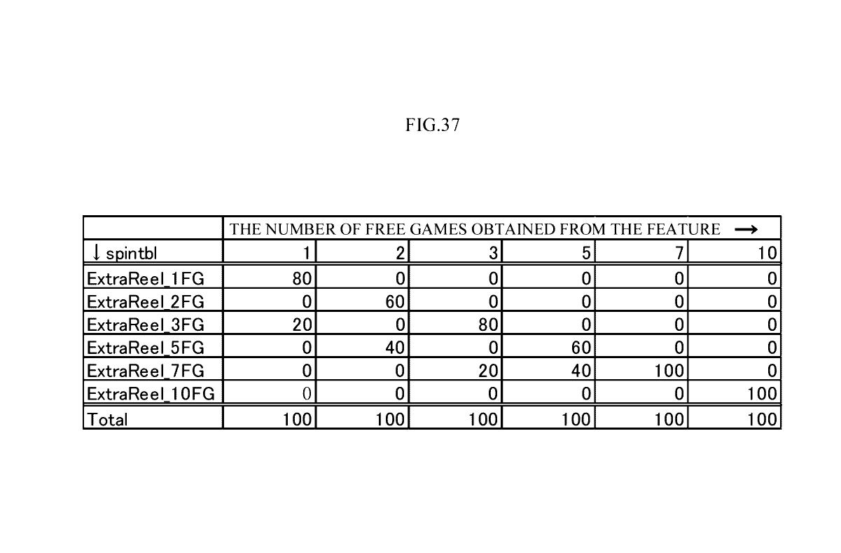

In the slot machine 10, after the free game is triggered, a numeric character indicating the number of games is rotating over each feature symbol 503 causing the triggering. A lottery is held for each feature symbol 503 to determine a spin table which is used with a probability in accordance with the number of obtained games. FIG. 37 shows an example of a spin table determination table for determining the spin table.

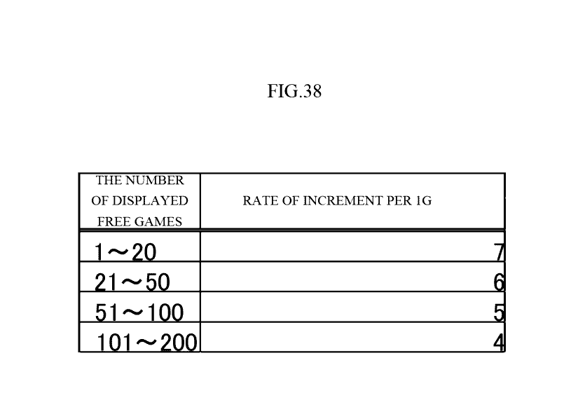

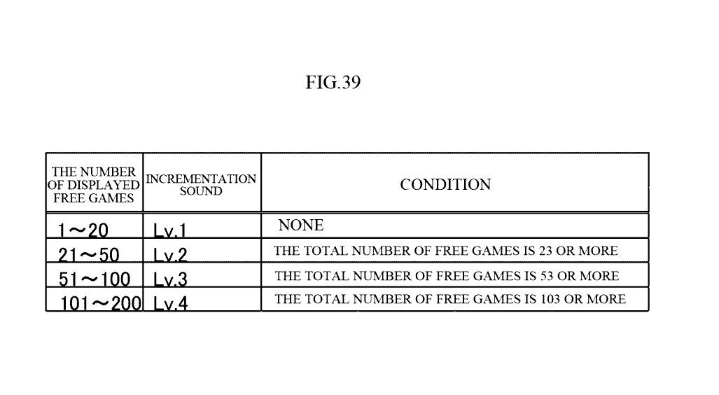

After the lottery for determining the number of games is held for each feature symbol 503 causing the triggering, the total number of games (displayed FG number) indicated in the upper portion of the lower image display panel 141 is incremented. At this time, the rate of increment and a incrementation sound are changed in accordance with the total number of games, as shown in FIGS. 38 and 39. FIG. 38 shows an example of the correspondence relationship between the total number of games and the rate of increment. FIG. 39 shows an example of the correspondence relationship between the total number of games and the incrementation sound (e.g., the sound volume). As shown in the CONDITION field, the incrementation sound outputted in incrementation is changed in accordance with the current number of games. If the condition is not satisfied, the incrementation sound is outputted at one level lower.

After the games, the number of which has been determined by the lottery, are played so that the free game is terminated, the sum total of the obtained credits is displayed on the lower image display panel 141, and then the game returns to the normal game.

(Jackpot)

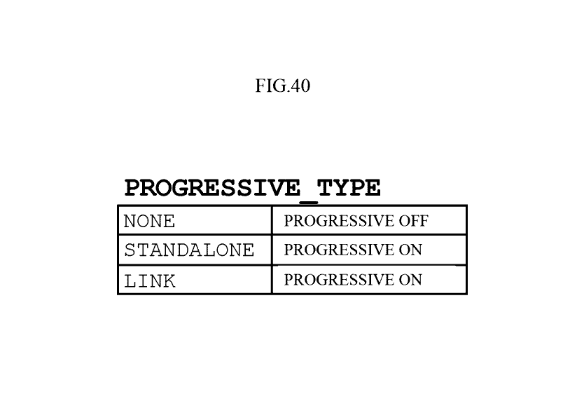

Next, a jackpot will be described. The jackpot is a bonus that enables an accumulated number of payouts (more strictly, credits) to be obtained. The jackpot may be referred to as a progressive, as appropriate. As shown in FIG. 40, types of the jackpot include a type (STAND ALONE) in which the credit is accumulated in the corresponding slot machine 10, a type (LINK) in which the credit is accumulated in a predetermined group to which the corresponding slot machine belongs, and a type (NONE) in which the progressive service is not used. In the type (NONE) in which the progressive function is OFF, the group of video reels B is not displayed and no jackpot is awarded.

In the slot machine 10, the progressive function can be set (ON, OFF) through the audit. When the progressive function is ON, either one type from STAND ALONE or LINK is selectable.

When the progressive function is OFF, an increased probability of wining the free game (feature) can be employed. In one example, a configuration is adoptable in which the symbol arrays 170 used when the progressive function is OFF have a higher probability (the weighting or the number of feature symbols/the total number of symbols) of stopping the feature symbol 503 as compared with the symbol arrays 170 used when the progressive function is ON. In another example, a configuration is adoptable in which the weighting (probability) of replacing the mystery symbol 506 with the feature symbol 503 is increased.

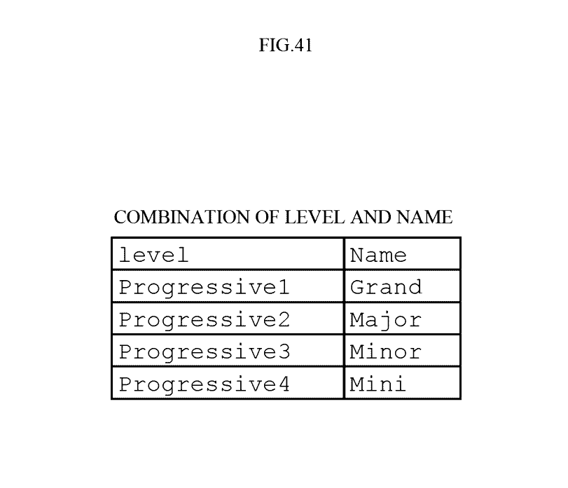

The slot machine 10 have a plurality of levels of the progressive (progressive levels) which indicate the magnitude of an obtainable credit (progressive payout). In this example, four progressive levels (Progressive 1 to Progressive 4) are provided as shown in FIG. 41.

For the obtainable credit, various tables are set such that different degrees of accumulation, different base credits, and different maximum values are provided for different progressive levels.

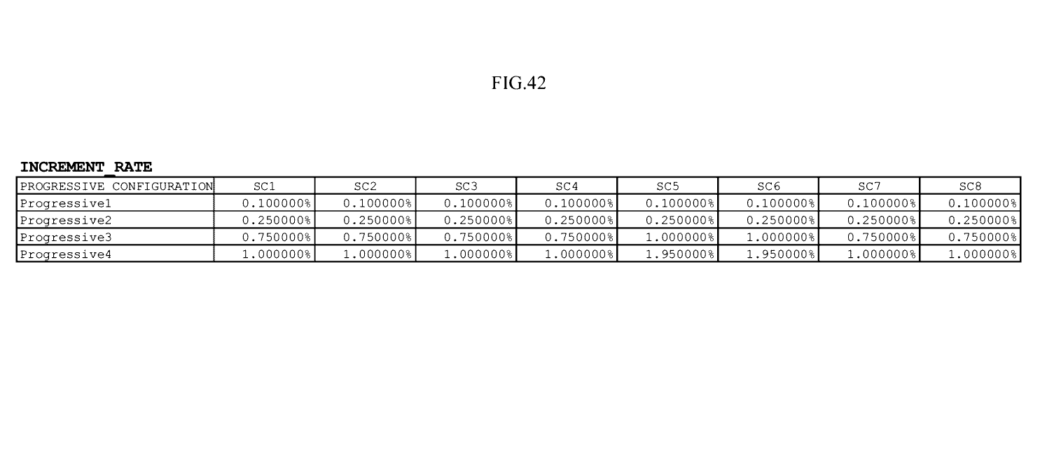

FIG. 42 shows an example of an incremental ratio table that defines the ratio of increment of a credit to be accumulated. The incremental ratio table defines the ratio of increment in association with each progressive level and each setting value (SC01 to SC08).

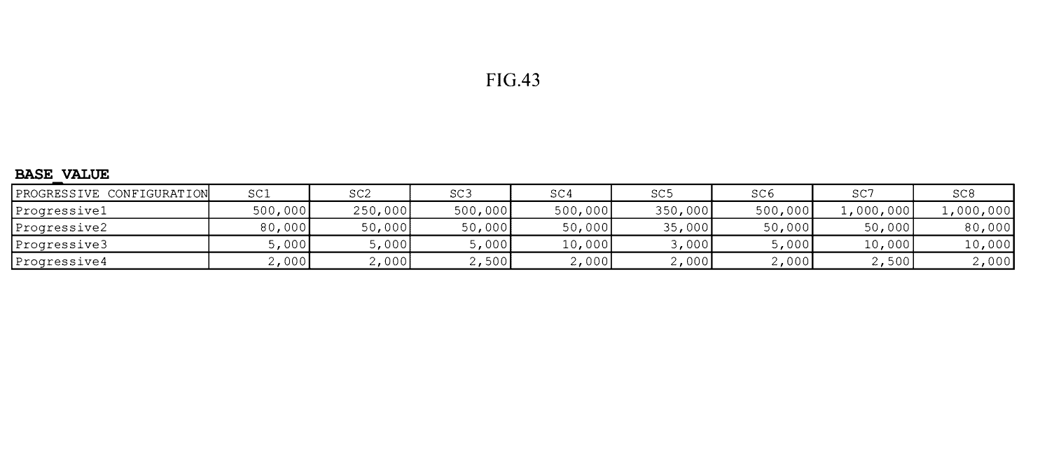

FIG. 43 shows an example of a base value table that defines a base credit. The base value table defines the base value in association with each progressive level and each setting value.

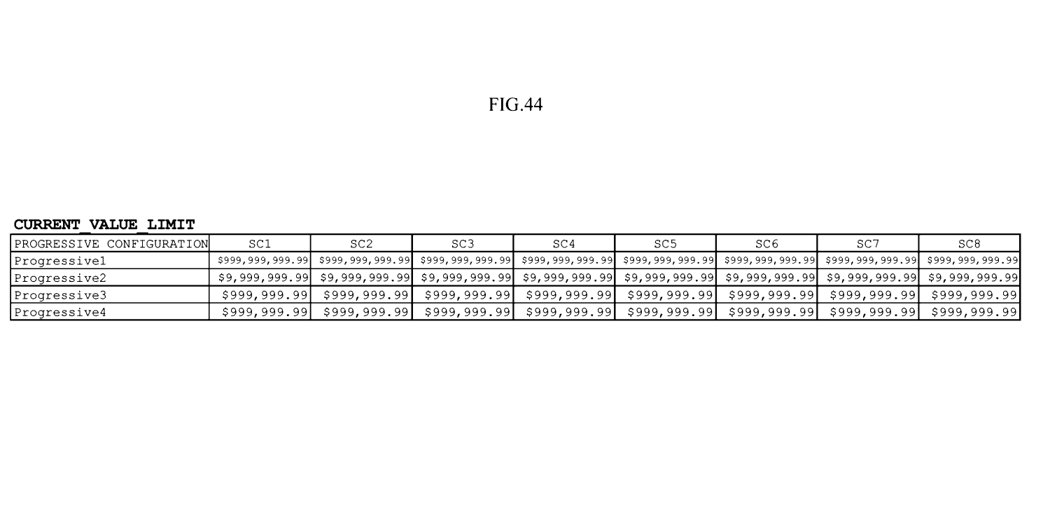

FIG. 44 shows an example of a maximum value table that defines a maximum value (limit value) of an accumulatable credit. The maximum value table defines the maximum value of the accumulatable credit in association with each progressive level and each setting value.

The jackpot of the slot machine 10 firstly determines which of the fixed payout (a payout of a predefined credit) and a progressive payout (a payout of an accumulated credit) is to be awarded. Upon determination to award the progressive payout, which level of payout is to be awarded is determined.

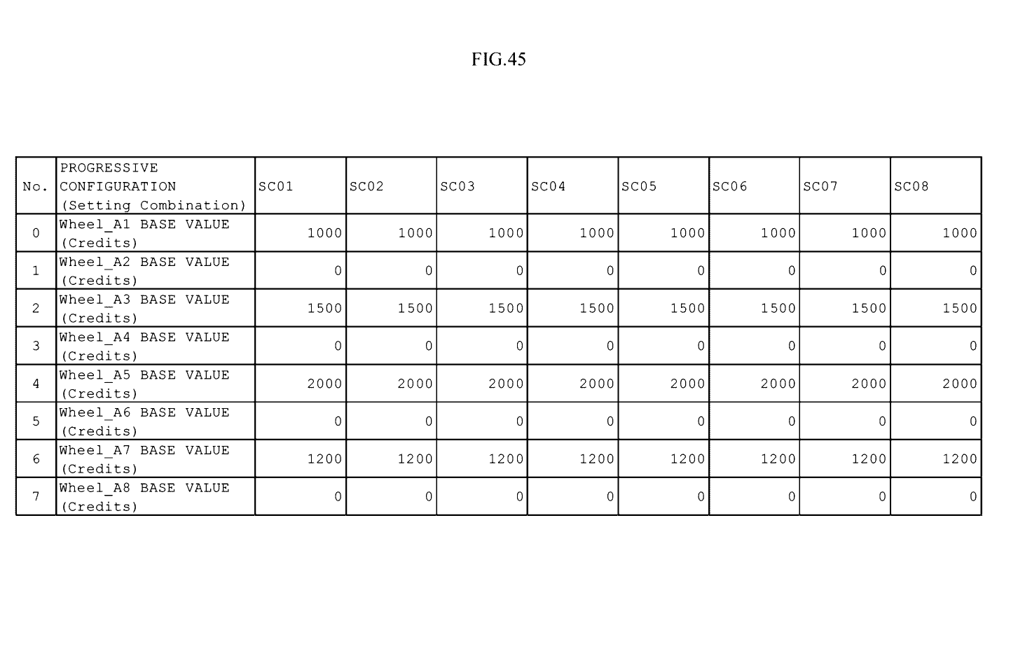

FIG. 45 shows an example of a fixed payout setting table. The fixed payout setting table defines a value of the fixed payout in association with each of a plurality of options (Wheel_A1 to Wheel_A8) and each setting value. The fixed payout having the value “0” represents the progressive payout.

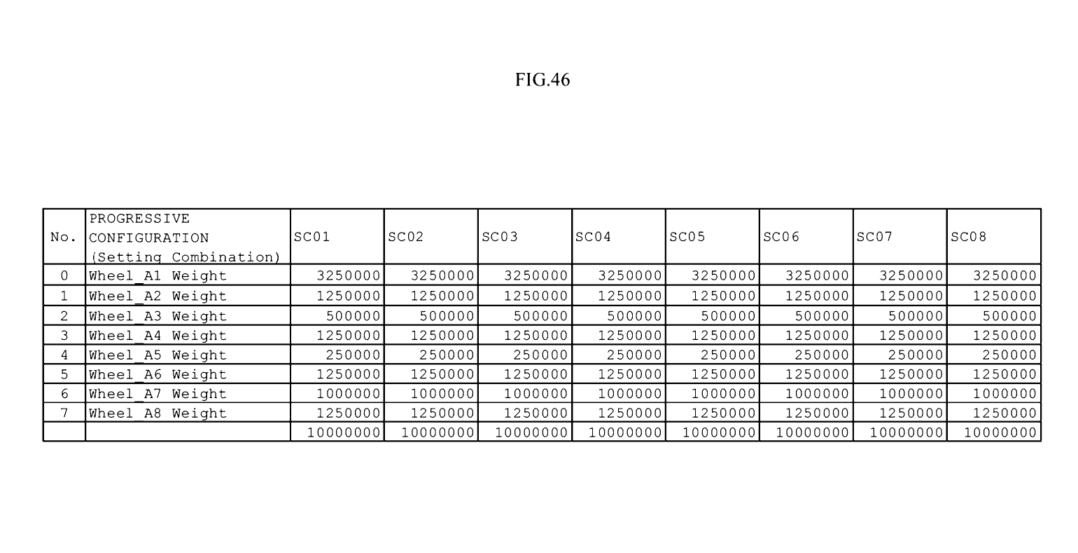

FIG. 46 shows an example of a wheel-A contents determination table which is used for determination of an option (wheel-A contents). The wheel-A contents determination table defines a weighting (lottery value) in association with each of a plurality of options and each setting value.

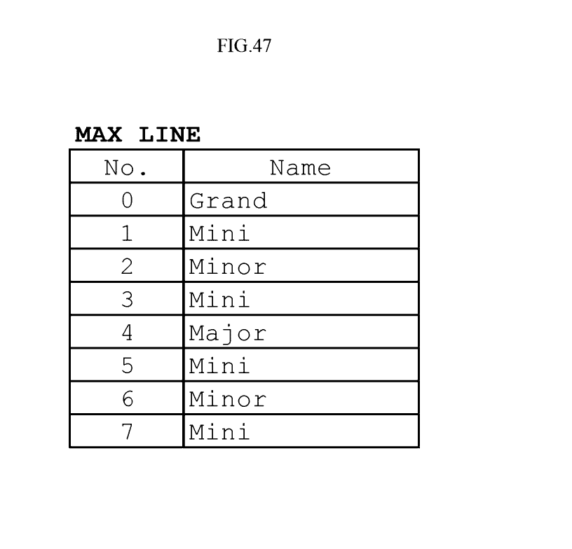

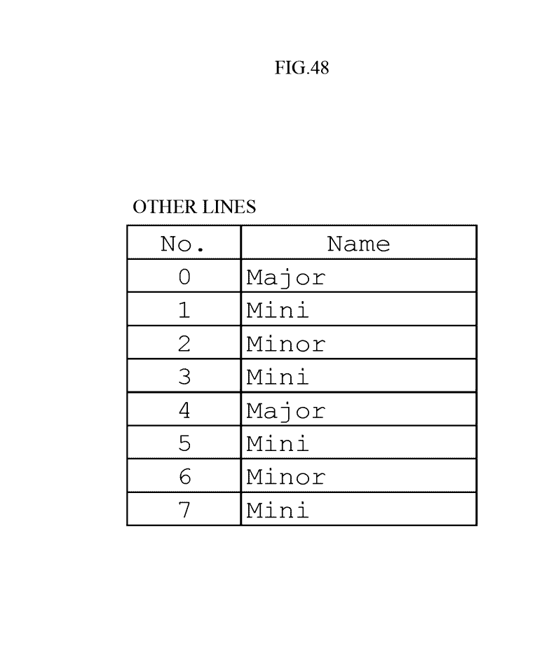

FIGS. 47 and 48 show examples of a progressive payout setting table. A table shown in FIG. 47 is selected upon triggering of the jackpot with the maximum number of activated paylines (MAX LINE). A table shown in FIG. 48 is selected upon triggering of the jackpot with a number of activated paylines (OTHER LINE) that is not equal to the maximum number of activated paylines.

The progressive payout setting table defines a plurality of options (Grand, Major, Minor, Mini).

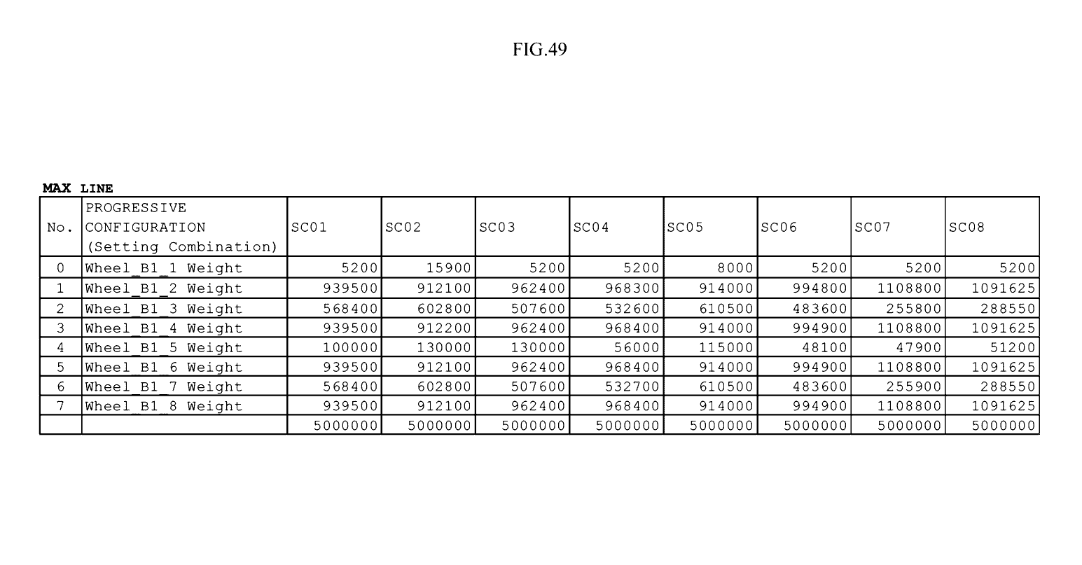

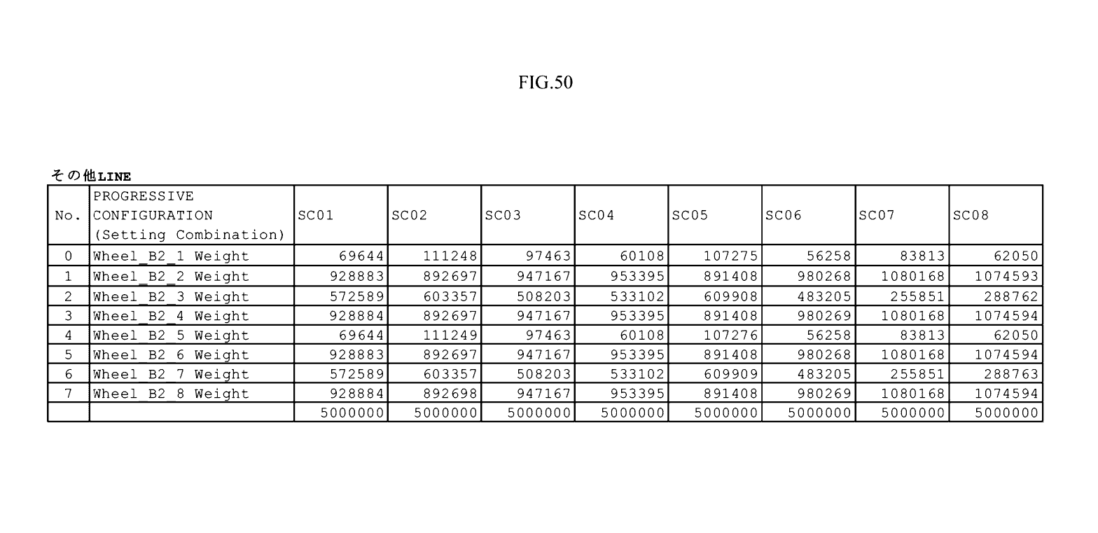

FIGS. 49 and 50 show examples of a wheel-B contents determination table which is used for determination of an option (wheel-B contents). A table shown in FIG. 49 is selected upon triggering of the jackpot with the maximum number of activated paylines. A table shown in FIG. 50 is selected upon triggering of the jackpot with a number of activated paylines that is not equal to the maximum number of activated paylines.

The wheel-B contents determination table defines the weighting (lottery value) in association with each of a plurality of options and each setting value.

(Game Flow)

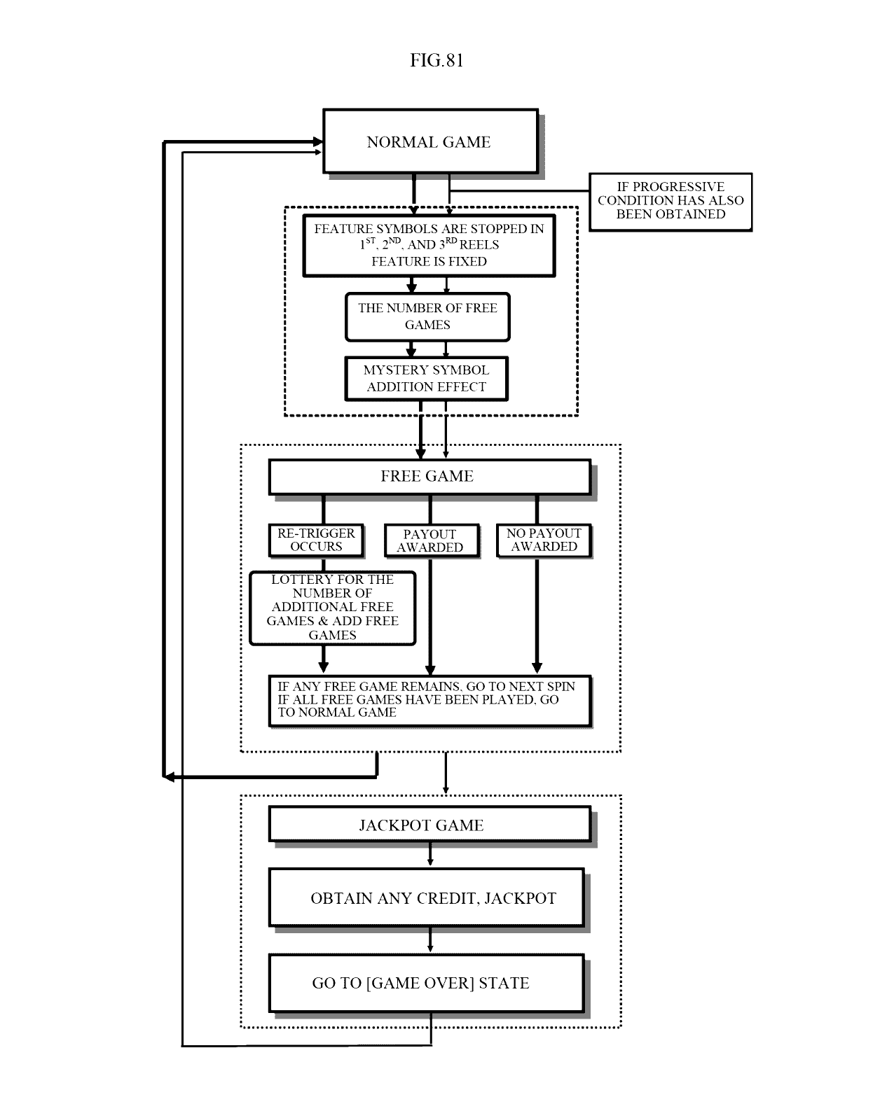

Outline of a game flow in the slot machine 10 will be described with reference to FIG. 81. In the slot machine 10, the game basically begins with the normal game.

If, in the normal game, the feature symbol 503 is stopped in each of the first to third video reels A, a lottery effect associated with the number of games in the free game and an effect associated with addition of the mystery symbol 506 are produced.

Then, the free game is started, and the game (starting and stopping of scrolling of the video reels A) is run a number of times corresponding to the number of games. If re-triggering occurs, a number of games are added. When a payout is awarded, the WIN meter is updated

After all the games are played, the process returns to the normal game in which games are played.

If, in the normal game, the feature symbol 503 is stopped in each of the first to third video reels A and the JP symbols of the group of video reels B are stopped in all of the display blocks 28, the jackpot is started after the free game is played. In the jackpot, the fixed payout or a jackpot payout is awarded, and then the process returns to the normal game in which games are played.

The game flow described above is merely an illustrative example.

(Normal Game Running Process)

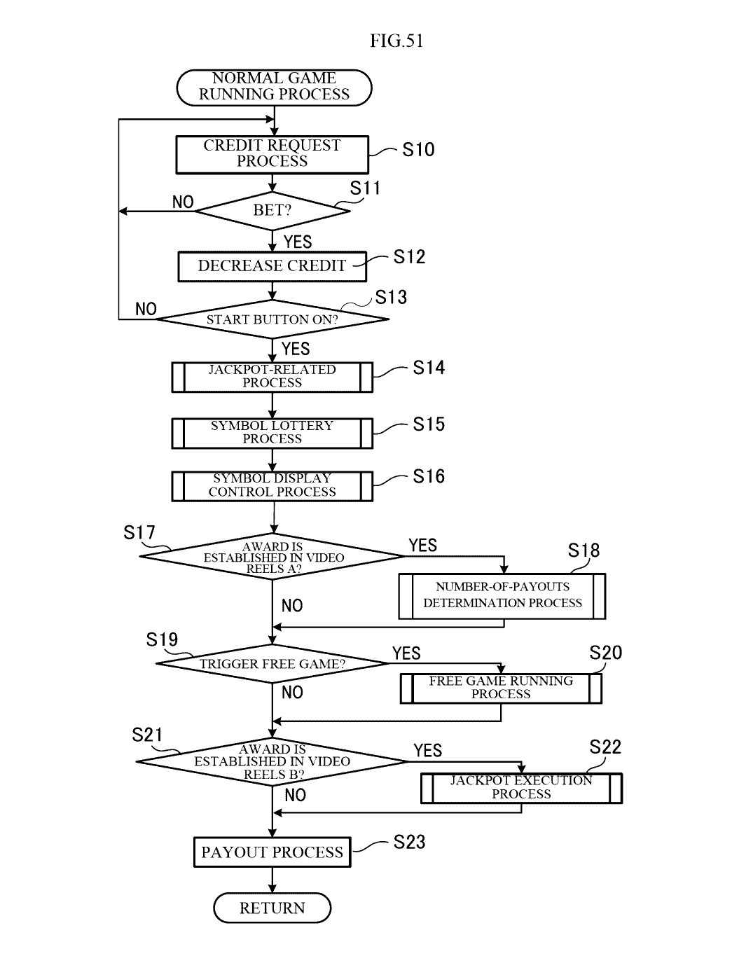

Next, operations of the slot machine 10 will be described. A normal game running process shown in FIG. 51 is executed by the main CPU 71 of the slot machine 10. In the slot machine 10, the game program, etc. is read and an initializing process, etc., is executed.

First, the main CPU 71 executes a credit request process (S10). The main CPU 71 determines whether or not a credit has been input based on a bill or a ticket having the number of credits printed thereon. Upon detection of the input, the main CPU 71 adds the number of inputted credits to a number-of-credits counter. The main CPU 71 also determines whether or not the value of the number-of-credits counter is “0”. Upon determining that it is not “0”, the main CPU 71 makes a control so as to allow an operation (BET operation) on the BET buttons 34 to 38 and the play-line button 40 to 44 to be received in accordance with the value of the number-of-credits counter. Then, the main CPU 71 moves the processing to S11.

In S11, the main CPU 71 determines whether or not the BET operation is performed. In this processing, the main CPU 71 receives an input signal that is outputted from the BET switch 34S to 38S when the corresponding BET button 34 to 38 is operated and an input signal that is outputted from the credit switch 40S to 44S when the corresponding play-line button 40 to 44 is operated, and based on these received input signals, determines the presence or absence of the BET operation.

Upon determining that the BET operation is not performed, the main CPU 71 moves the processing back to S10. Upon determining that the BET operation is performed, the main CPU 71 moves the processing to S12.

In S12, the main CPU 71 updates the values stored in a number-of-BETs storage area provided in the RAM 73 (makes addition to the value of the number of BETs counter and makes subtraction from the value of the number-of-credits counter) in accordance with the BET operation, and makes a control so as to allow an operation (start operation) on the spin button 46 to be received. Then, the main CPU 71 moves the processing to S13.

In S13, the main CPU 71 determines whether or not the spin button 46 (start button) is pressed (ON). In this processing, the main CPU 71 determines whether or not an input signal that is outputted from the spin switch 46S when the spin button 46 is pressed is received. Upon determining that the spin button 46 is not pressed, the main CPU 71 moves the processing back to S10. In a case where the spin button 46 has not been pressed (for example, in a case where an instruction to terminate the play is inputted without pressing of the spin button 46), the main CPU 71 cancels the addition processing and the subtraction processing having been executed in S12. On the other hand, in a case where it is determined that the spin button 46 is pressed in S13, the main CPU 71 moves the processing to S14.

In S14, the main CPU 71 executes a jackpot-related process. In the jackpot-related process, though details thereof will be described later, the main CPU 71 calculates an amount to be accumulated in accordance with the BET operation, and stores the calculated amount or transmits the calculated amount to the external controller 621. Then, the main CPU 71 moves the processing to S15.

In S15, the main CPU 71 executes a symbol lottery process. In the symbol lottery process, though details thereof will be described later, the main CPU 71 determines symbols to be stopped in the display blocks 28 and a winning combination. Then, the main CPU 71 moves the processing to S16.

In S16, the main CPU 71 executes a symbol display control process. In the symbol display control process, though details thereof will be described later, the main CPU 71 stops the symbols, and then moves the processing to S17.

In S17, the main CPU 71 determines whether or not an award is established as a result of rearrangement of symbols of the video reels A. Upon determining that an award is established, the main CPU 71 moves the processing to S18, while upon determining that an award is not established, the main CPU 71 moves the processing to S19.

In S18, the main CPU 71 executes a number-of-payouts determination process. In the number-of-payouts determination process, though details thereof will be described later, the main CPU 71 determines the number of payouts based on, for example, the type and number of symbols that form the winning combination. Then, the main CPU 71 moves the processing to S19.

In S19, the main CPU 71 determines whether or not the free game is triggered (whether or not the bonus win is occurring). Upon determining that the free game is triggered, the main CPU 71 moves the processing to S20, while upon determining that the free game is not triggered, the main CPU 71 moves the processing to S21.

In S20, the main CPU 71 executes a free game running process. In the free game running process, though details thereof will be described later, the main CPU 71 runs the free game, and determines the number of payouts. Then, the main CPU 71 moves the processing to S21.

In S21, the main CPU 71 determines whether or not an award is established (whether or not the bonus win is occurring) as a result of rearrangement of symbols of the video reels B. Upon determining that an award is established, the main CPU 71 moves the processing to S22, while upon determining that an award is not established, the main CPU 71 moves the processing to S23.

In S22, the main CPU 71 executes a jackpot execution process. In the jackpot execution process, though details thereof will be described later, the main CPU 71 executes the jackpot, and determines a fixed payout or a jackpot payout (determines a jackpot payout). Then, the main CPU 71 moves the processing to S23.

In S23, the main CPU 71 executes a payout process, and the normal game running process ends. The main CPU 71 refers to the odds data (such as data indicating the BET multiplying factor) stored in the RAM 73, to determine a payout by multiplying the number of payouts for each winning combination by the BET multiplying factor. In a case where a jackpot payout is occurring, the main CPU 71 adds the jackpot payout to the payout, and executes a payout (for example, updates the number-of-credits counter).

The process is not limited to the above-described one. For example, a configuration is adoptable in which the processing relating to running of the free game (the processing in S19 and S20) is executed after the processing relating to running of the jackpot (the processing in S21 and S22).

(Jackpot-Related Process)

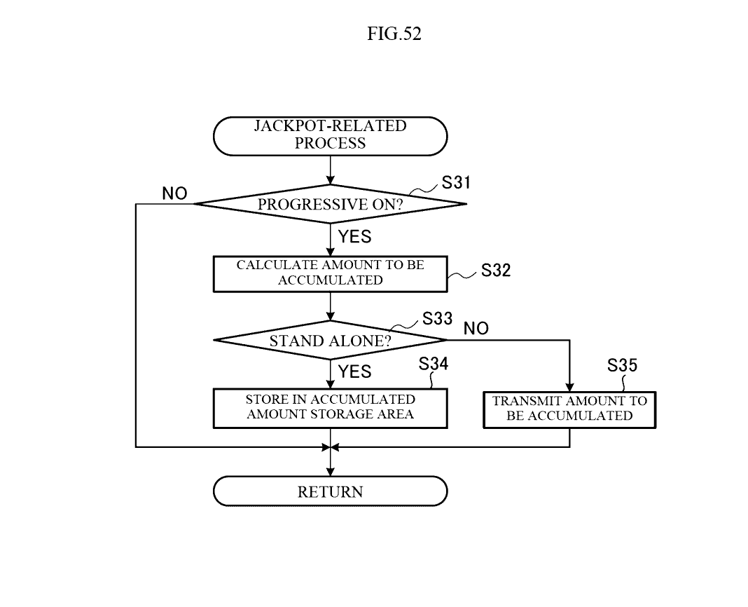

In the jackpot-related process, as shown in FIG. 52, the main CPU 71 firstly determines whether or not the progressive function is ON (S31). More specifically, the main CPU 71 obtains information designating any of the values (NONE, STAND ALONE, LINK) stored in the RAM 73 as shown in FIG. 40, and determines whether or not the obtained information is information indicating either one of “STAND ALONE” and “LINK”. Upon determining that the progressive function is ON, the main CPU 71 moves the processing to S32. Upon determining that the progressive function is not ON, the main CPU 71 terminates the jackpot-related process.

In S32, the main CPU 71 calculates an amount to be accumulated. More specifically, the main CPU 71 obtains the product of the value stored in the number-of-BETs storage area and an incremental ratio (a preset accumulation ratio) shown in FIG. 42, thereby calculating an amount to be accumulated into a jackpot amount.

In S33, the main CPU 71 determines whether or not the jackpot type is the stand-alone type (STAND ALONE). Upon determining that the jackpot type is the stand-alone type, the main CPU 71 moves the processing to S34, while upon determining that the jackpot type is not the stand-alone type (STAND ALONE), the main CPU 71 moves the processing to S35.

In S34, the main CPU 71 accumulates and stores the calculated amount to be accumulated, in an accumulated amount storage area (a jackpot payout storage area provided in the RAM 73). After this processing, the main CPU 71 terminates the jackpot-related process.

In S35, the main CPU 71 transmits the calculated amount to be accumulated, to the external controller 621. Upon reception of the amount to be accumulated, the external controller 621 updates the jackpot payout. After this processing, the main CPU 71 terminates the jackpot-related process.

The process is not limited to the above-described one. For example, a configuration is adoptable in which, irrespective of the jackpot type, the determination of S31 and S33 are not performed but an amount to be accumulated is transmitted to the external controller 621 so that the jackpot payout is managed (stored) in the external controller 621.

(Symbol Lottery Process)

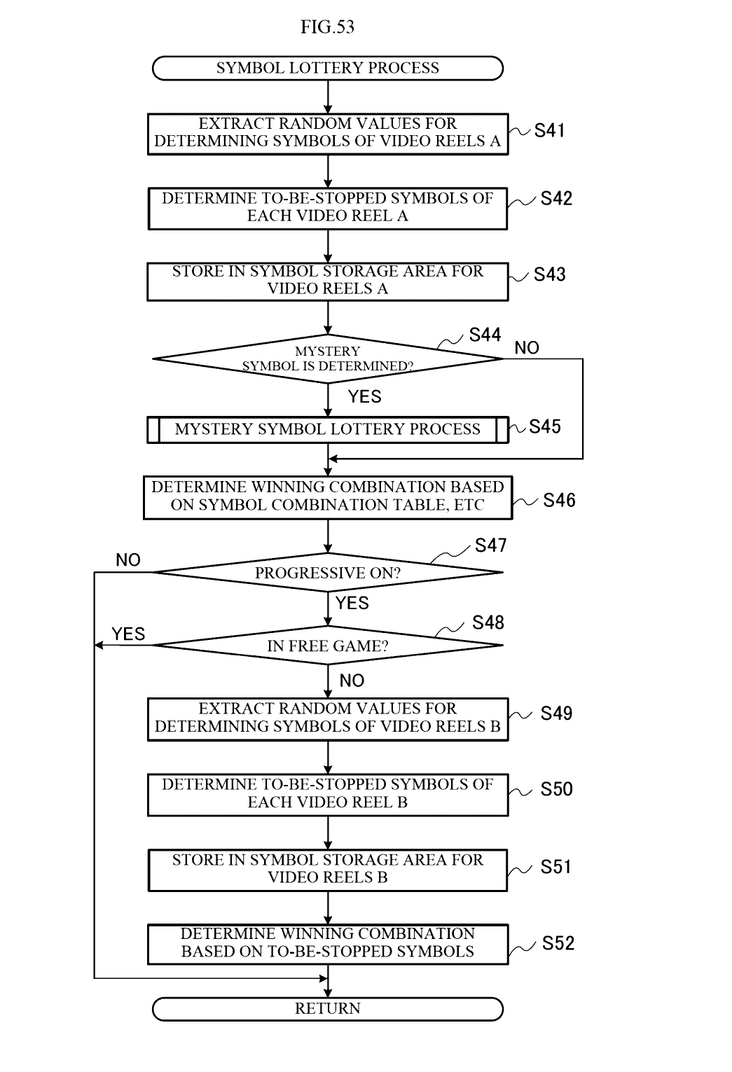

In the symbol lottery process, as shown in FIG. 53, the main CPU 71 firstly extracts random values for determining symbols of the video reels A (S41). After this processing, the main CPU 71 moves the processing to S42.

In S42, the main CPU 71 determines, by a lottery, a to-be-stopped symbol of each video reel A. More specifically, the main CPU 71 determines the group of video reels A to be used, based on the state of selection of the progressive function (ON or OFF) and the game type (the normal game or the free game), holds a lottery in accordance with each video reel A, and determines any of the code numbers. The symbols arranged in each video reel A have equal probabilities of being determined as a to-be-stopped symbol. After this processing, the main CPU 71 moves the processing to S43.

In S43, the main CPU 71 stores a series of symbols (to-be-stopped symbols of the respective video reels A) corresponding to the determined code numbers, into a symbol storage area for video reels A which is provided in the RAM 73. After this processing, the main CPU 71 moves the processing to S44.

In S44, the main CPU 71 determines whether or not the determined to-be-stopped symbols include a mystery symbol 506. Upon determining that the determined to-be-stopped symbols include the mystery symbol 506, the main CPU 71 moves the processing to S45, while upon determining that the determined to-be-stopped symbols include no mystery symbol 506, the main CPU 71 moves the processing to S46.

In S45, the main CPU 71 executes a mystery symbol lottery process. In the mystery symbol lottery process, though details thereof will be described later, the main CPU 71 determines a replacement symbol and stores it into the RAM 73. After this processing, the main CPU 71 moves the processing to S46.

In S46, the main CPU 71 refers to tables (FIGS. 29 and 30) indicating combinations of symbols, etc., to determine a winning combination based on the symbol storage area. For example, the main CPU 71 determines a winning combination by determining whether or not a combination of symbols of the video reels A displayed on the activated payline is coincident with a combination of symbols defined in the tables that indicate combinations of symbols. The main CPU 71 determines a winning combination by determining whether or not at least one feature symbol 503 is stopped in each of the first to third display columns 1421 to 1423. The main CPU 71 stores the determined winning combination into a winning combination storage area for video reels A. After this processing, the main CPU 71 moves the processing to S47.

In S47, the main CPU 71 determines whether or not the progressive function is ON. More specifically, the main CPU 71 obtains information designating any of the values (NONE, STAND ALONE, LINK) stored in the RAM 73 as shown in FIG. 40, and determines whether or not the obtained information is information indicating either one of “STAND ALONE” and “LINK”. Upon determining that the progressive function is ON, the main CPU 71 moves the processing to S48, while upon determining that the progressive function is not ON, the main CPU 71 terminates the symbol lottery process.

In S48, the main CPU 71 determines whether or not the free game is running Upon determining that the free game is running, the main CPU 71 terminates the symbol lottery process, while upon determining that the free game is not running, the main CPU 71 moves the processing to S49.

In S49, the main CPU 71 extracts random values for determining symbols of the video reels B. After this processing, the main CPU 71 moves the processing to S50.

In S50, the main CPU 71 determines, by a lottery, a to-be-stopped symbol of each video reel B. More specifically, the main CPU 71 determines the group of video reels B corresponding to the total number of BETs (Total Bet), holds a lottery in accordance with each video reel B, and determines any of the code numbers. The symbols and blanks arranged in the video reels B have equal probabilities of being determined as a to-be-stopped symbol. After this processing, the main CPU 71 moves the processing to S51.

In S51, the main CPU 71 stores a series of symbols (to-be-stopped symbols of the respective video reels B) corresponding to the determined code numbers, into a symbol storage area for video reels B which is provided in the RAM 73. After this processing, the main CPU 71 moves the processing to S52.

In S52, the main CPU 71 determines a winning combination (whether or not a jackpot is awarded) based on the symbol storage area. More specifically, the main CPU 71 determines whether or not JP symbols 507 of the video reels B are stopped in all the display blocks 28, and upon determining that JP symbols 507 are stopped in all the display blocks 28, determines a jackpot winning combination (jackpot award). The main CPU 71 stores the determined winning combination into a winning combination storage area for video reels B. After this processing, the main CPU 71 terminates the symbol lottery process.

(Mystery Symbol Lottery Process)

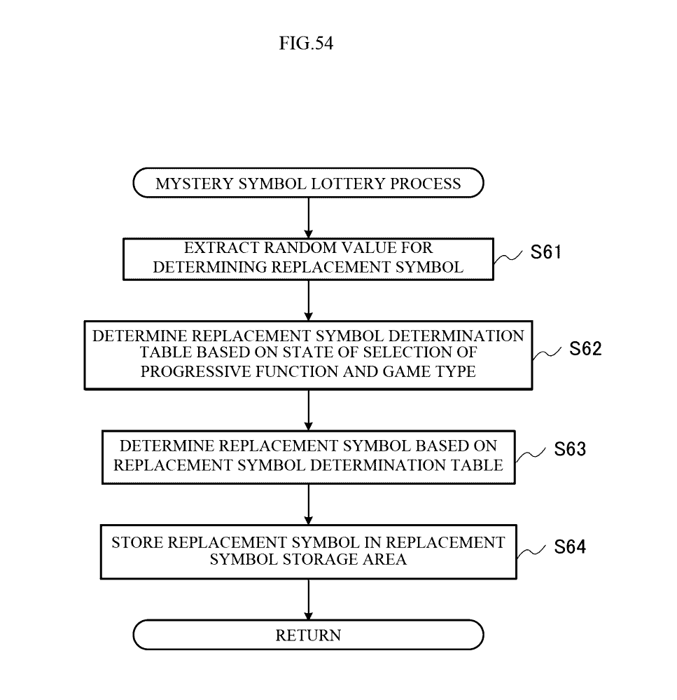

In the mystery symbol lottery process, as shown in FIG. 54, the main CPU 71 firstly extracts a random value for determining a replacement symbol (S61). After this processing, the main CPU 71 moves the processing to S62.

In S62, the main CPU 71 determines a replacement symbol lottery table (replacement symbol determination table). More specifically, the main CPU 71 determines a replacement symbol determination table to be used, among the replacement symbol determination tables shown in FIGS. 19 to 22, based on the state of selection of the progressive function (ON or OFF) and the game type (the normal game or the free game). After this processing, the main CPU 71 moves the processing to S63.

In S63, the main CPU 71 determines a replacement symbol by a lottery. More specifically, the main CPU 71 determines a replacement symbol (one symbol) based on the extracted random value and the determined replacement symbol determination table. After this processing, the main CPU 71 moves the processing to S64.

In S64, the main CPU 71 stores the determined replacement symbol into a replacement symbol storage area which is provided in the RAM 73. After this processing, the main CPU 71 terminates the mystery symbol lottery process.

(Symbol Display Control Process)

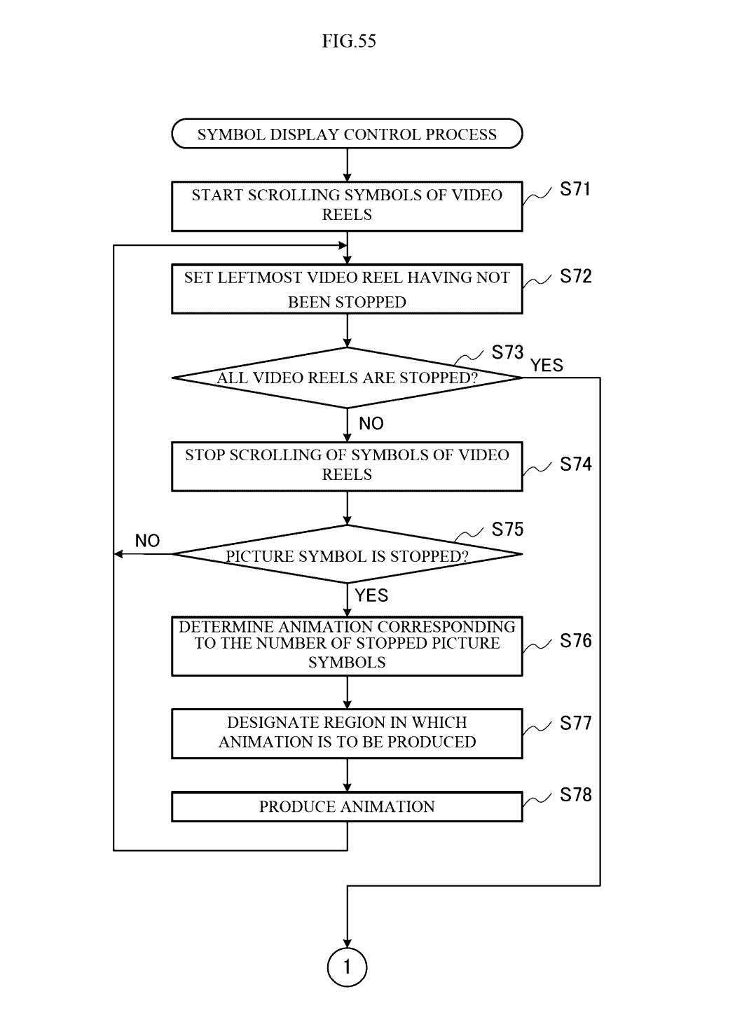

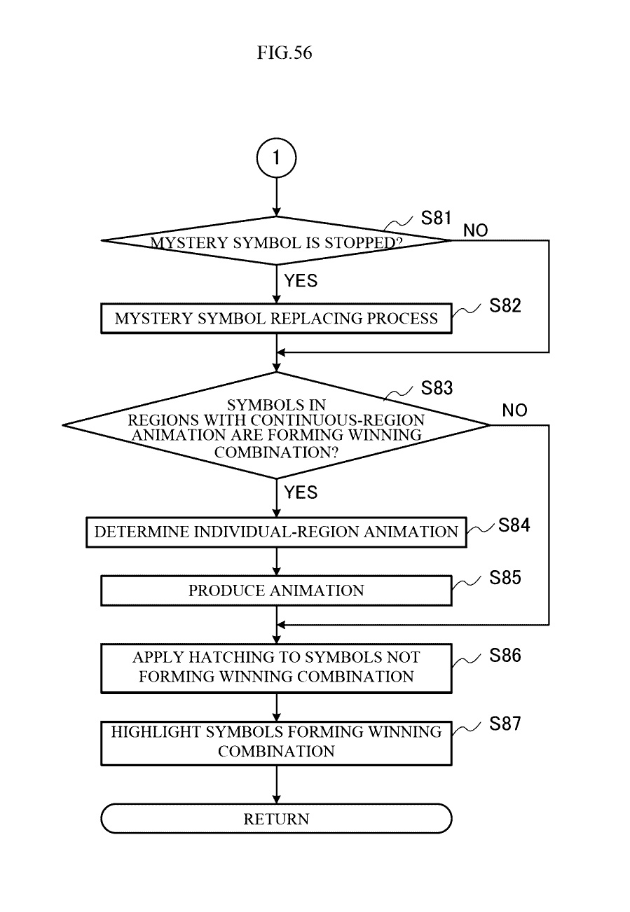

In the symbol display control process, as shown in FIGS. 55 and 56, the main CPU 71 firstly starts scrolling the symbol arrays of the respective video reels displayed in the symbol display area 150 of the lower image display panel 141 (S71).

More specifically, in a case where the normal game is running and the progressive function is ON, the main CPU 71 starts scrolling the symbol arrays of the respective video reels A and the symbol arrays of the respective video reels B. As an additional remark, it is to be noted that the symbols of the respective video reels A and the symbols of the respective video reels B are simultaneously scrolled in the symbol display area 150.

In the slot machine 10, a reel strip of each video reel A and a reel strip of each video reel B have different lengths, and they are rotating with different cycles. In this respect, a scroll start symbol of each video reel A and a scroll start symbol of each video reel B are determined by backward calculation from the to-be-stopped symbol of the video reel A and the to-be-stopped symbol of the video reel B at an appropriate timing. This is why the to-be-stopped symbol of the video reel A and the to-be-stopped symbol of the video reel B can be stopped in synchronization with each other.

In a case where the normal game is running and the progressive function is OFF or in a case where the free game is running, the main CPU 71 starts scrolling the symbol arrays of the respective video reels A.

In S72, the main CPU 71 sets, as an object to be stopped, the leftmost video reel that has not been stopped. In this embodiment, stopping is effected sequentially from the first video reel arranged leftmost toward the right video reels, that is, in the order of the second video reel, the third video reel, the fourth video reel, and the fifth video reel.

In S73, the main CPU 71 determines whether or not all the video reels are stopped. Upon determining that all the video reels are stopped, the main CPU 71 moves the processing to S81 shown in FIG. 56, while upon determining that not all the video reels are stopped, the main CPU 71 moves the processing to S74.

In S74, the main CPU 71 stops scrolling of the video reel that is the object to be stopped. After this processing, the main CPU 71 moves the processing to S75.

In S75, the main CPU 71 determines whether or not a picture symbol 505 is stopped in the symbol display area 150. Upon determining that a picture symbol 505 is stopped in the symbol display area 150, the main CPU 71 moves the processing to S76, while upon determining that no picture symbol 505 is stopped in the symbol display area 150, the main CPU 71 moves the processing to S72.

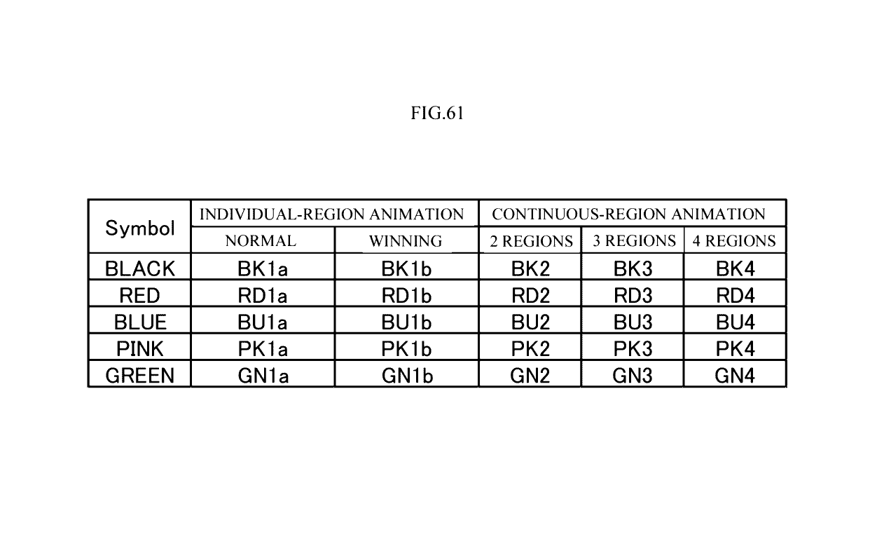

In S76, the main CPU 71 determines an animation corresponding to the number of stopped picture symbols 505. For example, in a case where one “RED” picture symbol 505 is stopped (first stage) and three “BLACK” picture symbols 505 are stopped (second, third, and fourth stages), the main CPU 71 determines a normal individual-region animation “RD1a” and a continuous-region animation “BK3” corresponding to three regions, by referring to an animation determination table shown in FIG. 61. After this processing, the main CPU 71 moves the processing to S77.

In S77, the main CPU 71 designates a region in which an animation is to be produced. In the above-described example, the main CPU 71 designates, as a region in which an animation is to be produced, a region in the first stage where the “RED” picture symbol 505 is stopped and regions in the second, third, and fourth stages where the “BLACK” picture symbols 505 are stopped. After this processing, the main CPU 71 moves the processing to S78.

In S78, the main CPU 71 produces an animation. More specifically, the main CPU 71 reads out an animation file corresponding to the determined animation from animation files stored in the ROM 72 or the like, and outputs to the graphic board 130 a command to reproduce the determined animation file in the designated region. After this processing, the main CPU 71 moves the processing to S72.

In S81 of FIG. 56, the main CPU 71 determines whether or not a mystery symbol 506 is stopped in the symbol display area 150. Upon determining that a mystery symbol 506 is stopped in the symbol display area 150, the main CPU 71 moves the processing to S82, while upon determining that no mystery symbol 506 is stopped in the symbol display area 150, the main CPU 71 moves the processing to S83.

In S82, the main CPU 71 executes a mystery symbol replacing process. More specifically, the main CPU 71 reads out replacement symbols from the replacement symbol storage area, and replaces all the mystery symbols 506 with the replacement symbols concurrently. The main CPU 71 determines whether or not the replacement symbol is a picture symbol 505, and upon determining that it is a picture symbol, produces an individual-region animation. After this processing, the main CPU 71 moves the processing to S83.

In S83, the main CPU 71 determines whether or not the symbols stopped in the regions in which a continuous-region animation is being produced are symbols that form a winning combination. Upon determining that the symbols stopped in the regions in which a continuous-region animation is being produced are symbols that form a winning combination, the main CPU 71 moves the processing to S84, while upon determining that the symbols stopped in the regions in which a continuous-region animation is being produced are not symbols that form a winning combination, the main CPU 71 moves the processing to S86.

In S84, the main CPU 71 determines an individual-region animation. In the above-described example, if the “BLACK” picture symbols 505 stopped in the second and third stages are symbols that form a winning combination (winning combination), the main CPU 71 determines a winning individual-region animation “BK1b” for each of the second and third stages as well as a normal individual-region animation “BK1a” for the fourth stage. After this processing, the main CPU 71 moves the processing to S85.

In S85, the main CPU 71 produces an animation. More specifically, the main CPU 71 outputs to the graphic board 130 a command to concurrently start animations associated with the winning combination among the determined animations (to start animations associated with the winning combination such that the animations are displayed with the same motion) in each region. After this processing, the main CPU 71 moves the processing to S86.

In S86, the main CPU 71 applies hatching to symbols that do not form the winning combination. More specifically, the main CPU 71 refers to the symbol storage area for video reels A and the winning combination storage area for video reels A, to identify symbols (or regions) that do not form the winning combination (winning combination), among the symbols stopped in the symbol display area 150. The main CPU 71 outputs to the graphic board 130 a command to apply hatching to the identified symbols. After this processing, the main CPU 71 moves the processing to S87.

In S87, the main CPU 71 highlights the symbols that form the winning combination. More specifically, the main CPU 71 refers to the winning combination storage area for video reels A, to identify symbols (or regions) that form the winning combination (winning combination). The main CPU 71 outputs to the graphic board 130 a command to highlight the identified symbols. After this processing, the main CPU 71 terminates the symbol lottery process.

(Number-of-Payouts Determination Process)

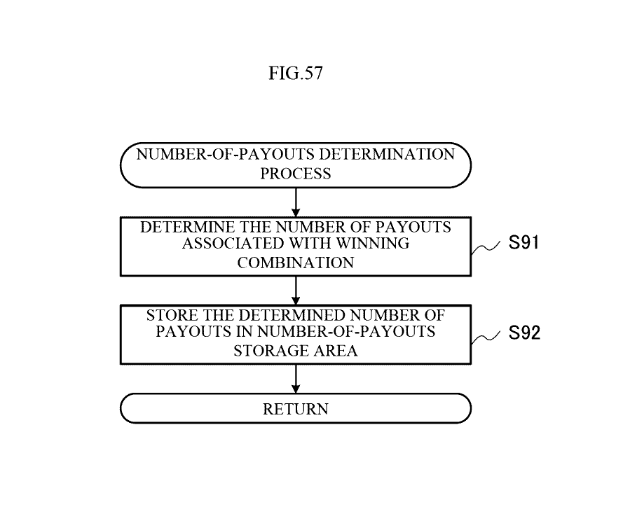

In the number-of-payouts determination process, as shown in FIG. 57, the main CPU 71 firstly determines the number of payouts associated with the winning combination (S91). For example, in a case where the winning combination is 3 Kind of “ACE”, it is determined that the number of payouts is “5” (see FIG. 29). In a case of a lose, it is determined that the number of payouts is “0”.

In S92, the main CPU 71 stores the determined number of payouts into a number-of-payouts storage area. After this processing, the main CPU 71 terminates the number-of-payouts determination process.

(Free Game Running Process)

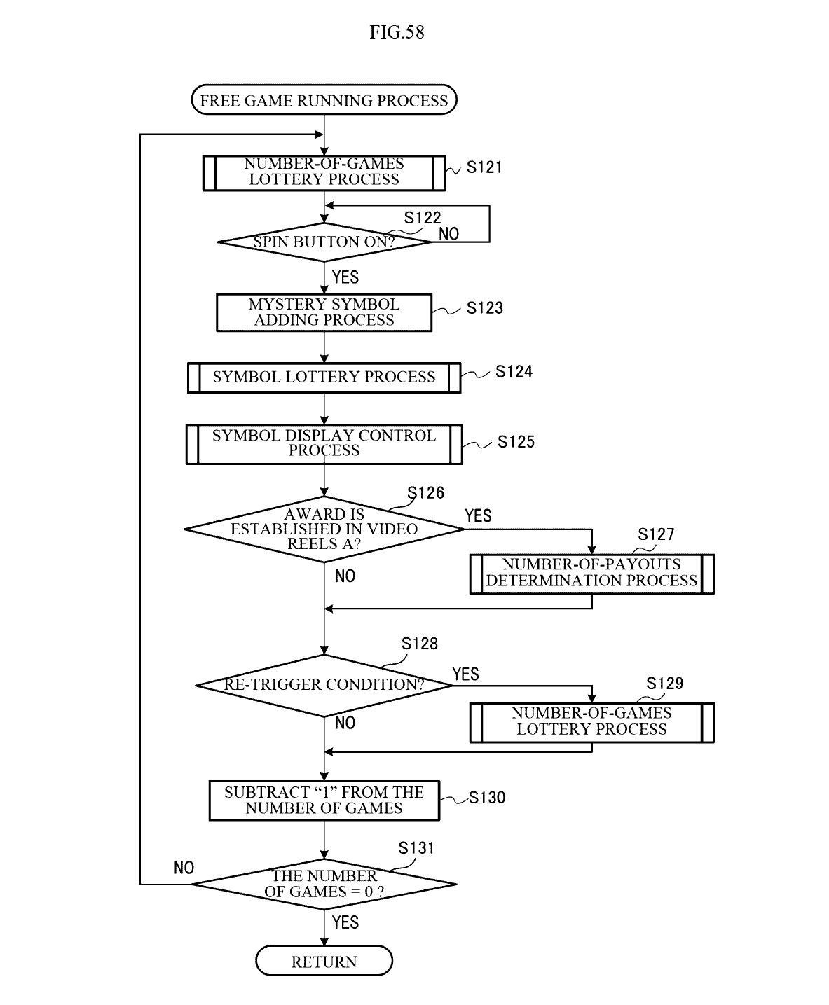

In the free game running process, as shown in FIG. 58, the main CPU 71 firstly executes a number-of-games lottery process (S121). In the number-of-games lottery process, though details thereof will be described later, the main CPU 71 determines the number of free games. After this processing, the main CPU 71 moves the processing to S122.

In S122, the main CPU 71 determines whether or not the spin button 46 is pressed (ON). In this processing, the main CPU 71 determines whether or not an input signal that is outputted from the spin switch 46S when the spin button 46 is pressed is received. Upon determining that the spin button 46 is pressed, the main CPU 71 moves the processing to S123, while upon determining that the spin button 46 is not pressed, the main CPU 71 moves the processing back to S121.

In S123, the main CPU 71 executes a mystery symbol adding process. More specifically, the main CPU 71 switches the symbol arrays from the normal-game symbol arrays (see FIGS. 15A to 15D, FIGS. 17A to 17D) to the free-game symbol arrays (see FIGS. 16A to 16D, FIGS. 18A to 18D). The free-game symbol arrays include fifty mystery symbols 506 in addition to the normal-game symbol arrays. After this processing, the main CPU 71 moves the processing to S124.

In S124, the main CPU 71 executes a symbol lottery process. In the symbol lottery process, as shown in FIG. 53, the main CPU 71 determines symbols to be stopped in the display blocks 28 and a winning combination. After this processing, the main CPU 71 moves the processing to S125.

In S125, the main CPU 71 executes a symbol display control process. In the symbol display control process, as shown in FIGS. 55 and 56, the main CPU 71 stops the symbols. Since the video reels B are not used in the free game, the symbols of the video reels B are neither scrolled nor stopped. After this processing, the main CPU 71 moves the processing to S126.

In S126, the main CPU 71 determines whether or not an award is established as a result of rearrangement of symbols of the video reels A. Upon determining that an award is established, the main CPU 71 moves the processing to S127, while upon determining that an award is not established, the main CPU 71 moves the processing to S128.

In S127, the main CPU 71 executes a number-of-payouts determination process. In the number-of-payouts determination process, as shown in FIG. 57, the main CPU 71 determines the number of payouts based on, for example, the type and number of symbols that form the winning combination. Then, the main CPU 71 moves the processing to S128.

In S128, the main CPU 71 determines whether or not a re-trigger condition is satisfied (whether or not the bonus win is occurring). Upon determining that the free game is re-triggered, the main CPU 71 moves the processing to S129, while upon determining that the free game is not re-triggered, the main CPU 71 moves the processing to S130.

In S129, the main CPU 71 executes a number-of-games lottery process. In the number-of-games lottery process, though details thereof will be described later, the main CPU 71 determines the number of free games. After this processing, the main CPU 71 moves the processing to S130.

In S130, the main CPU 71 subtracts “1” from the number of games, and moves the processing to S131.

In S131, the main CPU 71 determines whether or not the number of games is “0”. Upon determining that the number of games is “0”, the main CPU 71 terminates the free game running process, while upon determining that the number of games is not “0”, the main CPU 71 moves the processing to S121.

The free game running process is not limited to the above-described one. For example, a configuration is adoptable in which offering additional free games instead of increasing the number of games is provided upon establishment of re-triggering.

For example, in S129-1 instead of S129, though not shown, the main CPU 71 adds “1” to the number of re-triggers. At this time, the main CPU 71 outputs a command to the graphic board 130 via the body PCB 110, the command instructing to display an image indicating that the number of re-triggers has been updated. Then, the main CPU 71 moves the processing to S130.

In S130, the main CPU 71 subtracts “1” from the number of games, and moves the processing to S131. In S131, the main CPU 71 determines whether or not the number of games is “0”. Upon determining that the number of games is “0”, the main CPU 71 moves the processing to S132, while upon determining that the number of games is not “0”, the main CPU 71 moves the processing to S121.

In S132, the main CPU 71 subtracts “1” from the number of re-triggers, and moves the processing to S133.

In S133, the main CPU 71 determines whether or not the number of re-triggers is “−1”. Upon determining that the number of re-triggers is “−1”, the main CPU 71 terminates this free game running process, while upon determining that the number of re-triggers is not “−1”, the main CPU 71 moves the processing back to S121.

Occurrence of the re-triggering during the free game involves production of a sound effect such as a beep sound, and then causes a display for informing the player that there is one free game in stock.

(Number-of-Games Lottery Process)

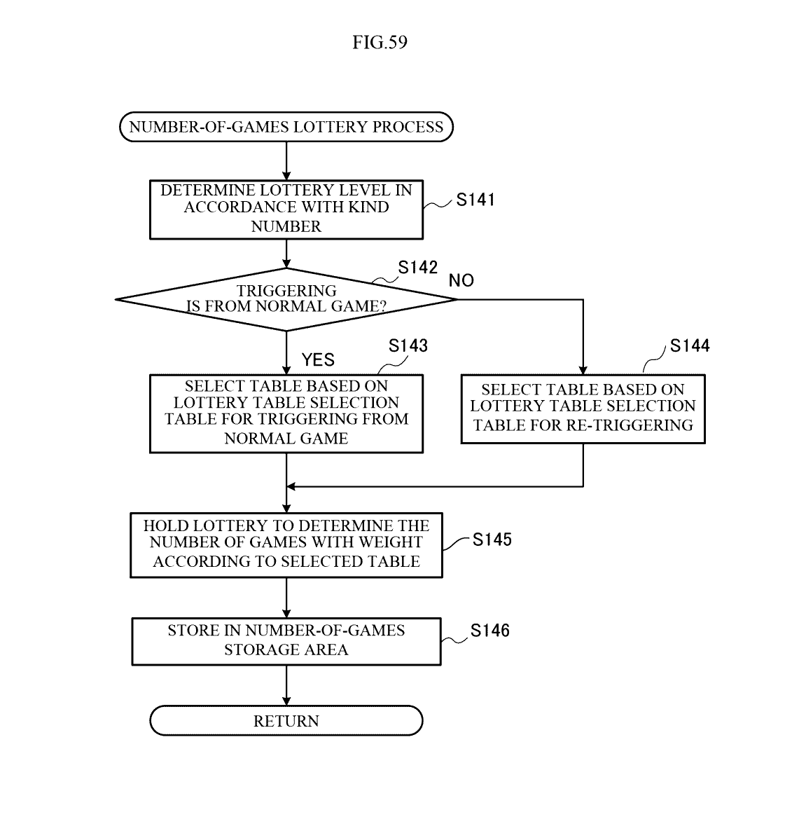

In the number-of-games lottery process, as shown in FIG. 59, the main CPU 71 firstly determines a lottery level in accordance with the Kind number (S141). For example, in a case where the Kind number is “20”, the main CPU 71 determines that the lottery level is “EXTRA”, based on the lottery level determination table shown in FIG. 34. After this processing, the main CPU 71 moves the processing to S142.

In S142, the main CPU 71 determines whether or not triggering is from the normal game. Upon determining that triggering is from the normal game, the main CPU 71 moves the processing to S143, while upon determining that triggering is not from the normal game, the main CPU 71 moves the processing to S144.

In S143, the main CPU 71 selects a table based on a lottery table selection table for triggering from the normal game. The main CPU 71 determines any table from “TABLE 0”, “TABLE 1”, and “TABLE 2”, based on the lottery table selection table shown in FIG. 35A. After this processing, the main CPU 71 moves the processing to S145.

In S144, the main CPU 71 selects a table based on a lottery table selection table for re-triggering. The main CPU 71 determines any table from “TABLE 0”, “TABLE 1”, and “TABLES”, based on the lottery table selection table shown in FIG. 35B. After this processing, the main CPU 71 moves the processing to S145.

In S145, the main CPU 71 holds a lottery to determine the number of games with a weight according to the selected table. More specifically, the main CPU 71 holds a lottery (a number of lotteries corresponding to the Kind number) for each active feature symbol 503, by using the selected table (see FIGS. 36A to 36D).

For example, in a case where the Kind number is “20” and “TABLE 2” is selected, the main CPU 71 holds a lottery twenty times by using “TABLE 2” shown in FIG. 36C. In this example, the lottery level is “EXTRA”, and therefore it is determined that the number of games is “1” with a probability of “6/100”, that the number of games is “2” with a probability of “6/100”, that the number of games is “3” with a probability of “6/100”, that the number of games is “5” with a probability of “6/100”, that the number of games is “7” with a probability of 6/100, and that the number of games is “10” with a probability of “70/100”. In this example, therefore, the minimum number of games and the maximum number of games determined by the twenty lotteries are “20” and “200”, respectively.

After this processing, the main CPU 71 moves the processing to S146.

In S146, the main CPU 71 stores the determined number of games into a number-of-games storage area. More specifically, the main CPU 71 stores the number of games into the number-of-games storage area in association with identification information that enables identification of a region where the active feature symbol 503 was stopped. The main CPU 71 also stores the sum of the numbers of games (the total number of games) into the number-of-games storage area. After this processing, the main CPU 71 terminates the number-of-games lottery process.

(Jackpot Execution Process)

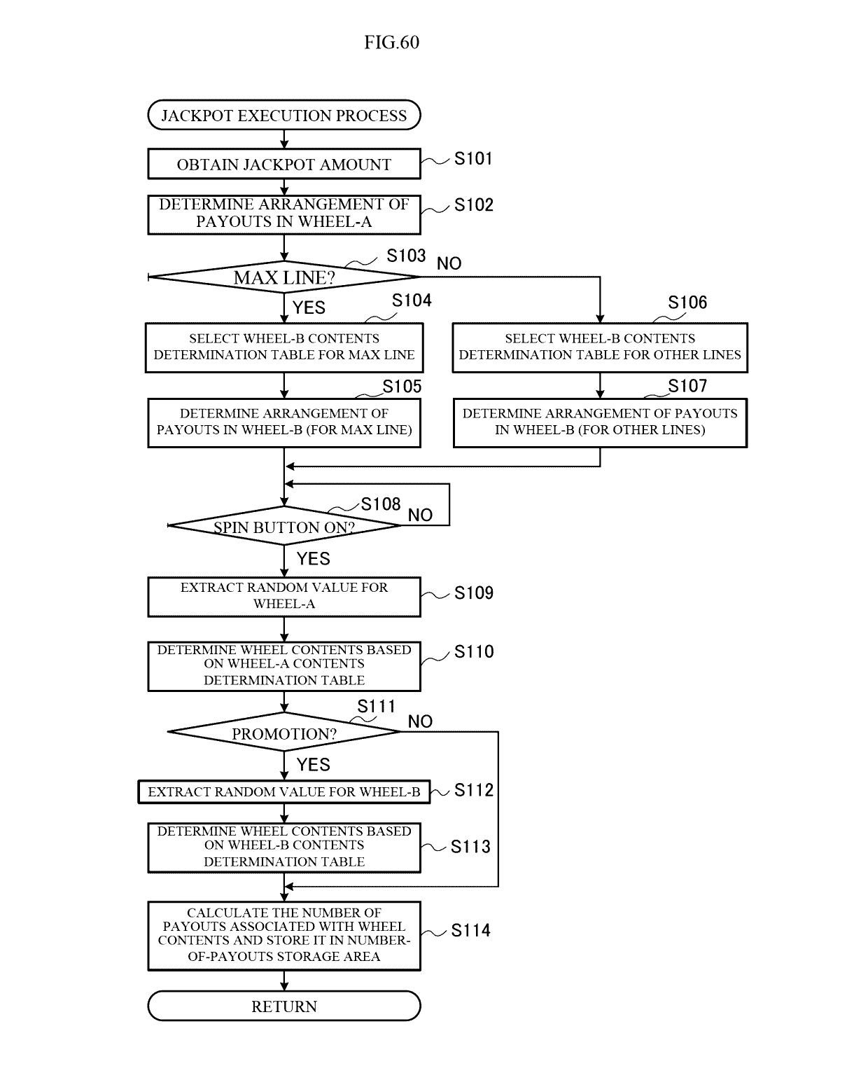

In the jackpot execution process, as shown in FIG. 60, the main CPU 71 firstly obtains the jackpot amount (S101). More specifically, in a case where the jackpot type is the stand-alone type, the main CPU 71 obtains the jackpot amount (credit value) from the accumulated amount storage area. In a case where the jackpot type is the link type (LINK), the main CPU 71 obtains the jackpot amount from the external controller 621. After this processing, the main CPU 71 moves the processing to S102.

In S102, the main CPU 71 determines a payout arrangement of the wheel-A. More specifically, the main CPU 71 determines payouts to be arranged in the wheel-A, based on the fixed payout setting table shown in FIG. 45. After this processing, the main CPU 71 moves the processing to S103.

In S103, the main CPU 71 determines whether or not the jackpot is triggered with the maximum number of activated paylines (MAX LINE). Upon determining that the jackpot is triggered with the maximum number of activated paylines (MAX LINE), the main CPU 71 moves the processing to S104, while upon determining that the jackpot is not triggered with the maximum number of activated paylines (MAX LINE), the main CPU 71 moves the processing to S106.

In S104, the main CPU 71 selects the wheel-B contents determination table (see FIG. 49). After this processing, the main CPU 71 moves the processing to S105.

In S105, the main CPU 71 determines a payout arrangement of the wheel-B. More specifically, the main CPU 71 determines payouts to be arranged in the wheel-B, based on the progressive payout setting table shown in FIG. 47. After this processing, the main CPU 71 moves the processing to S108.

In S106, the main CPU 71 selects the wheel-B contents determination table (see FIG. 50). After this processing, the main CPU 71 moves the processing to S107.

In S107, the main CPU 71 determines a payout arrangement of the wheel-B. More specifically, the main CPU 71 determines payouts to be arranged in the wheel-B, based on the progressive payout setting table shown in FIG. 48. After this processing, the main CPU 71 moves the processing to S108.

In S108, the main CPU 71 determines whether or not the spin button 46 is pressed (ON). In this processing, the main CPU 71 determines whether or not an input signal that is outputted from the spin switch 46S when the spin button 46 is pressed is received. Upon determining that the spin button 46 is pressed, the main CPU 71 moves the processing to S109, while upon determining that the spin button 46 is not pressed, the main CPU 71 moves the processing to S108.

In S109, the main CPU 71 extracts a random value for the wheel-A. After this processing, the main CPU 71 moves the processing to S110.

In S110, the main CPU 71 determines wheel contents based on the wheel-A contents determination table. More specifically, the main CPU 71 determines which of the payouts arranged in the wheel-A is to be awarded, based on the extracted random value and the wheel-A contents determination table shown in FIG. 46. After this processing, the main CPU 71 moves the processing to S111.

In S111, the main CPU 71 determines whether or not the determined wheel contents are promotion. More specifically, the main CPU 71 determines whether or not the determined payout is the fixed payout “0” (progressive payout). Upon determining that the determined wheel contents are promotion, the main CPU 71 moves the processing to S112, while upon determining that the determined wheel contents are not promotion, the main CPU 71 moves the processing to S114.

In S112, the main CPU 71 extracts a random value for the wheel-B. After this processing, the main CPU 71 moves the processing to S113.

In S113, the main CPU 71 determines wheel contents based on the wheel-B contents determination table. More specifically, the main CPU 71 determines which of the payouts arranged in the wheel-B is to be awarded, based on the extracted random value and the selected wheel-B contents determination table. After this processing, the main CPU 71 moves the processing to S114.

In S114, the main CPU 71 calculates the number of payouts associated with the wheel contents, and stores it into the number-of-payouts storage area. After this processing, the main CPU 71 terminates the jackpot execution process.

(Animation Data)

FIG. 61 shows an example of an animation determination table that defines identifiers for enabling identification of animation data.

The animation data include a normal individual-region animation, a winning individual-region animation, a continuous-region animation corresponding to two regions, a continuous-region animation corresponding to three regions, and a continuous-region animation corresponding to four regions, which are provided in association with each picture symbol 505. Although the animation data is stored in the ROM 72, the animation data may be stored in another storage device.

It is to be noted that the motion of a moving object of the winning individual-region animation is greater than that of the normal individual-region animation.

(How Mystery Symbols are Changed)

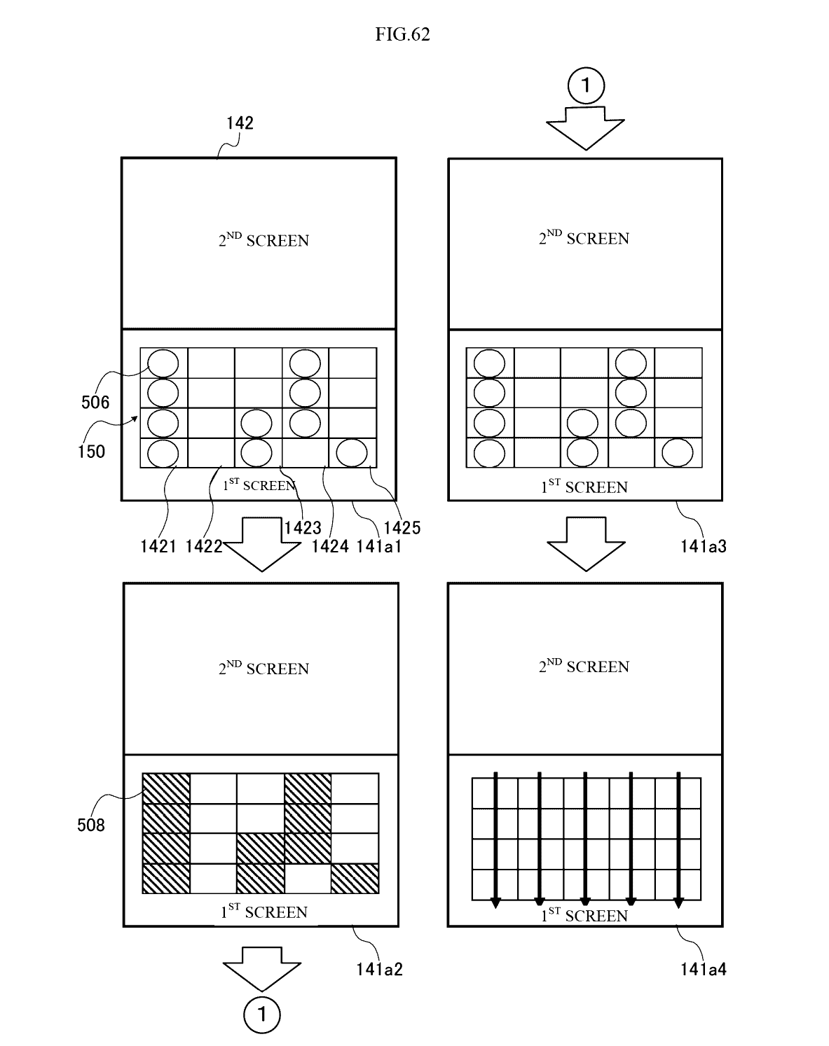

FIG. 62 shows an example of how the mystery symbols are changed. A lower image display panel 141a1 is illustrated as an example of the lower image display panel 141 on which four mystery symbols 506 are stopped in the first display column 1421, zero mystery symbol 506 is stopped in the second display column 1422, two mystery symbols 506 are stopped in the third display column 1423, three mystery symbols 506 are stopped in the fourth display column 1424, and one mystery symbol 506 is stopped in the fifth display column 1425.

After symbols are stopped in all of the display columns, all of the mystery symbols 506 are concurrently replaced with other symbols 508, as shown in a lower image display panel 141a2. At this time, an effect (symbol replacement effect) for replacing the mystery symbols 506 with other symbols 508 is produced. In this embodiment, the other symbols 508 are any of the normal symbols 502, the feature symbols 503, the wild symbols 504, and the picture symbols 505; but symbols of other types are also adoptable.

After the symbol replacement effect, a win determination and a win effect are executed. Then, at a time of starting next scrolling or a next start operation, the other symbols 508 having appeared as a result of the replacement return to the mystery symbols 506 (a lower image display panel 141a3). Then, next scrolling is started (a lower image display panel 141a4).

(How Animations are Changed)

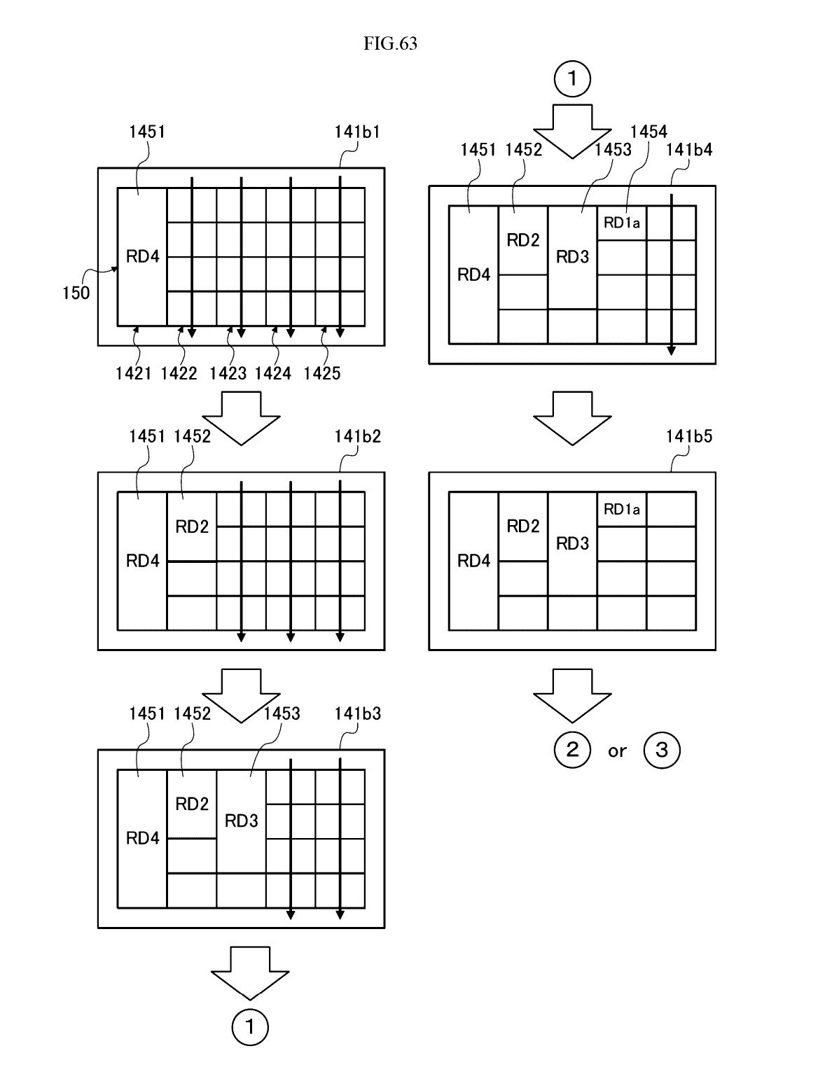

FIGS. 63 to 65 show an example of how animations are changed. If four picture symbols 505 (in this example, “RED”) are stopped in the first display column 1421, all the regions of the first display column 1421 are used to produce an effect (a continuous-region animation 1451 is generated in a region obtained by coupling the four display blocks 28) (a lower image display panel 141b1).

Then, if two picture symbols 505 are stopped in the second display column 1422, the regions of the second display column 1422 where the picture symbols 505 are successively stopped are used to produce an effect (a continuous-region animation 1452 is generated in a region obtained by coupling the two display blocks 28) (a lower image display panel 141b2).

Then, if three picture symbols 505 are stopped in the third display column 1423, the regions of the third display column 1423 where the picture symbols 505 are successively stopped are used to produce an effect (a continuous-region animation 1453 is generated in a region obtained by coupling the three display blocks 28) (a lower image display panel 141b3).

Then, if one picture symbol 505 is stopped in the fourth display column 1424, the region of the fourth display column 1424 where the picture symbol 505 is stopped is used to produce an effect (a normal individual-region animation 1454 is generated) (a lower image display panel 141b4).

Finally, if no picture symbol 505 is stopped in the fifth display column 1425, no animation is produced (a lower image display panel 141b5).

In the slot machine 10, as described above, an animation is generated each time the video reel is stopped. As an additional remark, it is to be noted that an animation is generated during both the normal game and the free game. In addition, an animation is started independently of the presence or absence of a win (winning). A mix of the picture symbols 505 and the wild symbols 504 is not considered as a succession of the picture symbols 505 (as identical symbols).

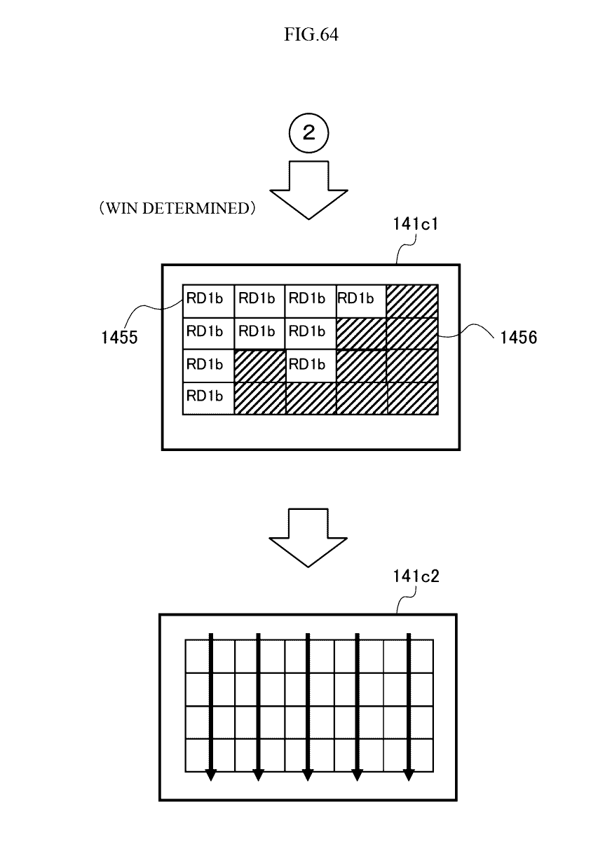

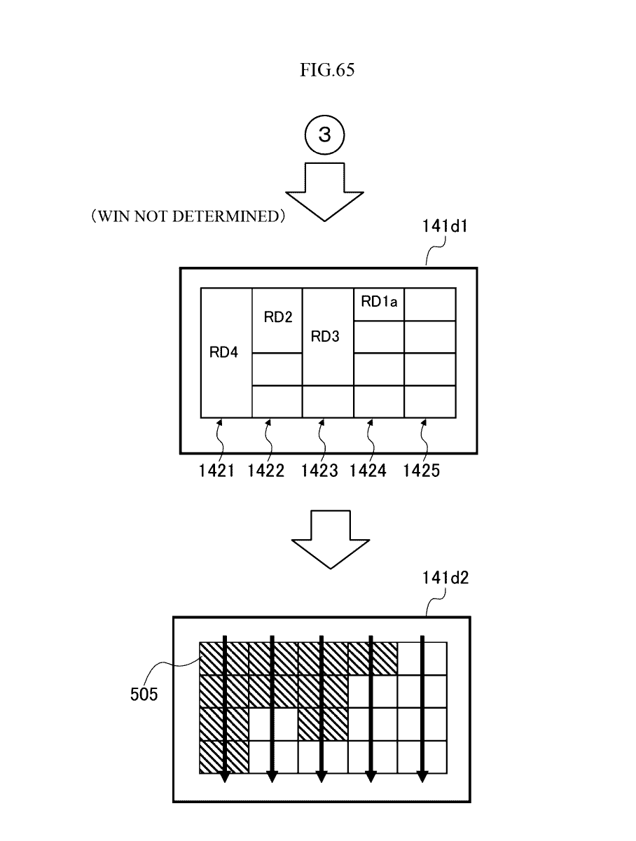

Then, a win determination is executed. If a win is determined, a state shown in FIG. 64 is created. If no win is determined, a state shown in FIG. 65 is created.

If a win is determined, the continuous-region animation is changed into winning individual-region animations 1455 (a lower image display panel 141c1). Any picture symbol 505 not related to the win is changed into a normal individual-region animation 1454. At this time, the symbols (regions) not related to the win are given hatching 1456.

Then, a win effect is produced, and next scrolling is executed (a lower image display panel 141c2). If a predetermined length of time (for example, sixty seconds from the start of increment of the number of payouts) has elapsed without a next start operation in the normal game, the hatching is terminated.

If no win is determined, the continuous-region animation is maintained until a next start operation is performed (a lower image display panel 141d1).

Then, at a time of starting scrolling, the continuous-region animation is terminated. The picture symbols 505 are once displayed, and scrolling is started (a lower image display panel 141d2).

(Win Effect)

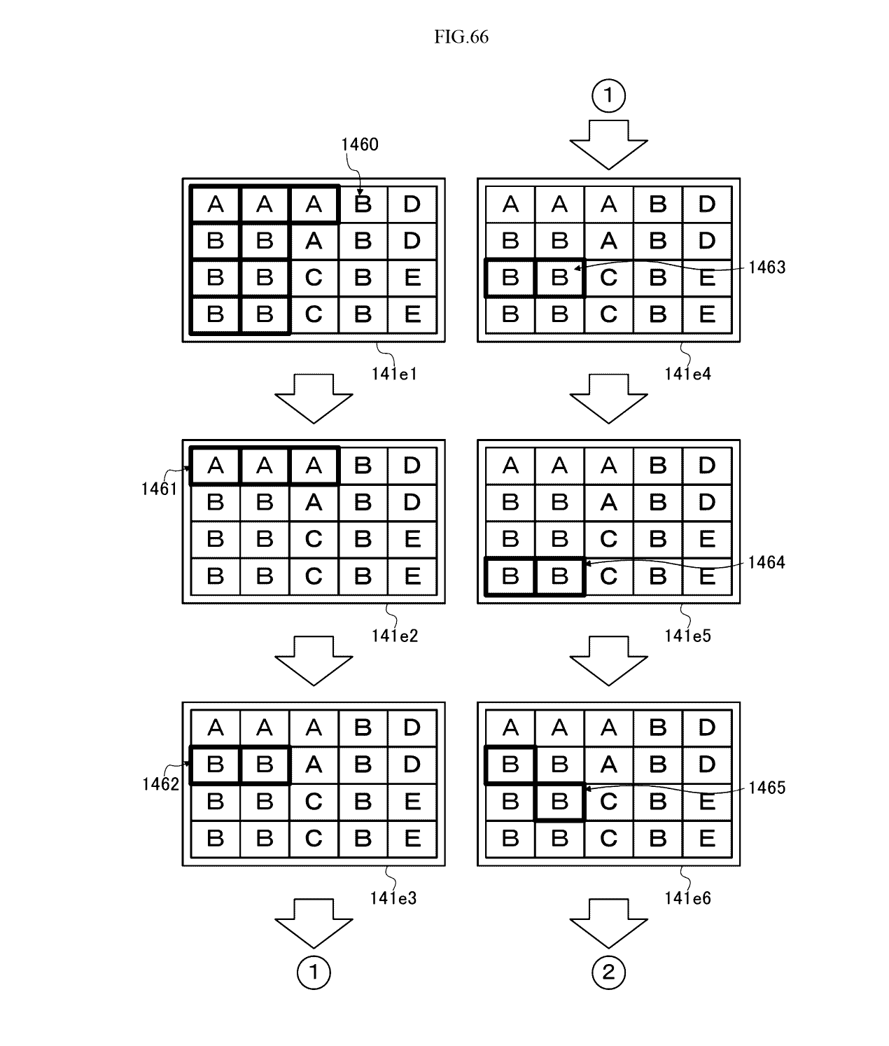

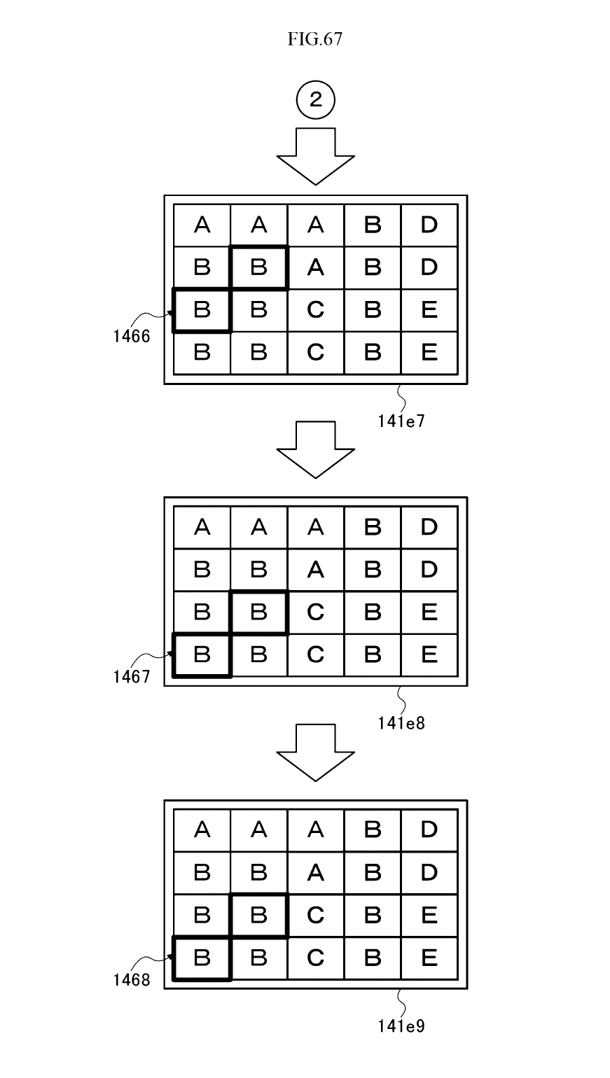

FIGS. 66 and 67 show an example of a win effect. The win effect is an effect for highlighting a winning combination (win line) upon occurrence of a win. In the slot machine 10, after stopping all of the video reels and before starting display of each winning combination, a for-all frame is displayed for all of the symbols related to the win individually for a first time duration (for example, one second). Then, a frame is displayed for each winning combination for second time duration (for example, 0.3 seconds) that is shorter than the first time duration. Any color is adoptable for the frame. For example, a plurality of colors (red, blue, yellow, pink, green, light blue) may be provided so that the color changes in the order of red→blue→yellow→pink→green→light blue→red→ . . . (looped).

In the following, an example case will be described in which the number of activated paylines is “20” and symbols are stopped in the form shown in FIG. 66.

In such a stopping form, firstly, an effect for enclosing in a frame each one of symbols related to the win is produced (a lower image display panel 141e1). At this time, symbols (regions) not related to the win are given hatching 1460.

Then, an effect in association with each winning combination is produced. More specifically, a frame 1461 for highlighting a winning combination of symbols “PINK”×3 on LINE1, a frame 1462 for highlighting a winning combination of symbols “GREEN”×2 on LINE2, a frame 1463 for highlighting a winning combination of symbols “GREEN”×2 on LINE3, a frame 1464 for highlighting a winning combination of symbols “GREEN”×2 on LINE4, a frame 1465 for highlighting a winning combination of symbols “GREEN”×2 on LINE6, a frame 1466 for highlighting a winning combination of symbols “GREEN”×2 on LINE7, a frame 1467 for highlighting a winning combination of symbols “GREEN”×2 on LINE8, and a frame 1468 for highlighting a winning combination of symbols “GREEN”×2 on LINE10, are sequentially displayed (lower image display panels 141e2 to 141e9).

In the slot machine 10, as described above, if a plurality of winning combinations are occurring, effects therefor are produced in ascending order of the line number. This configuration, however, is not limiting. For example, a configuration is adoptable in which effects are produced in descending order of the number of payouts.

While the effects associated with the respective winning combinations are in production, the animations for the picture symbols 505 are maintained. The reproduction of the effects associated with the respective winning combinations are looped until a next start operation is started.

(Number-of-Games Determination Effect)

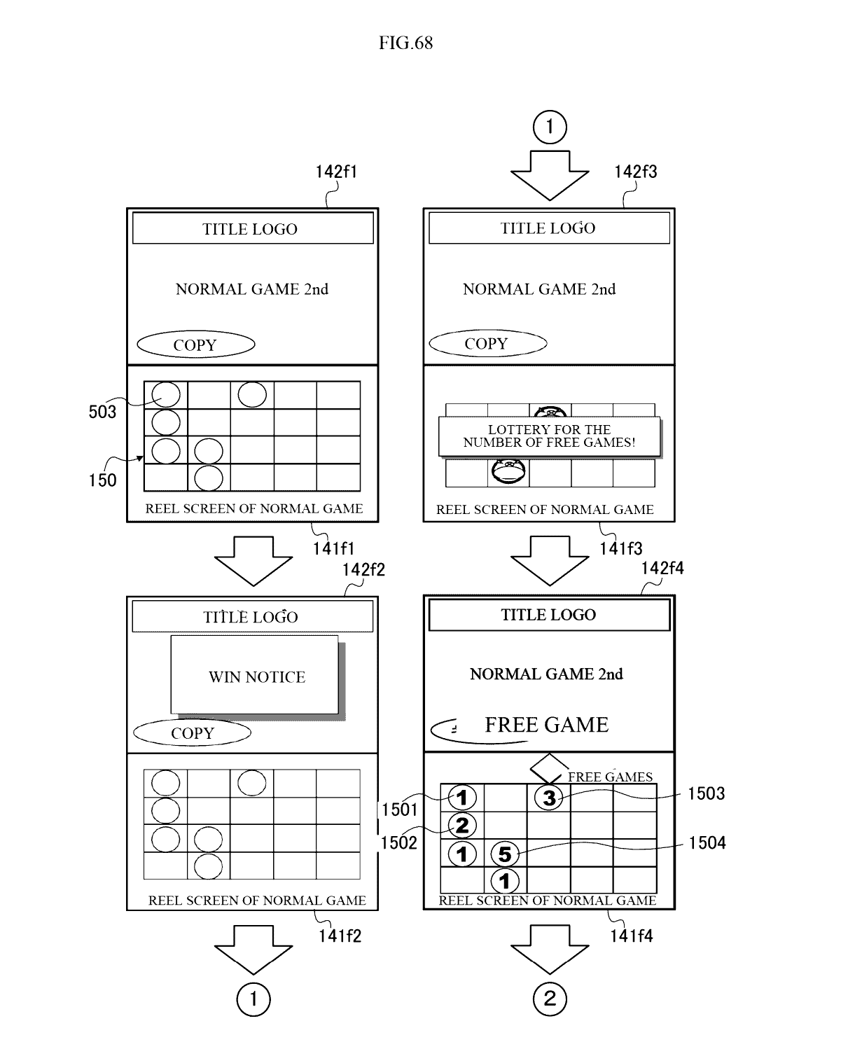

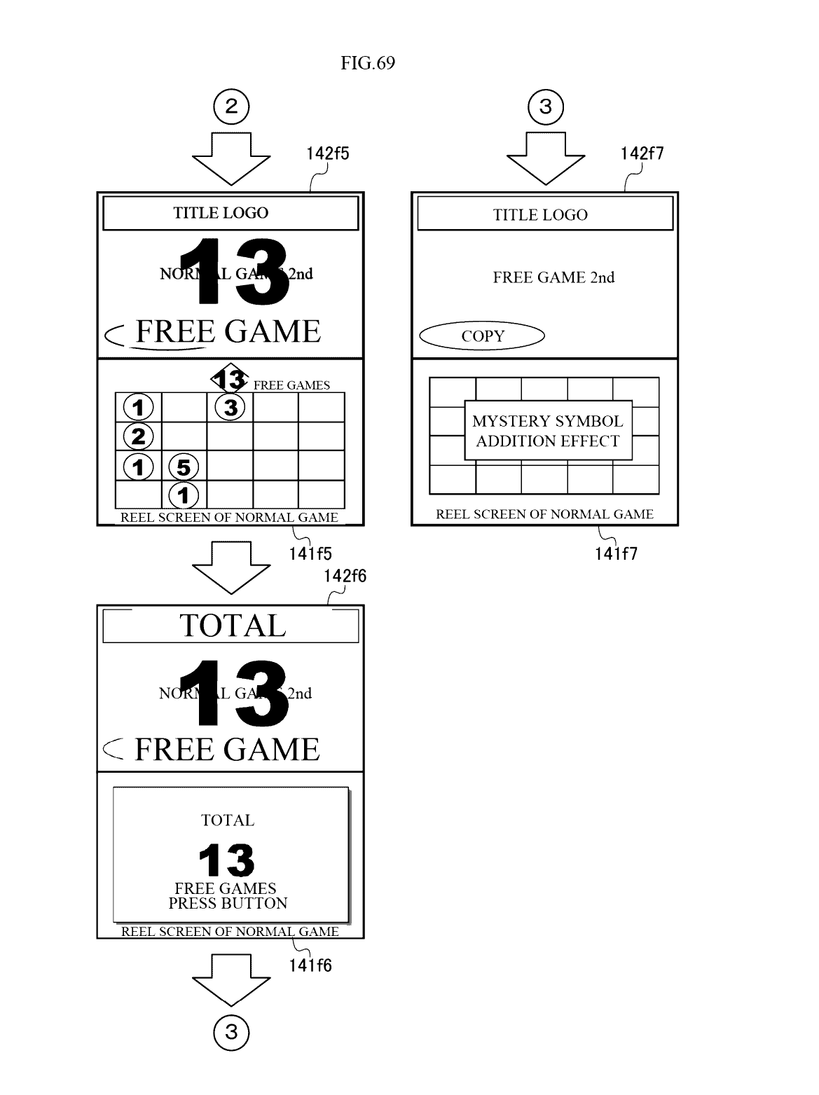

FIGS. 68 and 69 show an example of a number-of-games determination effect. If at least one feature symbol 503 is stopped in each of the first, second, and third display columns during the normal game, the free game is awarded. In a case where the free game is obtained, a lottery (lottery effect) for determining the number of obtainable games is held for each of the feature symbols 503 (active feature symbol 503) associated with triggering.

The number of games obtainable from one active feature symbol 503 is any of one, two, three, five, seven, and ten. The number of games obtainable from one active feature symbol 503, however, is not limited to the aforesaid values. Any appropriate value is adoptable. After the lotteries for determining the number of games are held with respect to all the active feature symbols 503, the number of games is fixed, to make the free game runnable.

Referring a lower image display panel 141f1, upon triggering of the free game, a beep sound is outputted, and a win notice is displayed as shown in a middle image display panel 142f2, in which a win increment is caused. Then, as shown in a lower image display panel 141f3, the introduction message “Lottery for the Number of Free Games!” is displayed, and a lottery for the number of games is started.

Lotteries are simultaneously (substantially simultaneously) held for the active feature symbols 503. In a lower image display panel 141f4, the active feature symbol 503 are highlighted, and the respective numbers of games are displayed (a display 1501 indicating that the number of games is “1”, a display 1502 indicating that the number of games is “2”, a display 1503 indicating that the number of games is “3”, and a display 1504 indicating that the number of games is “5” are displayed) in regions where the respective active feature symbols 503 are stopped. The highlighting may be implemented in any appropriate form, such as enclosing the feature symbol 503 in a frame or contrasting between light and dark.

After the lotteries for the number of games are held with respect to all of the active feature symbols 503, the number of games is incremented and the total number of games is displayed in a middle image display panel 142f5 and a lower image display panel 141f5. Then, a feature notice is displayed in a lower image display panel 141f6. At this time, the state is in a waiting state in which a start operation is waited. Then, the processing moves to a mystery symbol addition effect.

(Mystery Symbol Addition Effect)

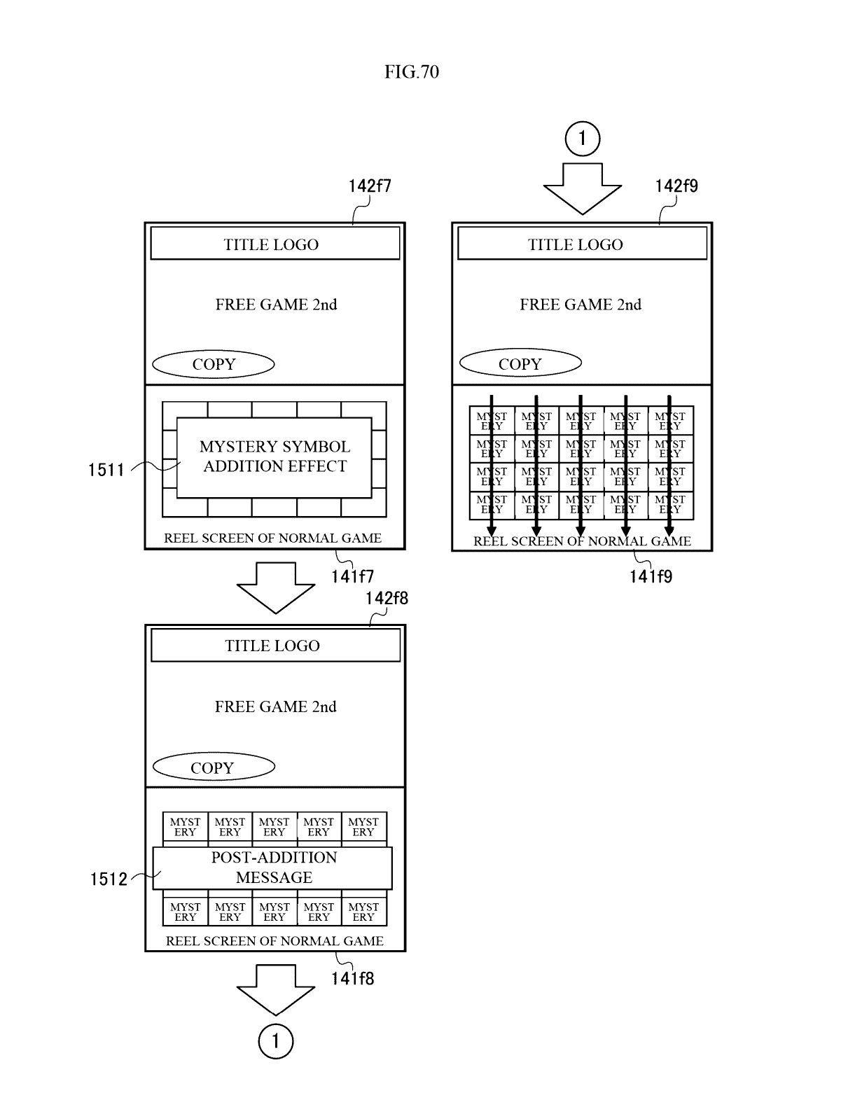

FIG. 70 shows an example of the mystery symbol addition effect. After a mystery symbol addition effect 1511 is produced, mystery symbols 506 are stopped in all of the display blocks 28 (all of the positions) of the symbol display area 150, and a post-addition message 1512 is displayed. The post-addition message 1512 shows the number of added mystery symbols 506 (in this example, fifty).

For example, after the post-addition message 1512 is displayed for a predetermined time period (e.g., two seconds), a first game of the free game is started as shown in a lower image display panel 141f9.

(Jackpot Effect)

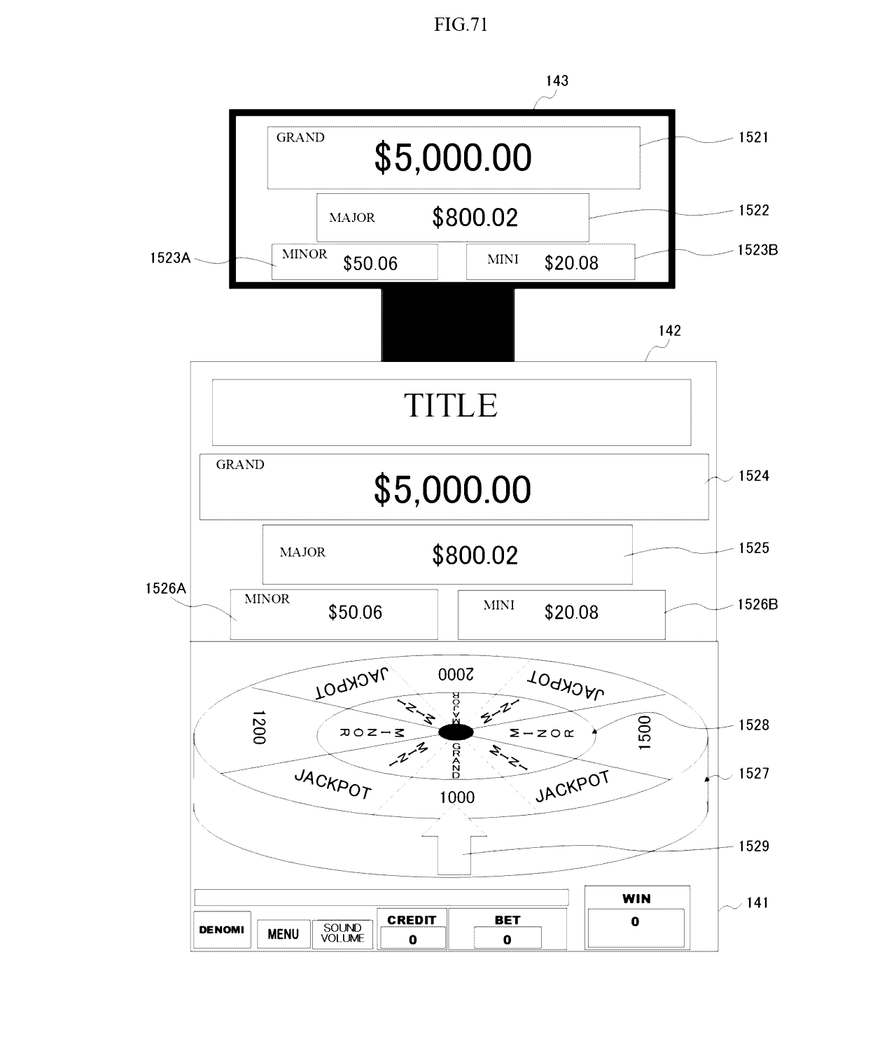

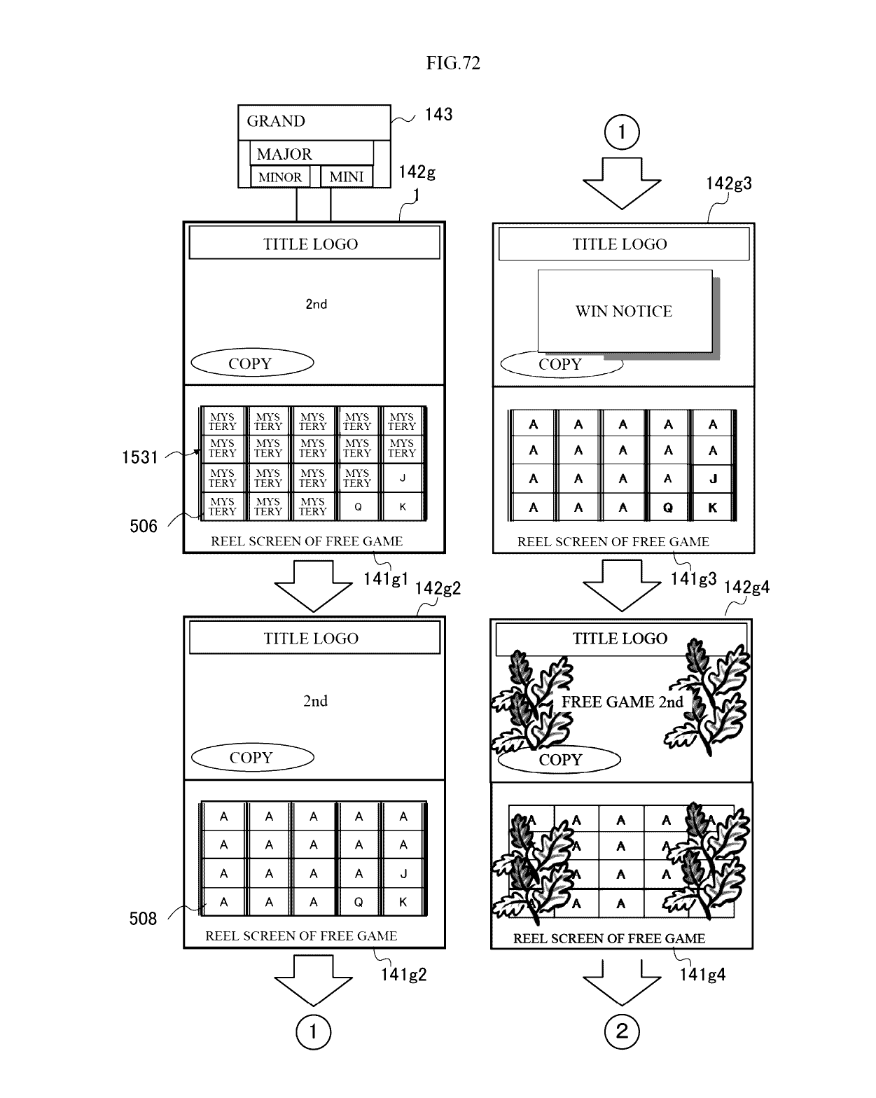

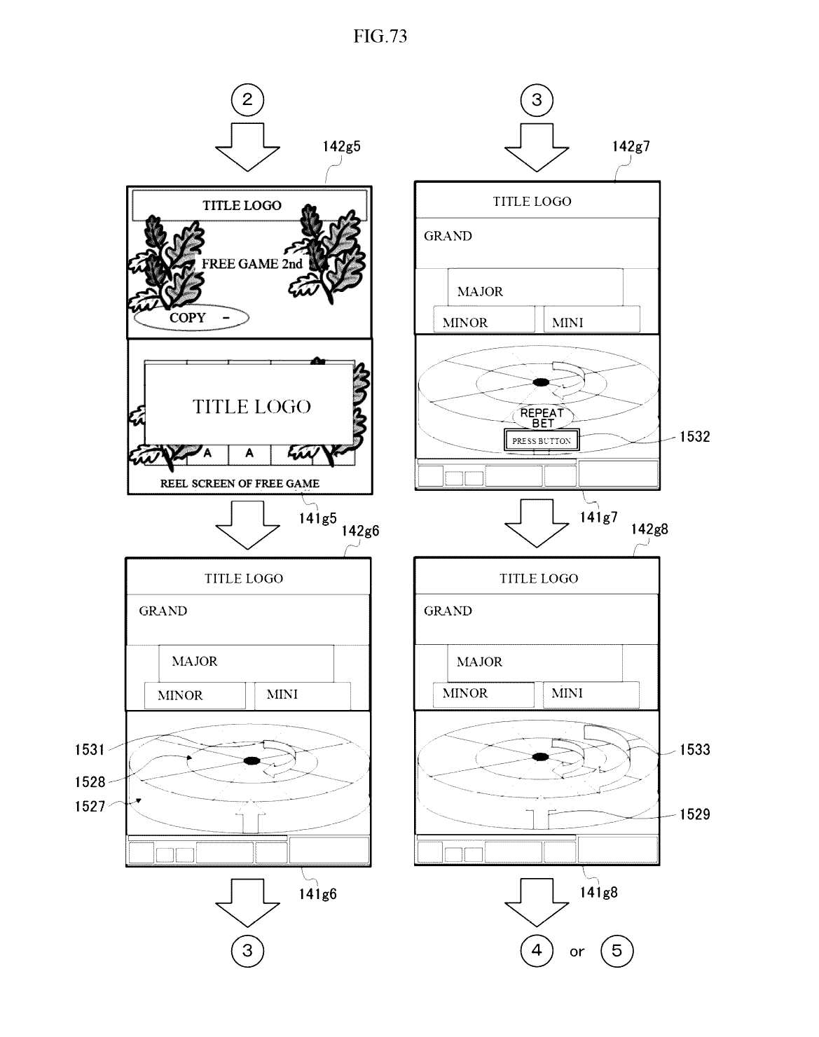

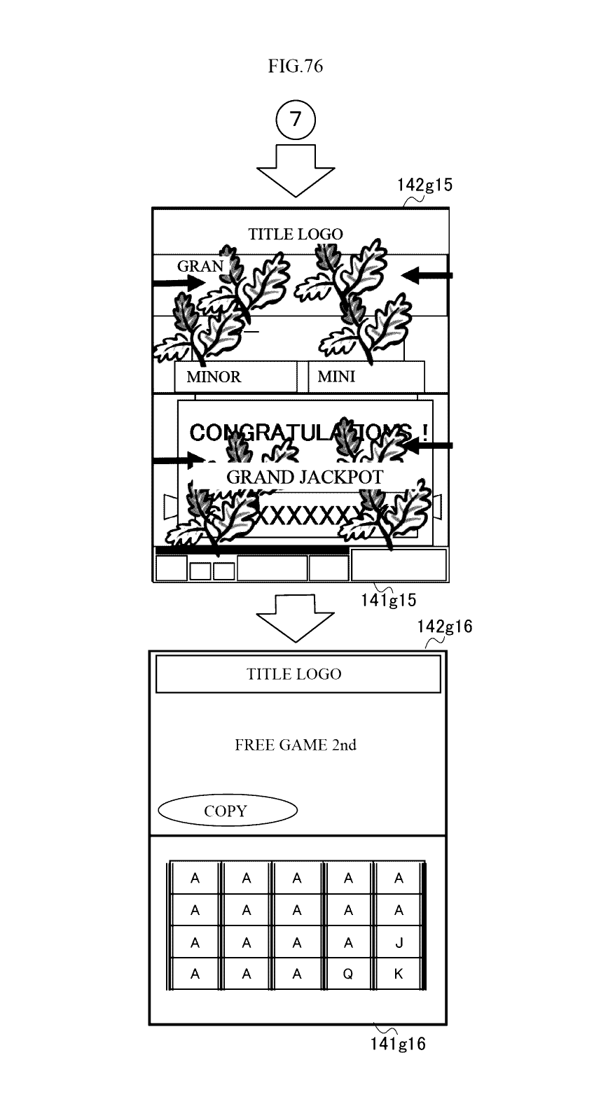

FIG. 71 shows an exemplary configuration of a screen for a jackpot effect. FIGS. 72 to 76 shows an example of the jackpot effect.

The upper image display panel 143 is configured to display a jackpot payout (progressive amount of money).

More specifically, the upper image display panel 143 includes jackpot payout display areas 1521 to 1523A, 1523B, which display jackpot payouts associated with the respective progressive levels.

The jackpot payout display area 1521 is an area (first area) for displaying a first jackpot payout. The jackpot payout display area 1521 has the largest size among the jackpot payout display areas 1521 to 1523A, 1523B. The jackpot payout display area 1521 displays “$5,000.00”, for example.

The jackpot payout display area 1522 is an area (second area) for displaying a second jackpot payout that is a payout smaller than the first jackpot payout. The size of the jackpot payout display area 1522 is smaller than that of the first area. The jackpot payout display area 1522 displays “$800.02”, for example.

The jackpot payout display area 1523A is an area (third area) for displaying a third jackpot payout that is a payout smaller than the second jackpot payout. The size of the jackpot payout display area 1523A is smaller than that of the second area. The jackpot payout display area 1523A displays “$50.06”, for example.

The jackpot payout display area 1523B is an area (fourth area) for displaying a fourth jackpot payout that is a payout smaller than the third jackpot payout. The size of the jackpot payout display area 1523B is the same as that of the third area. The jackpot payout display area 1523B displays “$20.08”, for example.

When the progressive function is ON, the jackpot payout is displayed in the upper image display panel 143.

Configurations of the jackpot payout display areas 1521 to 1523A, 1523B are not limited to the above-described ones. In a conceivable example, the jackpot payout may be undisplayed or “?” may be displayed in the jackpot payout display area 1521. In another conceivable example, the jackpot payout display area 1521 may be omitted. The same is true for the jackpot payout display areas 1522, 1523A, and 1523B.

The middle image display panel 142 is configured to display a jackpot payout (progressive amount of money). Like the upper image display panel 143, the middle image display panel 142 includes jackpot payout display areas 1524 to 1526A, 1526B, which display jackpot payouts associated with the respective progressive levels. In the middle image display panel 142, a jackpot payout is displayed during execution of a jackpot.

The lower image display panel 141 is configured to display a lottery effect associated with a jackpot payout.

More specifically, the lower image display panel 141 includes a wheel-A 1527, a wheel-B 1528, and a wheel contents fixer 1529. The wheel-B 1528 is provided inside the wheel-A 1527.

The wheel-A 1527 has eight frames (windows). Each of the frames displays wheel contents. For example, the respective frames of the wheel-A 1527 display “1000”, “JACKPOT”, “1500”, “JACKPOT”, “2000”, “JACKPOT”, “1200”, and “JACKPOT”, based on FIG. 45.

The wheel-B 1528 has eight frames (windows). Each of the frames displays wheel contents. For example, the respective frames of the wheel-B 1528 display wheel contents based on either of FIG. 47 and FIG. 48. In this example, FIG. 47 is employed, so that “GRAND”, “MINI”, “MINOR”, “MINI”, “MAJOR”, “MINI”, “MINOR”, and “MINI” are displayed.

Next, the jackpot effect will be described based on FIGS. 72 to 76 as an example.

In the slot machine 10, a jackpot is triggered upon stopping of JP symbols 1531 in all of the display blocks 28 of the symbol display area 150 (lower image display panel 141g1). At this time, a sound is produced. The sound is different from the sound produced when the free game is triggered.

On the symbol display area 150, it appears as if the JP symbols 1531 and other symbols were simultaneously rotating, but separate video reels (the video reels A and the video reels B) at a base layer and a top layer are rotating. The video reels A and the video reels B, which have a double-layered configuration, are simultaneously stopped. Since the video reels A and the video reels B are different in the length of a video reel strip, symbols appear at different timings even though the video reels are rotated for a long time. The slot machine 10 is configured such that the JP symbols 1531 are highlighted by right and left frames, because the continuous-region animation (the symbol frame expansion effect) can be produced. Displaying of the JP symbols 1531 occurs over displaying of the display blocks 28 (frames of the video reels).

If mystery symbols 506 have been stopped when the jackpot is triggered, the mystery symbols 506 are replaced with other symbols 508 (a lower image display panel 141g2), and the win effect is produced (a lower image display panel 141g3). The number of payouts (the number of credits) obtained is displayed in a win notice or the like. Then, the screen is switched one after another so as to clearly show that the jackpot is starting (e.g., a middle image display panel 142g4 and a lower image display panel 141g4, a middle image display panel 142g5 and a lower image display panel 141g5).

Then, as shown in a lower image display panel 141g6, the wheel-A 1527 and the wheel-B 1528 are displayed. At this time, the wheel-B 1528 is slowly rotating (at a first speed) in the direction indicated by an arrow 1531 which represents the direction of rotation of the wheel-B 1528. It is to be noted that the arrow 1531 is illustrated for convenience of description and actually not displayed on the screen.

Then, as shown in a lower image display panel 141g7, a message “SPIN THE WHEEL” (not shown) for prompting rotation of the wheel-A 1527 and an operation instruction 1532 are displayed.

In response to pressing of the spin button 46, a lottery for wheel contents is held in association with the wheel-A 1527. The wheel-A 1527 rotates fast (for example, at a second speed higher than the first speed) in the direction indicated by an arrow 1533 which represents the direction of rotation of the wheel-A 1527 (a lower image display panel 141g8). It is to be noted that the arrow 1533 is illustrated for convenience of description and actually not displayed on the screen. The second speed may be either variable or fixed. For example, a configuration is adoptable in which the second speed gradually increases, and upon reaching a certain speed, gradually decreases.

Then, based on a lottery result, the wheel-A 1527 is stopped, and wheel contents (a fixed payout or a right to advance to the next wheel) indicated by the wheel contents fixer 1529 along with stopping of the wheel-A 1527 are awarded. At this time, highlighting is applied to the wheel contents indicated by the wheel contents fixer 1529.

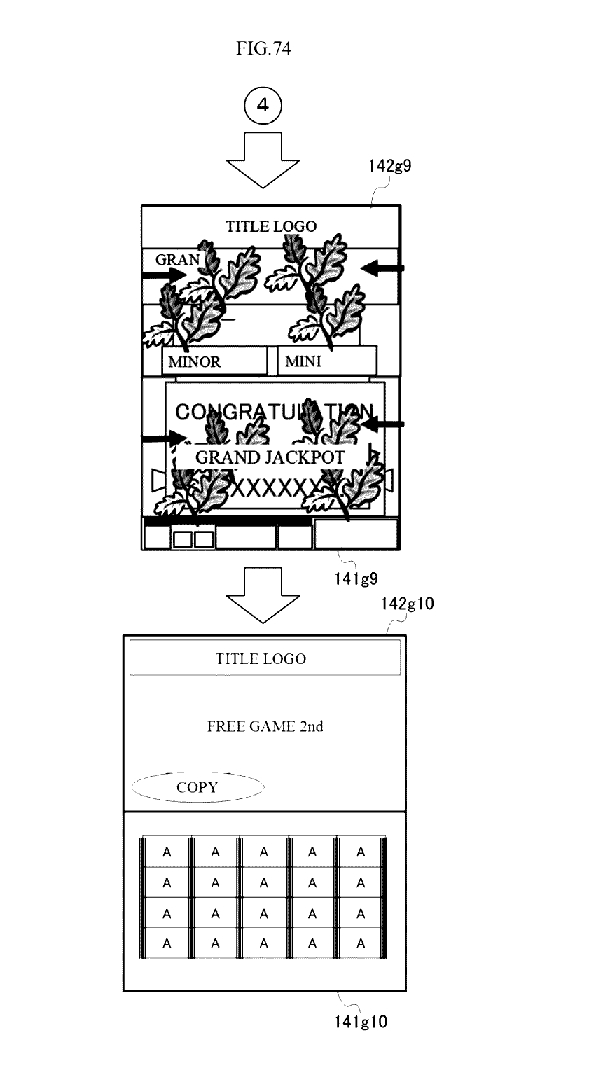

When the fixed payout is obtained, the screen is switched one after another so as to clearly show that the jackpot is ending (e.g., a middle image display panel 142g9 and a lower image display panel 141g9), as shown in FIG. 74. The, the screen returns to the one that was displayed prior to the execution of the jackpot (a middle image display panel 142g10 and a lower image display panel 141g10).

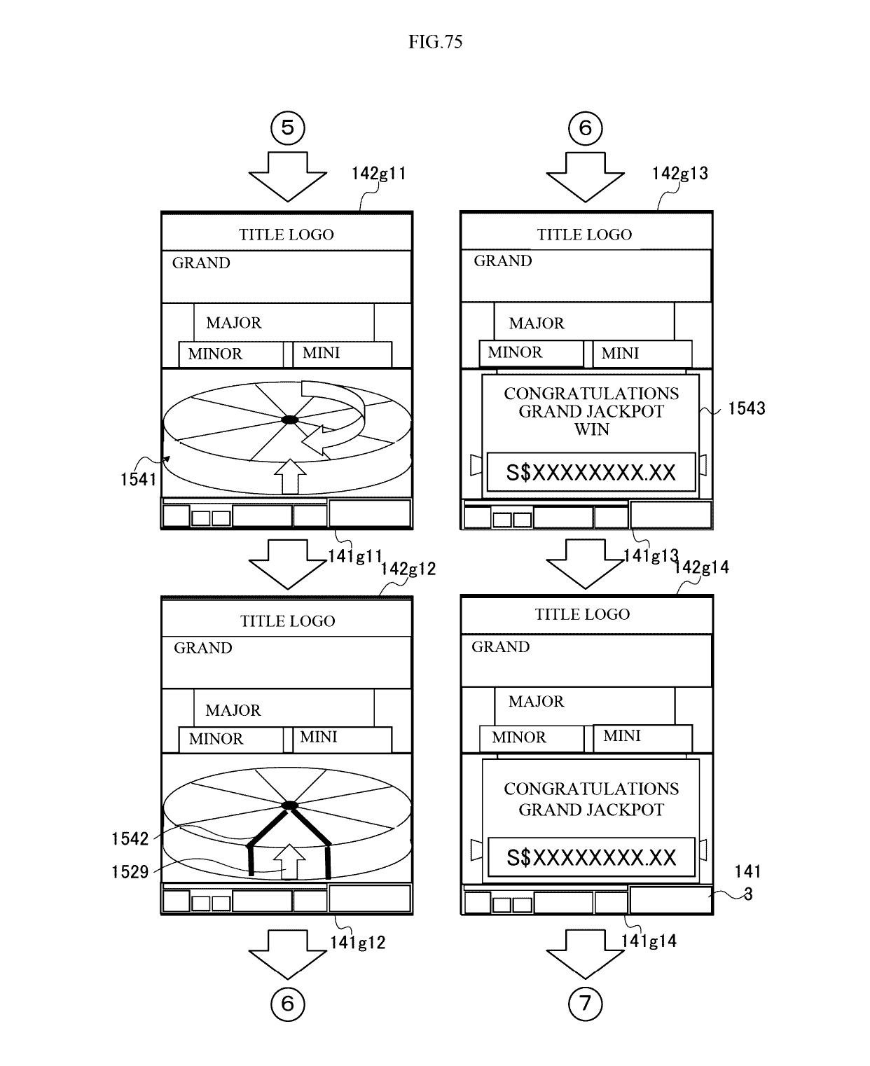

When the right to advance to the next wheel is obtained, the wheel-A 1527 is vanished and a wheel-B 1541, which is an enlarged version of the wheel-B 1528, is displayed (a lower image display panel 141g11), as shown in FIG. 75. A lottery for wheel contents is held in association with the wheel-B 1541 (wheel-B 1528).

Then, based on a lottery result, the wheel-B 1541 is stopped (a lower image display panel 141g12), and wheel contents (a jackpot payout) indicated by the wheel contents fixer 1529 along with stopping of the wheel-B 1541 are awarded. At this time, highlighting 1542 is applied to the wheel contents indicated by the wheel contents fixer 1529.

After the jackpot payout is fixed, a payout display area 1543 is displayed as shown in a lower image display panel 141g13. In a case where the obtained jackpot payout is “GRAND” or “MAJOR”, the payout display area 1543 is displayed for ten seconds, while in a case where the obtained jackpot payout is “MINOR” or “MINI”, the payout display area 1543 is displayed for six seconds. In the payout display area 1543, the jackpot payout is incremented (a lower image display panel 141g14). At this time, the jackpot payout is incremented in the WIN meter indicator 1413, too.

After elapse of a predetermined length of time (e.g., three seconds) from the end of the incrementation, the screen is switched one after another so as to clearly show that the jackpot is ending (a middle image display panel 142g15 and a lower image display panel 141g15). Then, the screen returns to the predetermined one that was displayed prior to the execution of the jackpot (e.g., a middle image display panel 142g16 and a lower image display panel 141g16).

(Example of Screen Display)

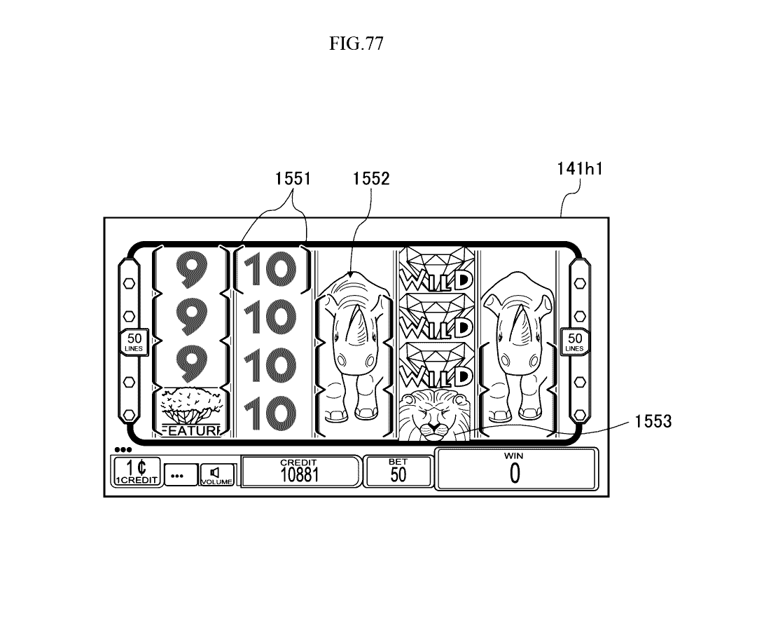

FIGS. 77 to 79 show an example of a specific embodiment of the slot machine 10.

FIG. 77 shows an exemplary screen display (a lower image display panel 141h1) of the lower image display panel 141 in the normal game.

A symbol 1551 is an example of the JP symbol 507. The symbol 1551 has a symbol design of brackets. This, however, is not limiting. Examples of the form of the brackets include round brackets, corner brackets, white corner brackets, square brackets, curly brackets, tortoise shell brackets, angle brackets, and black lenticular brackets. Alternatively, for example, a symbol design may be in the form of line segments (e.g., dotted lines, broken lines, solid lines, double-bar lines, lines that appear as if the inside is depressed, lines that appear as if the inside is floating, hatched lines, wavy lines, zigzag lines) instead of brackets.

As an additional remark, it is to be noted that the JP symbol 1551 is configured such that its symbol design is provided on the right and left sides. The video reels B having the JP symbols 1551 are provided in a more frontward position than the video reels A having other symbols. Therefore, the symbols arranged in the video reels A are visible while the JP symbols 1551 arranged in the video reels B are also visible. Even when animations are produced for the symbols arranged in the video reels A, the visibility of the animations are not disturbed (deteriorated) by the JP symbols 1551. Furthermore, even when a continuous-region animation is produced, the visibility of the animation is not disturbed by the JP symbols 1551.

The JP symbol 1551 may not necessarily be configured such that its symbol design is provided on the right and left sides. For example, the symbol design may be provided on either one of the right and left sides.

The video reels B may not necessarily be provided in a more frontward position than the video reels A. In a possible example, the video reels B may have a larger width than that of the video reels A. In another possible example, the video reel B may include two video reels, each of which is provided on each side of the video reel A.

An animation 1552 is an example of the continuous-region animation. An animation 1553 is an example of an individual-region animation.

The animation 1552 and the animation 1553 show an exemplary display provided at an arbitrary timing. For example, an object (in this example, a rhinoceros) expressed by the animation 1552 and an object (in this example, a lion) expressed by the animation 1553 are displayed such that their appropriate parts (e.g., eyes, mouth, ears, face, body, etc.) are moving at appropriate timings.

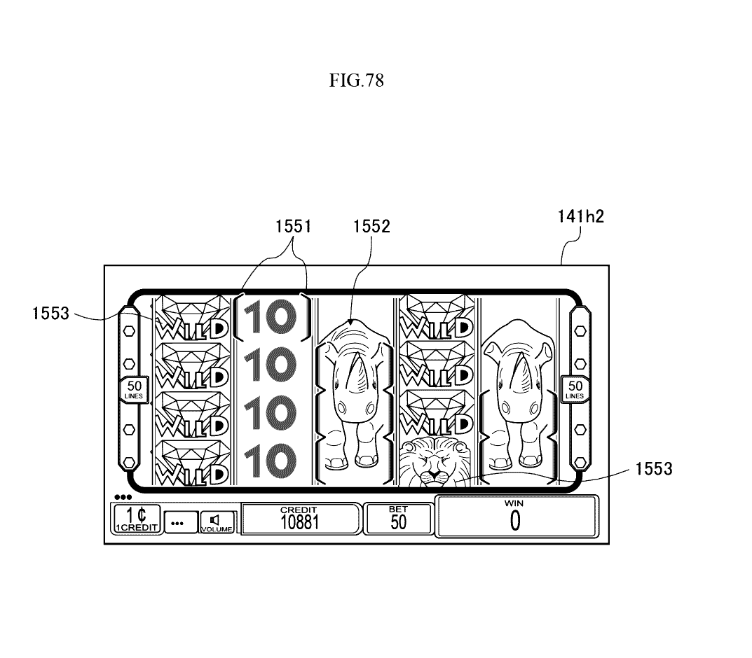

FIG. 78 shows an example of the screen display of the lower image display panel 141 (a lower image display panel 141h2) in the normal game.

The lower image display panel 141h2 is an exemplary screen display obtained when four mystery symbols 506, which were successively stopped in the first display column 1421, are concurrently replaced with the wild symbols 504.

In a case where a wild symbol 504 is provided in the firstly-stopped video reel (first video reel), a large number of payouts is expected. The player, therefore, desires such a slot machine that a plurality of wild symbols 504 can be successively stopped.

If, for example, a plurality of wild symbols 504 are arranged in the first video reel, a large number of payouts can be awarded. This may undesirably cause an imbalance between a player's benefit and a game store's benefit. Moreover, if, for example, a plurality of wild symbols 504 are successively arranged in the first video reel, a further imbalance may occur between the player's benefit and the game store's benefit.

In this respect, the slot machine 10 adopts a configuration in which a plurality of wild symbols 504 can be successively stopped. This configuration is implemented not by providing the wild symbol 504 in the first video reel but by providing the mystery symbol 506 in the first video reel. The mystery symbol 506 can be replaced with a symbol different from the wild symbol 504, for example. This enables a balance between the player's benefit and the game store's benefit to be maintained appropriately by adjusting the probability (weighting) of replacement with the wild symbol 504.

Accordingly, this configuration is able to provide a slot machine that creates an expectation that a plurality of wild symbols 504 may be successively stopped in the first video reel, while maintaining a balance between the player's benefit and the game store′ benefit.

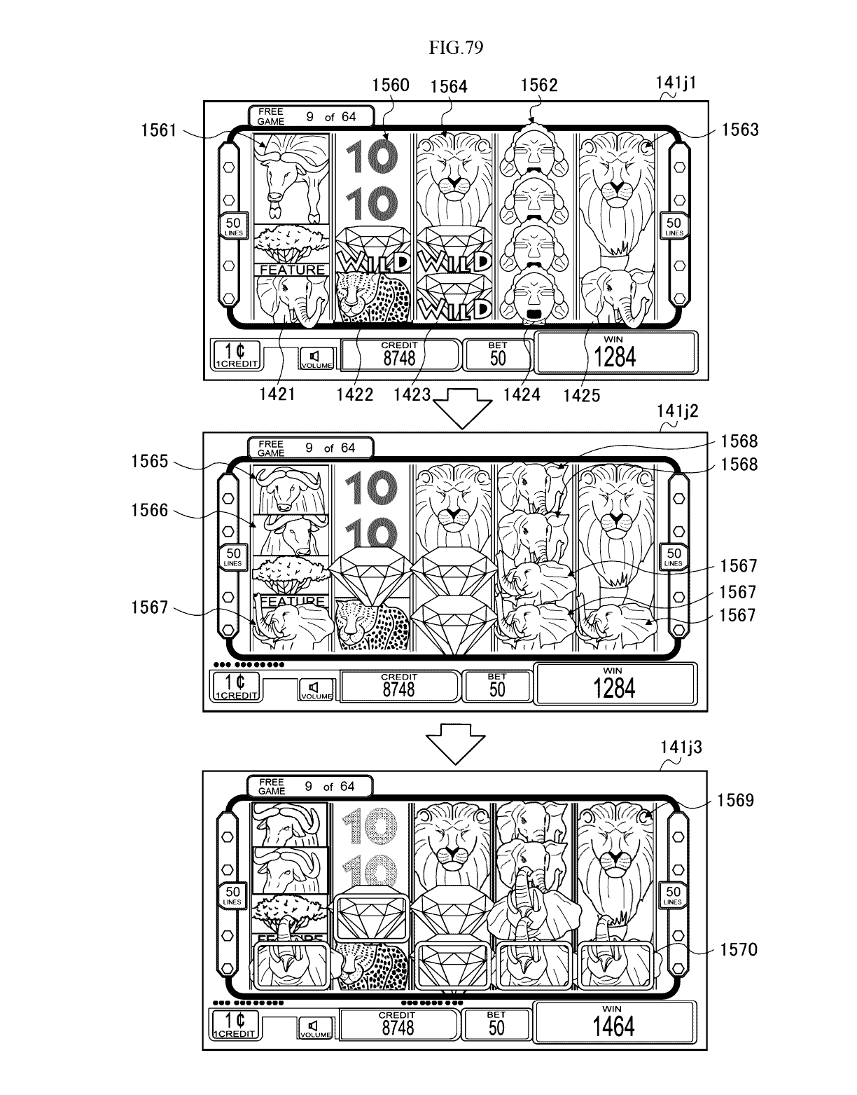

FIG. 79 shows an example of the screen display (lower image display panels 141j1 to 141j3) of the lower image display panel 141 in the free game.

The lower image display panel 141j 1 is an exemplary display screen obtained when all the video reels are stopped (before the symbol replacing process).

In the first display column 1421 where two picture symbols 505 expressing “buffalo” are successively stopped, a continuous-region animation 1561 corresponding to two regions is produced.

In the second display column 1422 where two normal symbols 1560 are successively stopped, no animation is produced because they are not picture symbols 505.

In the third display column 1423 where two picture symbols 505 are successively stopped, a continuous-region animation 1564 corresponding to two regions is produced.

In the fourth display column 1424 where four mystery symbols 1562 are successively stopped, no animation is produced because they are not picture symbols 505.

In the fifth display column 1425 where three picture symbols 505 are successively stopped, a continuous-region animation 1563 corresponding to three regions is produced.

As a result of execution of the symbol display control process, a screen as shown in the lower image display panel 141j2 is displayed. The following description illustrates an example case in which each mystery symbol 1562 is replaced with a picture symbol expressing “elephant”, so that a winning combination of “buffalo” and a winning combination of “elephant” are determined as a result of the symbol display control process.

In the first display column 1421, the continuous-region animation 1561 corresponding to two regions is changed into an individual-region animation. More specifically, the picture symbol of “buffalo” in the first stage is a symbol not involved in a winning combination, and therefore a normal individual-region animation is produced. The picture symbol of “buffalo” in the second stage is a symbol involved in a winning combination, and therefore a winning individual-region animation is produced. In the first display column 1421, moreover, an animation for the picture symbol of “elephant” in the fourth stage is changed from a normal animation into a winning animation.

In the fourth display column 1424, the symbols of “elephant” in the first and second stages are symbols not involved in winning, and therefore normal individual-region animations 1568 are produced in the first and second stages. The symbols of “elephant” in the third and fourth stages are symbols involved in winning, and therefore winning individual-region animations 1567 are produced in the third and fourth stages.

In the fifth display column 1425, an animation for the picture symbol of “elephant” in the fourth stage is changed from a normal animation into a winning animation.

The winning animations 1567 move in similar (synchronized) motions.

Then, as shown in the lower image display panel 141j3, symbols (regions) not forming a winning combination are given hatching 1569, and symbols forming a winning combination is given highlight 1570.

The lower image display panels 141j 1 to 141j3 are configured to display the total number of games obtained in the free game and the current number of games. The indication of “9 of 64” illustrated in this example represents that the number of awarded games is “64” and the current game is the ninth game. This can inform the player that the free game is progressing one by one.

(Example of Screen Display: Signage)

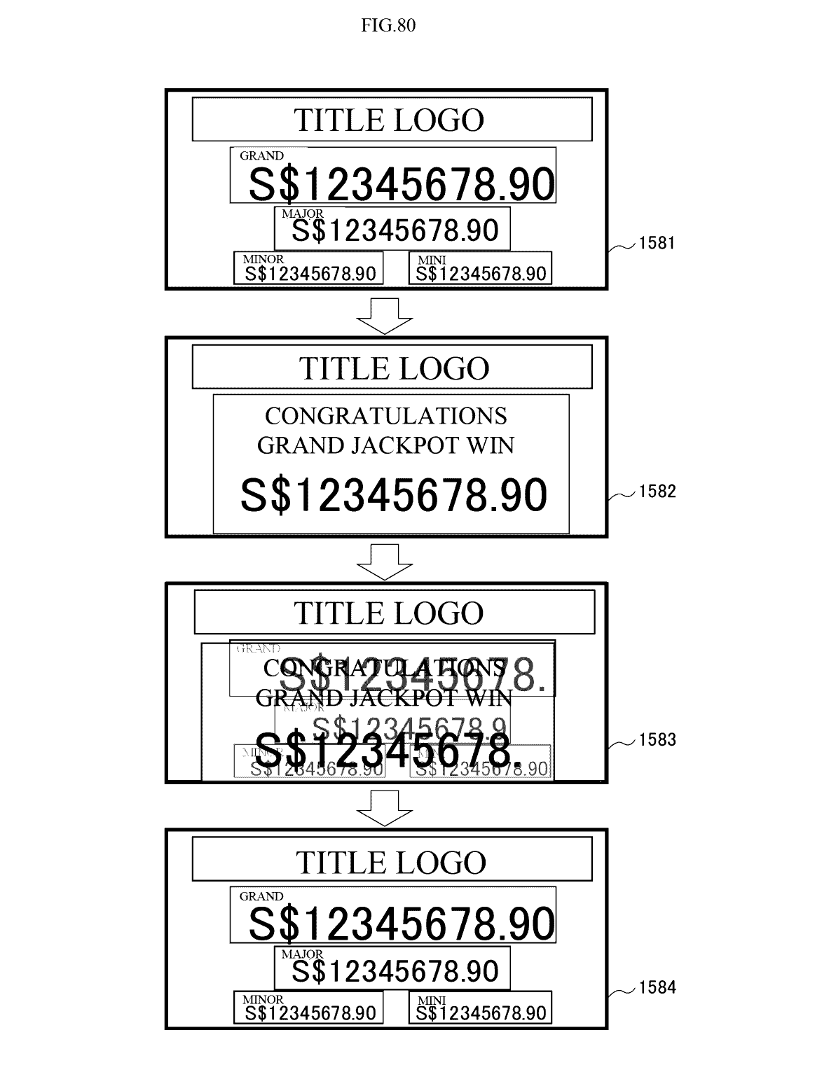

FIG. 80 shows an example (exemplary screen displays 1581 to 1584 of the LCD of the signage 760) according to a specific embodiment of the signage 760. A description of the signage 760 will be given based on an example case in which the progressive function is set ON and LINK type is designated.

The signage 760 shares and displays all of the linked progressives (the exemplary screen display 1581). If any jackpot payout (progressive) is obtained, the signage 760 displays a notice of the obtaining (the exemplary screen display 1582). After elapse of a predetermined length of display time (for example, ten seconds for “GRAND” and “MAJOR”, and six seconds for “MINOR” and “MINI”), the notice gradually disappears (the exemplary screen display 1583). Here, it is to be noted that incrementation of the payout, etc. is not displayed in the signage 760. Then, the obtained jackpot payout is reset, and the screen returns to the normal screen (the exemplary screen display 1584).

In a case where a plurality of players simultaneously win, and in other words, in a case where a jackpot is won simultaneously by a plurality of machines, an effect is produced sequentially from the one having the earliest communication.

In a case where another player wins the jackpot during a jackpot effect, the effect is terminated, then the screen once returns to the normal screen, and then the next effect is started.

### Second Embodiment

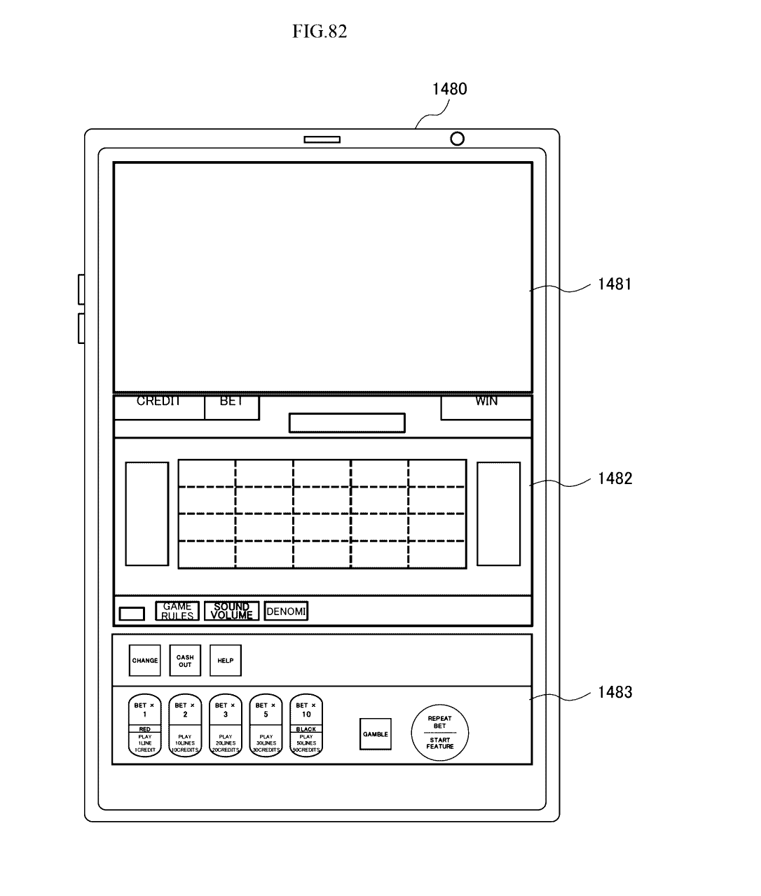

In this embodiment, an application to a machine different from the slot machine 10 will be described with reference to FIG. 82. Although the first embodiment has illustrated the slot machine 10 as an example of the gaming machine, the gaming machine is not limited to the slot machine 10. For example, a terminal such as a personal computer, a smart phone, or a tablet capable of providing plays by installing a game program (application) of the slot machine 10 is also acceptable.

In this embodiment, a description will be given mainly of configurations different from those illustrated in the first embodiment, and a description of configurations identical to those of the first embodiment, which are denoted respectively by the same reference signs, may be omitted as appropriate.

FIG. 82 shows an example of the tablet 1480. The tablet 1480 is configured as shown in FIG. 2.

The tablet 1480 includes an upper display unit 1481, a middle display unit 1482, and a lower display unit 1483.

The upper display unit 1481 has the same screen configuration as that of the middle image display panel 142, and displays the same contents as those displayed on the middle image display panel 142. The middle display unit 1482 has the same screen configuration as that of the lower image display panel 141, and displays the same contents as those displayed on the lower image display panel 141. The lower display unit 1483 displays icons representing the buttons of the control panel 30. Each button and each corresponding icon have the same function.

The configurations illustrated in the first and second embodiments can be combined appropriately.

The embodiments described above merely illustrate specific examples of the present invention, and should not be construed to put any particular limitations on the present invention. Specific structures of the units, etc. may be suitably designed or modified. Furthermore, the effects of the present invention described in the above embodiments are not more than examples of most preferable effects achievable by the present invention. The effects of the present invention are not limited to those described in the above embodiments.

The detailed descriptions above are mainly focused on characteristic parts, for easier understanding of the present invention. The present invention is not limited to the embodiments illustrated in the detailed description above, and is applicable to other embodiments. A diversity of applications can be made. In addition, the terms and phraseology used in the present specification are adopted solely to provide an appropriate illustration of the present invention, and in no case should be construed to limit the interpretation of the present invention. Moreover, other configurations, systems, methods, etc. covered by the concept of the present invention could be easily envisioned by those skilled in the art based on the concept of the invention described in this specification. The description of claims therefore shall encompass configurations equivalent to the present invention without departing from the technical idea of the present invention. Furthermore, the abstract is provided for the purpose of allowing, for example, the Patent Office, public institutions, engineers in the art who are not fully familiarized with patents, legal terminology, or technical terminology to quickly determine the technical features of the present application and essences thereof through a simple investigation. The abstract is therefore not intended to limit the scope of the invention which shall be construed on the basis of the description of the claims. To fully understand the object of the present invention and effects unique to the present invention, it is encouraged to sufficiently refer to disclosures of documents already made available.

The detailed description of the present invention provided hereinabove includes a process executed on a computer. The above descriptions and expressions are provided to allow the one skilled in the art to most efficiently understand the present invention. In the present specification, respective steps performed to yield one result shall be understood as a process with no self-contradiction. In addition, electrical or magnetic signals are transmitted/received or recorded in respective steps. It should be noted that, in processing of each step, such a signal is expressed in the form of bits, values, symbols, characters, terms, numbers, etc., which are adopted merely for the purpose of convenience of description. Although processing of each step may be sometimes expressed as if it is a human behavior, processing described in this specification is in principle executed by devices. Furthermore, other configurations required for executing each step are obvious from the descriptions given above.

What is claimed is:

1. A gaming machine comprising:
a display unit with a display area in which regions for displaying symbols stopped are arranged in a plurality of rows and a plurality of columns; and
a control unit that executes the processing of
(1-1) stopping symbols in each of the columns, and
(1-2) determining whether or not a plurality of predetermined symbols are successively stopped among the symbols stopped in the processing of (1-1);
upon determining in the processing of (1-2) that the plurality of predetermined symbols are successively stopped, the control unit producing a coupled-region animation for the predetermined symbols, the coupled-region animation being produced in a region obtained by coupling regions where the plurality of predetermined symbols are successively stopped.

2. The gaming machine according to claim 1, wherein the control unit executes the processing of
(2-1) determining whether or not a winning combination is included in symbol combinations containing any of the plurality of predetermined symbols, the winning combination awarding a benefit,
upon determining in the processing of (2-1) that the winning combination is included, the control unit producing individual-region animations for the predetermined symbols instead of the coupled-region animation, the individual-region animations being produced in the respective regions.

3. The gaming machine according to claim 1, wherein the control unit executes the processing of:
(3-1) starting scrolling of symbols in the display area based on a spin operation; and
(3-2) determining whether or not a winning combination is included in symbol combinations containing any of the plurality of predetermined symbols, the winning combination awarding a benefit,
upon determining in the processing of (3-2) that the winning combination is not included, the control unit maintaining the coupled-region animation until a next spin operation.

4. The gaming machine according to claim 2, wherein
after the processing of (2-1), the control unit applies hatching to, in the display area, regions where symbols not involved in the winning combination are stopped.
